(19) United States
(12) Patent Application Publication
(10) Pub. No.: US 2013/0021883 A1
(43) Pub. Date: Jan. 24, 2013

(54) INFORMATION RECORDING MEDIUM, INFORMATION RECORDING APPARATUS AND METHOD, AND INFORMATION REPRODUCING APPARATUS AND METHOD

(71) Applicants: Masayoshi Yoshida, Sayama-shi (JP); Hideki Kobayashi, Kawagoe-shi (JP); Takuya Shiroto, Yokohama-shi (JP)

(72) Inventors: Masayoshi Yoshida, Sayama-shi (JP); Hideki Kobayashi, Kawagoe-shi (JP); Takuya Shiroto, Yokohama-shi (JP)

(73) Assignee: PIONEER CORPORATION, KANAGAWA (JP)

(21) Appl. No.: 13/638,672

(22) PCT Filed: Apr. 2, 2010
(86) PCT No.: PCT/JP2010/056104

§ 371 Date: Oct. 1, 2012

(51) Int. Cl. G11B 7/24; G11B 7/00

(52) U.S. Cl. 369/44.11; 369/275.1; G9B/7; G9B/7.139

(57) ABSTRACT

An information recording medium (11) adopting a zone CAV method is provided with: a guide layer (12) in which tracks (TR) are formed in advance; and a plurality of recording layers (13) laminated on the guide layer. On the tracks, a plurality of guide areas (22), each of which has a physical structure for carrying guide information for guidance, are arranged discretely at arrangement intervals of predetermined distance or less which is set in advance in a track direction and are shifted between a plurality of tracks throughout the plurality of tracks which are adjacent to each other in a radial direction. The plurality of guide areas are disposed in a partial plurality of slots which are not adjacent to each other in the track direction and which are not adjacent to each other throughout the plurality of tracks in the radial direction, out of a plurality of slots obtained by dividing the tracks in the track direction.

### TECHNICAL FIELD

The present invention relates to an information recording medium, such as an optical disc of a multilayer type or multilayer recording type, an information recording apparatus and method for recording information onto the information recording medium, and an information reproducing apparatus and method for reproducing the information from the information recording medium.

### BACKGROUND ART

In this type of information recording medium, a plurality of or multiple recording layers are laminated on a single guide layer in which tracks are formed in advance, and the guide layer is used to perform recording and reproduction in each recording layer (e.g. refer to patent documents 1 to 3).

Specifically, at the time of the recording and the reproduction, a first light beam for tracking (e.g. a guiding light beam or a servo light beam including red laser as in a DVD) is irradiated and focused on the guide layer through the recording layers. This enables the tracking for each recording layer. In other words, this enables focus servo for the guide layer and tracking servo using the tracks formed in advance in the guide layer.

In parallel with such a tracking operation, a second beam for information recording and reproduction in which a positional relation with the first beam is fixed or known (e.g. a main light beam including blue laser as in a Blu-ray) is irradiated typically in a form of concentrically overlapping the first beam by using the same optical pickup or through the same objective lens or in similar manners and is focused on one recording layer which is a recording or reproduction target. This enables the information recording and reproduction in each recording layer. In other words, this enables the focus servo for each recording layer and information writing or reading.

In addition, the recording and the reproduction of this type of information recording medium are performed while so-called “tilt correction” is performed on the optical pickup by a correction mechanism for correcting a disc tilt or simply tilt (typically, a slope or inclination of an optical disc surface). More generally, not only the tilt correction but also various processing, such as eccentricity correction of a disc, inclination correction of a disc surface, aberration correction of an optical system, phase difference correction of a light beam, distortion correction, light absorption correction, and setting of a strategy, are performed while the recording and the reproduction are performed.

### PRIOR ART DOCUMENT

### Patent Document

Patent document 1: Japanese Patent Application Laid Open No. Hei 4-301226
Patent document 2: Japanese Patent Application Laid Open No. 2003-67939
Patent document 3: International Publication WO2009/037773

### DISCLOSURE OF INVENTION

### Subject to be Solved by the Invention

However, in a technology disclosed in the patent documents, if the first beam for irradiating the guide layer and the second beam for irradiating the recording layer have different beam diameters on the disc and if the recording layer is subject to “higher-density recording” in comparison with the guide layer, then, the tracking accuracy of the guide layer is controlled with a track pitch calculated from a first beam diameter which is relatively larger. Based on that, the tracking in the recording layer is performed. Thus, the tracking accuracy becomes lower than the tracking accuracy which can be calculated from a second beam diameter which is relatively smaller, and the high-density recording causes an increase in crosstalk or the like from adjacent tracks, resulting in characteristic degradation.

Moreover, in the case of the high density recording in which the track pitch of the guide layer is substantially equal to the track pitch of the recording layer, the first beam is irradiated onto a plurality of track areas in the guide layer at a time, and it is thus extremely hard to follow a target track, which is technically problematic.

In particular, if a zone constant angular velocity (CAV) method is adopted, an angular velocity increases in each of zones having different radial direction positions. Therefore, an arrangement relation of control information recorded in tracks in a guide layer, or an arrangement relation of patterns for detecting tilt errors, become arbitrary depending on a radial position. Moreover, particularly if concentric tracks are adopted, track jumps are frequently performed. Alternatively, even if a spiral track is adopted, the track jumps are also performed, as occasion demands. Thus, it becomes extremely difficult to correspond to a high-density track pitch and recording linear density for realizing high-density recording, as described above, regardless of the radial position. In other words, if the zone CAV method is adopted in a multilayer type information recording medium, there is such a technical problem that it is practically extremely difficult to perform the tracking servo or to perform various processing, such as tilt correction, at high accuracy or with high resolution that can correspond to the high-density recording, which is an original purpose of the multilayer type.

Moreover, in particular, in the case of a zone CAV multilayer type optical disc, it is necessary to appropriately change various control in each layer and each zone. Thus, it is extremely important to perform a particular type of processing, such as tilt correction, with respect to each recording layer and each zone, as occasion demands. Furthermore, it is more important to do so for the high-density recording.

In view of the aforementioned problems, it is therefore an object of the present invention to provide an information recording medium of a multilayer type which enables high-accuracy tracking servo while adopting the zone CAV method, an information recording apparatus and method for recording information onto such an information recording medium, and an information reproducing apparatus and method for reproducing the information from such an information recording medium.

### Means for Solving the Subject

In order to solve the above object, an information recording medium of the present invention is an information recording medium adopting a zone CAV method, which is provided with: a guide layer in which tracks are formed in advance; and a plurality of recording layers laminated on the guide layer, wherein on the tracks, a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks, and the plurality of guide areas are disposed in partial slots which are not adjacent to each other in the track direction and which are not adjacent to each other throughout the plurality of tracks in the radial direction, out of a plurality of slots obtained by dividing the tracks in the track direction.

In order to solve the above object, an information recording apparatus of the present invention is an information recording apparatus for recording data onto the above-described information recording medium of the present invention, the information recording apparatus is provided with: a light irradiating device capable of irradiating and focusing a first light beam for tracking on the guide layer and capable of irradiating and focusing a second light beam for data recording on one recording layer out of the plurality of recording layers; an information obtaining device for receiving first light based on the irradiated and focused first light beam from the guide layer and obtaining the carried guide information on the basis of the received first light; a tracking servo device for controlling the light irradiating device to perform tracking servo in a predetermined band on the tracks on the basis of the obtained guide information; and a data recording control device for controlling the light irradiating device to record the data by irradiating and focusing the second light beam on the one recording layer when the tracking servo is performed.

In order to solve the above object, an information recording method of the present invention is an information recording method of recording data onto the above-described information recording medium of the present invention, by using a light irradiating device capable of irradiating and focusing a first light beam for tracking on the guide layer and capable of irradiating and focusing a second light beam for data recording on one recording layer out of the plurality of recording layers, the information recording method is provided with: an information obtaining process of receiving first light based on the irradiated and focused first light beam from the guide layer and obtaining the carried guide information on the basis of the received first light; a tracking servo process of controlling the light irradiating device to perform tracking servo in a predetermined band on the tracks on the basis of the obtained guide information; and a data recording control process of controlling said light irradiating device to record the data by irradiating and focusing the second light beam on the one recording layer when the tracking servo is performed.

In order to solve the above object, an information reproducing apparatus of the present invention is an information reproducing apparatus for reproducing data from the above-described information recording medium of the present invention, the information reproducing apparatus is provided with: a light irradiating device capable of irradiating and focusing a first light beam for tracking on the guide layer and capable of irradiating and focusing a second light beam for data reproduction on one recording layer out of the plurality of recording layers; an information obtaining device for receiving first light based on the irradiated and focused first light beam from the guide layer and obtaining the carried guide information on the basis of the received first light; a tracking servo device for controlling the light irradiating device to perform tracking servo in a predetermined band on the tracks on the basis of the obtained guide information; and a data obtaining device for receiving second light based on the irradiated and focused second light beam from the one recording layer and obtaining the data on the basis of the received second light when the tracking servo is performed.

In order to solve the above object, an information reproducing method of the present invention is an information reproducing method of reproducing data from the above-described information recording medium of the present invention, by using a light irradiating device capable of irradiating and focusing a first light beam for tracking on the guide layer and capable of irradiating and focusing a second light beam for data reproduction on one recording layer out of the plurality of recording layers, the information reproducing method is provided with: an information obtaining process of receiving first light based on the irradiated and focused first light beam from the guide layer and obtaining the carried guide information on the basis of the received first light; a tracking servo process of controlling the light irradiating device to perform tracking servo in a predetermined band on the tracks on the basis of the obtained guide information; and a data obtaining process of receiving second light based on the irradiated and focused second light beam from the one recording layer and obtaining the data on the basis of the received second light when the tracking servo is performed.

The operation and other advantages of the present invention will become more apparent from embodiments explained below.

### BRIEF DESCRIPTION OF DRAWINGS

FIG. 1 is a schematic perspective view illustrating a basic configuration of an information recording medium in a first example of the present invention.

FIG. 2 is a partially enlarged cross sectional view schematically illustrating: an objective lens for focusing a first beam for guiding and a second beam for recording (or reproduction); and the information recording medium in the example.

FIG. 3 is a partially enlarged perspective view illustrating a guide layer in the example.

FIG. 4 is a partially enlarged perspective view having the same concept as in FIG. 3 in a comparative example of the example.

FIG. 5 is a partially enlarged perspective view having the same concept as in FIG. 2 in the case of having one example of pre-pits in the example.

FIG. 6 is a partially enlarged perspective view having the same concept as in FIG. 2 in the case of having another example of the pre-pits in the example.

FIG. 7 is a partially enlarged plan view schematically illustrating tracks for low-density recording.

FIG. 8 is a partially enlarged plan view schematically illustrating tracks for high-density recording.

FIG. 9 is a conceptual diagram illustrating a configuration of the tracks with three areas arranged which are provided for the guide layer, and a structure in each of the three areas, in the example.

FIG. 10 is a schematic entire plan view of the guide layer illustrating zones divided in accordance with a zone CAV method in the example.

FIG. 11 is a schematic entire plan view of the guide layer illustrating groups of tracks into each of which a plurality of tracks are grouped, and center tracks located in the center thereof in the example.

FIG. 12 is a conceptual diagram illustrating a pre-format configuration example of a two layer use type in the example.

FIG. 13 is a conceptual view illustrating one configuration example of various data recorded in slots in the example.

FIG. 14 is a conceptual view illustrating another configuration example of various data recorded in the slots in the example.

FIG. 15 is a conceptual view illustrating one example of assignment of data in the slots in the example.

FIG. 16 is a conceptual view illustrating another configuration example of various data recorded in slots (“B Slots”) in the example.

FIG. 17 is a conceptual view illustrating another configuration example of various data recorded in slots (“A Slots”) in the example.

FIG. 18 is a schematic plan view illustrating track jumps performed on the inner circumferential side of concentric tracks TR formed in the guide layer in the example.

FIG. 19 is a schematic plan view illustrating track jumps performed on the outer circumferential side of the concentric tracks TR formed in the guide layer in the example.

FIG. 20 is a schematic plan view illustrating track jumps performed on the inner circumferential side of a spiral track TR formed in the guide layer in the example.

FIG. 21 is a schematic plan view illustrating track jumps performed on the outer circumferential side of the spiral TR formed in the guide layer in the example.

FIG. 22 is a block diagram illustrating an information recording/reproducing apparatus in the example.

FIG. 23 is a block diagram illustrating a configuration of a tilt detection system provided for the information recording/reproducing apparatus in FIG. 22.

FIG. 24 is a timing chart illustrating various signals used in the tilt detection system in FIG. 22.

FIG. 25 is a flowchart illustrating an information recording/reproducing method in the example.

FIG. 26 is a flowchart illustrating a recording method for a new disc in the example.

FIG. 27 is a flowchart illustrating one example of a reproducing method for a new disc in the example.

FIG. 28 is a block diagram illustrating a circuit part for performing tracking servo, of the information recording/reproducing apparatus in the example.

FIG. 29 is a characteristic diagram illustrating an operation of sampling a tracking error which is performed by a sampler included in the circuit part shown in FIG. 28.

FIG. 30 is a characteristic diagram illustrating phase rotation for defining an arrangement interval of two guide areas which are adjacent to each other along the track in the example.

FIG. 31 is a characteristic diagram illustrating frequency characteristics of a gain in the tracking servo for defining the arrangement interval of the two guide areas which are adjacent to each other along the track in the example.

FIG. 32 is a partially enlarged plan view schematically illustrating a predetermined pattern for generating a tilt detection signal in another example.

FIG. 33 is an enlarged plan view schematically illustrating a structure of the guide area in the example.

FIG. 34 is an enlarged plan view schematically illustrating a structure in the guide area in another modified example.

FIG. 35 is an enlarged plan view schematically illustrating a structure in the guide area in another modified example.

FIG. 36 is an enlarged plan view schematically illustrating a structure in the guide area in another modified example.

FIG. 37 is a table illustrating various combinations of the three areas arranged in the guide layer, which is a modified example about a track formation method.

FIG. 38 is a schematic perspective view having the same concept as in FIG. 1 and illustrating an optical disc in another modified example.

### MODE FOR CARRYING OUT THE INVENTION

Hereinafter, as the best mode for carrying out the invention, embodiments associated with a driving apparatus will be explained in order.

### (Information Recording Medium)

<1>

In order to solve the above object, an information recording medium of the present embodiment is An information recording medium adopting a zone CAV method, which is provided with: a guide layer in which tracks are formed in advance; and a plurality of recording layers laminated on the guide layer, wherein on the tracks, a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks.

Moreover, the plurality of guide areas are disposed in partial slots which are not adjacent to each other in the track direction and which are not adjacent to each other throughout the plurality of tracks in the radial direction, out of a plurality of slots obtained by dividing the tracks in the track direction.

According to the information recording medium in the embodiment, typically, by using the tracks provided for the guide layer for guidance or tracking, it is possible to optically record information into a desired recording layer out of the plurality of recording layers laminated on or under the guide layer, optically in the zone constant angular velocity (CAV) method along the tracks. Moreover, by using or without using the tracks for guidance, it is possible to reproduce the information from the desired recording layer which is already recorded, optically in the zone CAV method.

Here, the “guide layer” typically means a layer for guiding or leading to a position in a recording surface of each recording layer (i.e. a position in the radial direction and a position in the track direction along the recording surface) by using a first light beam for guidance or tracking (hereinafter simply referred to as a “first light beam”), at least in information recording or writing into each recording layer. The “guide layer” is typically a layer in which the tracks, which are configured to generate a tracking error signal (or a wobble signal as a basis thereof, a pre-pit signal, or the like), are physically formed in advance.

Moreover, the “tracks” formed in the guide layer mean courses or paths which are tracked or followed by the first light beam. Typically, for example, the tracks are wobbled. In addition to or instead of this, the tracks are physically formed in advance in the guide layer or on the guide layer, as groove tracks or land tracks in which pits are formed. Incidentally, information tracks formed after the recording in the recording layer are clearly distinguished from the “tracks” formed in advance herein, in that the information tracks are established as the arrangement or alignment of information pits recorded in the recording surface which originally does not have any tracks.

At each of positions which will make the information tracks after the recording in the desired recording layer and which correspond to respective positions of the first light beam on the tracks in the guide layer guided as described above, typically, the information recording is performed by a second light beam for information recording or information writing (hereinafter simply referred to as a “second light beam”).

Incidentally, typically, it is enough to provide one guide layer for all the recording layers; however, a plurality of guide layers, such as two layers, may be provided and each of them may be used as occasion demands, or the roles thereof may be divided. In any case, the guide layer and the plurality of recording layers are provided, as layers which are separate from each other.

The plurality of recording layers are configured such that information can be recorded or further reproduced independently in each of the recording layers, such as, for example, 16 layers. Each of the plurality of recording layers preferably has as a simple structure as possible, such as straight grooves or straight lands or a mirror surface, in an unrecorded state. That is because it is preferable in manufacturing that alignment between the plurality of recording layers and alignment between the recording layers and the guide layer are almost or practically completely unnecessary. The structure of the recording layers is configured to perform the recording in various recording methods in which each of transmittance and reflectance in each recording layer is set to be included in a predetermined range, so that the light beam reaches one recording layer on the rear side or the guide layer, viewed from the irradiation side of the light beam.

More specifically, in the information recording, for example, the tracking error signal (or the wobble signal as the basis thereof and additionally the pre-pit signal) can be detected from reflected light obtained when the first light beam (e.g. red laser for forming a light spot with a relatively large diameter) is focused on the tracks which exist in the guide layer. In accordance with the tracking error signal, the tracking or the tracking servo can be performed as one type of a guide operation. The information recording is performed by focusing the second light beam (e.g. blue laser for generating alight spot with a relatively small diameter) on the desired recording layer on the upper layer or lower layer side of the tracks in a state in which the tracking is performed or the tracking servo is closed. In other words, in-plane positioning for the information recording is performed in the desired recording layer which is another layer in which the tracks or the like do not exist (e.g. in a mirror-surface state), on the basis of the positions of the tracks formed in advance in the guide layer. (Incidentally, focus is separately performed in focusing the light.)

Here, if an optical system for irradiating the first and second light beams is fixed in an optical pickup or the like, a positional relation between the light spots formed by the light beams is also fixed. Thus, performing the guide operation, such as the tracking servo, for the position of the first light beam (i.e. the position of the light spot on the tracks formed by the first light beam) means performing the guide operation even for the second light beam (i.e. the position of the light spot in the recording surface formed by the second light beam) with reproducibility. In other words, by using the first light beam on the tracks which exist in advance, it is possible to track or guide the second light beam in the recording surface in which the tracks do not exist in advance.

If such a recording method is adopted, there is almost or practically no need to perform the alignment in a direction along the recording surface between the tracks, between the guide layer and each of the recording layers which are laminated mutually, or between the plurality of recording layers. This is extremely useful in manufacturing.

On the other hand, in the information reproduction, in the same manner, the tracks may be used for guidance. Alternatively, in the information reproduction, the reproduction can be performed by performing the tracking operation on the information tracks after the recording, without using the guide layer for guidance (typically for tracking), by following the information which is already written in the recording layer.

On the tracks formed in the guide layer, there are disposed the plurality of guide areas each of which has the physical structure for carrying the guide information. Here, the “guide information” is information for guiding or leading or following the first light beam, and typically information for optically generating the tracking error signal (or the wobble signal as the basis thereof and additionally the pre-pit signal). Moreover, the guide information can be said as “mark information”, since the guide information becomes a mark for positioning the light beam for tracking.

The physical structure for carrying the guide information as described above is typically realized by the arrangement or alignment or the like of pre-pits on a surface without the grooves and lands (e.g. a mirror surface), a wobble and partial-notch structure, and a wobble and pre-pit structure (i.e. land pre-pits, groove pre-pits, etc.) formed on the side walls of or in the inside or outside of the groove tracks or land tracks. Here, the “physical structure” is different from a logical structure, i.e. a conceptual or virtual structure simply established by data, but means a structure which physically exists. The physical structure is already formed on the guide in the completion of the information recording medium.

As a result of studies by the present inventors, it has been found that a special purpose of allowing the guide operation to be performed, such as, for example, performing the tracking in a predetermined band, can be achieved even without continuously forming special mechanisms for detecting the guide information in the track direction, as in tracks of a prior or existing optical disc, even if it is necessary to allow the detection of the guide information in any track. In other words, as long as the arrangement interval (i.e. arrangement pitch) of the guide information corresponding to a time interval at which the guide information is detected is set to be less than a distance minimum required to enable the guide operation (e.g. to be less than or equal to the longest distance that allows the tracking servo to operate in the predetermined band). At the same time, regarding the plurality of tracks which are adjacent to each other, it has been found that the aforementioned purpose can be achieved even if such special mechanisms are not arranged in a respective plurality of positions or areas aligned in the radial direction, i.e. even if such special mechanism area not arranged (or aligned) regularly in one line in the radial direction.

Thus, in the present invention, the plurality of guide areas are mutually arranged discretely at arrangement intervals (i.e. arrangement pitch) of the predetermined distance or less which is set in advance in the track direction along the tracks (in other words, a tangential direction of the tracks) which are spiral or concentric. Here, the “predetermined distance” is typically a distance which is shorter by some margin than the longest distance that allows the function of the guidance or the guide operation, which is the tracking or the tracking operation in the predetermined band (e.g. the longest distance that allows the continuous or continual generation of a tracking signal at a frequency which enables the tracking operation to be performed stably in the predetermined band). Moreover, the “predetermined band” means a band unique to a data format or data standard in which the tracking operation is performed and which is determined by a relation with a band used in the information recording.

The predetermined distance as described above may be set by obtaining a limiting distance in which the guide operation (typically, the tracking operation in the predetermined band) functions and by determining an appropriate margin, with respect to the guide layer of a specific information recording medium, by experiments, experiences, simulations, or the like in advance. If the guide areas are discretely arranged at arrangement intervals (i.e. arrangement pitch) longer than the predetermined distance, then, the tracking error signal cannot be generated at a frequency which allows the stable tracking servo in the predetermined band; namely, the stable guide operation cannot be performed.

Incidentally, “discretely” means that the guide areas are not mutually continuous, viewed planarly on the recording surface of each recording layer and that there are an another planar area between the guide areas, such as the mirror surface, buffer areas, and areas other than the guide areas.

The plurality of guide areas are shifted between the plurality of tracks throughout the plurality of tracks which are adjacent to each other in the radial direction crossing the tracks (i.e. the direction of the radius). Here, the expression of “throughout the plurality of tracks” means throughout or straddling two or more tracks which are adjacent to each other, including areas occupying gaps of the tracks, viewed planarly on the recording surface of each recording layer. Moreover, the expression of “shifted between the plurality of tracks in the radial direction” means that the plurality of tracks are not in the same phase (e.g. angle on a disc), or positions corresponding to the same phase (e.g. angular positions on the disc) in the radial direction (i.e. the direction of the radius), or not on the same radius. At this time, the plurality of guide areas arranged respectively adjacently in the radial direction do not need to be separated completely (i.e. do not need to have gaps therebetween). Typically, it is enough to shift the phase in the radial direction to the extent that the light beam for tracking servo in the information recording or reproduction does not cover the plurality of tracks simultaneously (e.g. throughout five tracks). Alternatively, it is enough to shift the phase to the extent that the signal and information which can be read from the plurality of guide areas by the light beam can be distinguished from each other.

Thus, even if a track density is increased until the spot of the light beam straddles or covers two or more tracks or track portions which are adjacent to each other (e.g. until the spot covers five tracks), as long as the guide areas are shifted as described above in response to the increased track density, it is possible to avoid a situation in which the guide information cannot be detected due to the overlap of the guide information in both the track direction and the radial direction (or due to an influence of a signal component from another guide area as noise), i.e. due to the crosstalk of the detected guide information. As described above, even if the track density is increased, the guidance or the tracking can be performed, and typically, the original function of generating the tracking signal as the guide layer is guaranteed.

Therefore, it is possible to stably and continuously generate the guide information, such as the tracking error signal or the wobble signal as the basis thereof and additionally the pre-pit signal, for example, by sampling a push-pull signal obtained from the reflected light caused by the first light beam or the like, while narrowing the track pitch with respect to the diameter of the first light beam to the extent that the plurality of tracks which are adjacent to each other in the guide layer are simultaneously irradiated with the first light beam. In other words, it is possible to perform the stable guide operation, such as the tracking operation, in the predetermined band. Alternatively, if the guide information includes information for control (e.g. a servo mark, address information, etc.), this can be certainly read as information based on the reflected light caused by the first light beam or the like. In other words, it is possible to stably obtain pre-format information.

This works extremely useful, particularly in cases where the first light beam (e.g. red laser) has a larger beam diameter than that of the second light beam (e.g. blue laser) and in cases where a recording density in the information recording into one recording layer is increased nearly to the limit by effectively using the light spot of the second light beam which is relatively small (i.e. in accordance with the small size). In other words, if narrow-pitch tracks corresponding to a narrow-pitch recording area which will make the tracks after the recording in the recording layer are formed in advance in the guide layer, the light spot of the first light beam, which is naturally larger than such tracks, has a technical characteristic of being simultaneously irradiated throughout the plurality of tracks (e.g. many tracks such as five tracks). Thus, it is necessary to perform the guide operation, such as the tracking operation, corresponding to a narrow-pitch recording layer by using the first light beam for forming the relatively large light spot.

Incidentally, even in cases where the first light beam has a smaller beam diameter than that of the second light beam, or even in cases where their diameters are almost or completely the same, as long as the guide operation is appropriately performed when the diameter of the light beam is larger than the track pitch, the unique configuration of the embodiment as described above provides a proper operational effect.

As described above, regarding the tracks for guidance, the pitch thereof can be set as a narrow pitch (can be set on the same level with a narrow pitch of the information tracks which are suitable for the beam diameter of the second light beam and which are established by the recording in the recording layer) (i.e. a narrow pitch unsuitable for the first light beam) without damaging the guiding function, such as enabling the tracking servo in the predetermined band or reading the pre-format information.

In addition, in particular, since the zone CAV method is adopted, an angular velocity increases toward a zone on an inner circumferential side (in other words, the angular velocity decreases toward an outer circumferential side). Thus, for example, an arrangement relation of the guide information recorded in advance in the tracks in the guide layer is arbitrary in accordance with a radial position. For example, it is basically impossible to adopt the arrangement of aligning a particular length of information throughout the plurality of tracks in the radial direction, which is possible in a constant angular velocity (CAV) method. Then, if no measure is taken in the zone CAV method, the track portion inside the light spot is arbitrary in accordance with the radial position (i.e. even the particular length of information is shifted in the track direction in accordance with the position in the radial direction in any cases) in cases where the first light beam forms the light spot throughout the plurality of tracks, and it is extremely unstable to obtain the guide information in accordance with the radial position.

However, the guide areas are shifted between the plurality of tracks in the radial direction, consciously or positively as described above. Thus, regardless of the position in the radial direction (i.e. regardless of whether to be closer to the inner circumference or the outer circumference), it is possible to stably perform the guide operation, such as the tracking servo, in the predetermined band, in response to a high-density track pitch and recording linear density for realizing high-density recording. Conversely, if the predetermined distance and the way to shift are defined in advance in accordance with the radial position on the premise that it is in the zone CAV method, then, there is no problem even in the zone CAV method.

Moreover, according to the embodiment, the plurality of guide areas are disposed in the partial slots which are not adjacent to each other in the track direction and which are not adjacent to each other throughout the plurality of tracks in the radial direction, out of the plurality of slots. Typically, the plurality of guide areas are disposed in the partial slots, one by one.

Here, the “slot” is a logical section or division or a physical section or division obtained by dividing the track in the track direction. The slots are typically arranged continuously without gaps in the track direction and arranged without gaps in the radial direction or adjacently to each other. The slots, however, may be arranged with slight gaps in at least one of the track direction and the radial direction. In other words, the tracks are established from the arrangement or alignment of the plurality of slots formed to be arranged in the track direction in advance in the guide layer.

Since the guide areas are disposed in the plurality of slots which are not adjacent to each other in the track direction and which are not adjacent to each other throughout the plurality of tracks in the radial direction, it is possible to certainly reduce or eliminate the crosstalk between the guide information which can be detected from the plurality of guide areas. In addition, in the guide layer, it is enough to form the grooves, the lands, the pre-pits or the like, in the slots in which the guide areas are disposed, and it is unnecessary to form them continuously in the whole tracks. Moreover, the presence or absence of the slot (e.g. a difference between the slot and the mirror surface) can be distinguished physically and clearly and thus easily detected. This makes it easily possible to stably read the guide information. This is extremely useful in practice.

On the other hand, regarding the plurality of slots in each recording layer, as opposed to the case of the guide layer, individual recording areas for recording content data, user data, and the like may be disposed in all the slots that are continuous in both the track direction and the radial direction. Even any slots in the recording layer can correspond to the slots in which the guide areas are disposed in the guide layer, and thus, the tracking servo in the predetermined band can be performed indirectly to the recording layer. In other words, in the recording layer, the light spot formed by the second light beam allows information to be recorded into all the slots, at high density to the readable limit.

As a result, it is possible to improve the track pitch and the recording linear density (e.g. a linear recording density, a pit pitch, or an information transfer rate (i.e. recording linear density×moving speed)) which allow the recording or reproduction in the recording layer to the extent that it can be said as the “high-density recording”, which is an intended purpose in the information recording medium of the multilayer type, while adopting the zone CAV method.

<2>

In an aspect of the information recording medium of the present embodiment, the plurality of slots have mutually equal lengths in the track direction and arranged without gaps in the track direction.

According to this aspect, it is possible to relatively and easily determine that the slots may be arranged in the guide layer and the recording layer, which slots in the guide layer are allowed to dispose the guide areas therein, which slots are not allowed to dispose the guide areas therein, or to determine such a placement rule.

<3>

In an aspect of the information recording medium of the present embodiment, the tracks are guide tracks for tracking servo, the physical structure allows generation of a signal for the tracking servo which constitutes at least one portion of the guide information, each of the plurality of guide areas is a servo area for generating the signal for the tracking servo, the predetermined distance is set in advance to a distance in which the tracking servo can operate in a predetermined band, and the plurality of servo areas are arranged such that the plurality of servo areas are shifted between the plurality of tracks so as not to be irradiated with a light beam simultaneously, on the basis of a diameter of the light beam for the tracking servo.

According to this aspect, the guide layer is a layer in which the tracks configured to generate the tracking error signal or the like are formed in order to track the position in the recording surface of each recording layer by using the first light beam, at least in the information recording into each recording layer.

More specifically, in the information recording, it is possible to detect the tracking error signal or the like from the reflected light obtained when the first light beam is focused on the tracks which exist in the guide layer. In accordance with the tracking error signal, the tracking or the tracking servo can be performed as one type of the guide operation.

Here, particularly in the embodiment, the plurality of servo areas are arranged separately from each other within the distance which is set in advance and in which the tracking servo can operate in the predetermined band, in the track direction. In other words, two servo areas in tandem in the track direction are arranged separately within the longest distance that allows the tracking signal to be generated continuously or continually from the servo areas at the frequency which enables the tracking operation to be performed stably in the predetermined band

Moreover, the plurality of servo areas are arranged such that the plurality of servo areas are shifted between the plurality of tracks so as not to be irradiated with the light beam simultaneously, on the basis of the diameter of the first light beam for the tracking servo.

Thus, even if the track density is increased until the spot of the first light beam straddles or covers two or more tracks or track portions which are adjacent to each other, as long as the servo areas are shifted as described above in response to the increased track density, it is possible to avoid a situation in which the tracking error signal cannot be detected due to the overlap of the tracking error signal (or the wobble signal as the basis thereof) in both the track direction and the radial direction (or due to an influence of a tracking error signal component from another servo area as the noise of the crosstalk). In other words, even if the track density is increased, the tracking can be performed, and the original function of generating the tracking signal as the guide layer is guaranteed.

Therefore, it is possible to stably and continuously generate the tracking error signal, for example, by sampling the push-pull signal obtained from the reflected light caused by the first light beam or the like, or by sampling a phase difference signal in differential phase detection (DPD), or by similar actions, while narrowing the track pitch. In other words, it is possible to perform the stable guide operation, such as the tracking operation.

<4>

In another aspect of the information recording medium of the present embodiment, a plurality of signal detection areas, each of which has an integrated predetermined pattern covering a plurality of track portions, are further arranged in the tracks such that a particular type of pattern signal can be detected in a center track portion, at least located near a central portion in the radial direction, out of the plurality of track portions which are adjacent to each other in the radial direction crossing the tracks

According to this aspect, each of the plurality of signal detection areas has the integrated predetermined pattern covering the plurality of track portions, which are adjacent to each other in the radial direction, such that the particular type of pattern signal can be detected in the center track portion. The “center track portion” is a track portion, at least located near the central portion in the radial direction, such as in the central portion, at the center, or on a center line in the radial direction, out of the plurality of track portions which are adjacent to each other in the radial direction in each of the signal detection areas. For example, if the plurality of track portions are odd-numbered, such as three, five, and seven, the track portion in the middle is preferably set as the center track portion.

On the other hand, the track portions other than the center track portion dare to be excluded from a pattern signal detection target, even when the center of a first light spot by the first light beam is thereon. In other words, even if some signal or noise caused by the predetermined pattern can be detected in the track portions other than the center track portion, such a signal or noise is not detected as noise, or is discarded as noise after being detected.

The plurality of signal detection areas are arranged, typically discretely in the track direction, and also discretely in the radial direction. Thus, even if the track density is increased until the spot of the light beam straddles or covers two or more tracks or track portions which are adjacent to each other (e.g. until the spot covers five tracks, seven tracks, and the like), it is possible to avoid a situation in which the pattern signal cannot be detected due to the crosstalk of the patter signal detected.

For example, if the predetermined pattern is formed typically in advance or the predetermined pattern is recorded at an arbitrary time point after starting to use it such that a tilt detection signal, such as a tilt error signal, can be generated as the pattern signal, there is a significant signal change in the pattern signal when a tilt occurs, which is extremely useful in practice.

Specifically, for example, in the case of a tilt in the radial direction, if the predetermined pattern, which is axially symmetrical to the center track as a center line, is formed to be planarly spread in a direction covering the plurality of tracks, it is possible to generate the tilt detection signal which is excellent in sensitivity, for the tilt in the radial direction. Alternatively, in the case of a tilt in the track direction (i.e. a tangential direction), if the predetermined pattern, which is axially symmetrical to a line segment perpendicular to the tracks as the center line, is formed to be planarly spread in the direction covering the plurality of tracks, it is possible to generate the tilt detection signal which is excellent in sensitivity, for the tilt in the track direction. Alternatively, in the case of a tilt in a diagonal direction, if the predetermined pattern, which is axially symmetrical to a line segment diagonally crossing the tracks as the center line, is formed to be planarly spread in the direction covering the plurality of tracks, it is possible to generate the tilt detection signal which is excellent in sensitivity, for the tilt in the diagonal direction.

The predetermined pattern may be configured such that various signals are detected as the pattern signal, such as an eccentricity signal for eccentricity correction of a disc, an inclination signal for inclination correction of a disc surface, an aberration signal for aberration correction of an optical system, a phase difference signal for phase difference correction of a light beam, a distortion signal for distortion correction, a light absorption signal for light absorption correction, and a strategy signal for setting of a strategy, in addition to the tilt detection signal for the tilt correction.

The predetermined pattern is configured by forming a plurality of pits or a plurality of small optically-specific portions in each portion of the plurality of tracks in a planar area having annual circular shape (i.e. a hollow type) or a solid shape (i.e. a filled type) in which an outer ring shape thereof is circular, rectangular, or the like, in a form of covering the plurality of tracks. In other words, the predetermined pattern is composed of a series or group of the plurality of pits, the plurality of small optically-specific portions, and the like.

Here, as a result of the studies by the present inventors, it has been found that a special purpose of enabling a particular type of processing based on the pattern signal, such as, for example, the tilt correction based on the tilt detection signal, can be achieved even without continuously forming the pattern signal, such as the tilt detection signal, on all the tracks, even though it is necessary to allow the detection of the pattern signal, such as the tilt detection signal, in any track. It is rather rare that the particular type of processing is performed, identically and continuously. In other words, it has been found that the above specific purpose can be achieved if the pattern signal, such as the tilt detection signal, is detected in accordance with frequency or a period in which the particular type of processing is performed, for example, if the tilt detection signal is detected once every time the tilt correction is maintained at a constant value (in other words, every period in which the tilt servo is locked).

Thus, on one hand, regarding the plurality of tracks which are adjacent to each other, if the pattern signal is detected every plurality of tracks, it is possible to perform predetermined processing based on the pattern signal, practically completely, almost completely, or properly. On the other hand, regarding an area along the tracks, if the pattern signal is detected at some intervals or at intervals of any phase (e.g. angles on a disc), it is possible to perform the predetermined processing based on the pattern signal, practically completely, almost completely, or properly. After all, practically, it is enough to obtain the pattern signal intermittently on every plurality of tracks, such as, for example, five tracks and seven tracks, in the center track portion which represents the tracks. Moreover, phase positions (e.g. angular positions on the disc) in which the pattern signals are detected may be or may not be aligned or arranged in order.

Thus, in the example, with respect to the signal detection area, an opportunity in which the center of the light spot of the first light beam is on the center track portion is used as a detection opportunity for the pattern signal. The track portions other than the center track portion dare to be excluded from the opportunity to detect the pattern signal even if the center of the light spot by the first light beam is thereon.

This works extremely useful, particularly in cases where the first light beam (e.g. red laser) has a larger beam diameter than that of the second light beam (e.g. blue laser) and in cases where the recording density in the information recording into one recording layer is increased nearly to the limit by effectively using the light spot of the second light beam which is relatively small (i.e. in accordance with the small size). In other words, if the narrow-pitch tracks, corresponding to the narrow-pitch recording area which will become the tracks after the recording in the recording layer, are formed in advance in the guide layer, the light spot of the first light beam, which is naturally larger than such tracks, has a technical characteristic of being simultaneously irradiated throughout the plurality of tracks (e.g. many tracks such as five tracks and seven tracks).

Thus, it is extremely advantageous to detect the integrated predetermined pattern covering the plurality of track portions which are adjacent to each other in the radial direction, by using the first light beam which forms the relatively large light spot. It can be also said that the light spot larger than the track pitch, which easily causes demerits, is effectively used.

Incidentally, even in cases where the first light beam has a smaller beam diameter than that of the second light beam, or even in cases where their diameters are almost or completely the same, as long as the predetermined pattern is detected when the diameter of the light beam is larger than the track pitch, the unique configuration of the embodiment as described above provides a proper operational effect.

As described above, the plurality of signal detection areas, each of which has the predetermined pattern, are arranged in the tracks. Thus, degree of freedom of the arrangement of the particular type of pattern signal, such as the tilt detection signal, remarkably increases. Moreover, the plurality of signal detection areas can be arranged, independently of each other, i.e. discretely. Thus, the arrangement with the degree of freedom is also possible on the entire information recording medium. By providing a plurality of types of pattern signals in association with a particular plurality of types of processing, it is also possible to perform the plurality of types of processing, as occasion demands.

<5>

In this aspect in which the signal detection areas are arranged, guide information associated with at least one guide area disposed in front of the center track portion in the track direction out of the plurality of guide areas may be configured to also function as mark information indicating that corresponding one signal detection area of the plurality of signal detection areas is located thereafter, the tracks may be formed, spirally or concentrically, from an inner circumference to an outer circumference or from the outer circumference to the inner circumference of the information recording medium, and the mark information may indicate that the corresponding one signal detection area is located thereafter by indicating (i) timing to sample the corresponding one signal detection area located thereafter or (ii) an address position of the corresponding one signal detection area located thereafter.

By virtue of such a configuration, the guide information functions as the mark information. In other words, a mark area for carrying the mark information indicating that the corresponding one signal detection area of the plurality of signal detection areas is located thereafter is disposed in front of the center track portion in the track direction in each of the plurality of signal detection areas. The mark information is, for example, information reproduced by using the wobble signal, the pre-pit signal, or the like, or used also as the guide information described above.

Thus, the pattern signal can be read, simply and certainly, on the basis of the arrival of the mark information. In particular, regarding the same phase position (e.g. the same angular position on the disc), the center track portion arrives (i.e. there is an opportunity to detect the pattern signal), for example, only every five or seven tracks, even in the phase position in which there is a signal generation area. On contrary, in many cases, the signal generation area does not arrive even though the track portions other than the center track arrive.

Therefore, it is extremely useful that the fact of the arrival in the near future of the center track portion is found by the detection of the mark information, because the detection or the like of the pattern signal can be performed simply and stably. For example, it is possible to start preparation for starting to detect the pattern signal after the detection of the mark information, or further preparation for starting the particular type of processing based on the pattern signal. For example, by defining in advance a phase relation and an interval between the pattern signal and the mark information, it is possible to easily specify sampling timing to detect the predetermined pattern from the mark information. Alternatively, by providing the mark information with the address position at which the pattern signal is recorded, it is possible to easily specify the sampling timing to detect the predetermined pattern.

In this case, the plurality of signal detection areas may be arranged discretely so as not to be adjacent to or overlap each other in the radial direction and the track direction, and the mark information may be disposed in each of the plurality of signal detection areas in the center track portion. Incidentally, “in front of” includes two meanings, which are in front without via any other area between the mark information and each of the signal detection areas, and in front via the buffer area, the mirror-surface area, or the other area between the mark information and each of the signal detection areas.

As described above, in this case, in the recording or reproduction, firstly, the mark information is detected in the mark area, and then, it is found in which timing or at which address position the pattern signal will arrive. Thus, it is possible to prepare for the detection of the pattern signal in advance, thereby stably and certainly detecting or sampling the pattern signal. It is also possible to prepare for the execution of the particular type of processing based on the detected pattern signal in accordance with the detection of the mark information, thereby stably and certainly perform the particular type of processing.

Incidentally, the track may be formed, spirally, from the inner circumference to the outer circumference, or from the outer circumference to the inner circumference of the information recording medium. The mark area may be disposed immediately before the center track portion in the track direction and may indicate that the corresponding one of the plurality of signal detection areas is located immediately thereafter. By virtue of such a configuration, in the recording or reproduction, firstly, the mark information is detected in the mark area, and then it is found that the pattern signal will arrive later without a delay. Thus, it is possible to prepare for the detection of the pattern signal in advance, thereby stably and certainly detecting the pattern signal. It is also possible to prepare for the execution of the particular type of processing based on the detected pattern signal in accordance with the detection of the mark information, thereby stably and certainly perform the particular type of processing. Incidentally, “immediately before” includes two meanings, which are in front without via any other area between the mark information and the corresponding one of the signal detection areas, and in front without via the area other than the buffer area and the mirror-surface area between the mark information and the corresponding one of the signal detection areas (i.e. only via the buffer area and the mirror-surface area).

<6>

In this aspect, furthermore, the physical structure may carry the guide information such that a length in the track direction of the slot and a length in the track direction of a constituent unit in a format of data which is recorded into each of the plurality of recording layers have a predetermined integral ratio, and the predetermined pattern may be configured such that a length in the track direction of another slot and a length in the track direction of a constituent unit in a format of data which is recorded into each of the plurality of recording layers have a predetermined integral ratio.

By virtue of such a configuration, the length in the track direction of the slot in the guide layer and the length in the track direction of the constituent unit in the format of the data (e.g. user data, content data, etc.) which is recorded into each recording layer have the predetermined integral ratio. Here, the “constituent unit in the format” means a constituent unit according to a data format, such as, for example, an error correction unit like an ECC block, an ADIP unit, or the like, and it is typically a unit treated in performing a predetermined type of processing in the information recording or information reproduction.

Moreover, the length in the track direction of another slot in which the signal detection area is disposed and the length in the track direction of the constituent unit in the format of the data which is recorded into each of the plurality of recording layers have the predetermined integral ratio.

Thus, it is possible to maintain the frequency of generating the guide information such as the tracking error signal, the frequency of generating the pattern signal such as the tilt detection signal, and the cycle of recording information into the recording layer at the position in the recording surface corresponding to the track, in a constant relation, regardless of the radial position or the track position. In particular, due to the zone CAV method, the stable guide operation can be performed at any radial position, even though an angular velocity varies depending on the radial position, and it is also possible to perform the particular type of processing, stably, on the basis of the detected pattern signal. Moreover, for that purpose, it is enough to define the length in the track direction of the slot in accordance with the length of the constituent unit in the format of the data when the slots are formed in advance.

<7>

In this aspect, furthermore, the plurality of guide areas may be configured as the slots having mutually equal lengths in the track direction, the guide information may be disposed in each of the slots so as not to be adjacent to each other between the plurality of tracks in the radial direction, the plurality of signal detection areas may be configured as other slots having lengths equal to those of the slots, and the predetermined pattern is disposed in each of the slots so as not to be adjacent to each other between the plurality of tracks in the radial direction and so as not to overlap the plurality of guide areas.

By virtue of such a configuration, the plurality of signal detection areas, as in the guide information, are also disposed in the partial slots (preferably one by one) which are not adjacent to each other in the track direction and which are not adjacent to each other throughout the plurality of tracks in the radial direction, out of the plurality of slots. Moreover, by using the slots having equal lengths, it is possible to relatively and easily determine that the slots may be arranged in the guide layer and the recording layer, which slots in the guide layer are allowed to dispose the guide areas therein, which slots are not allowed to dispose the guide area, or to determine such an arrangement rule.

In this manner, since the plurality of signal detection areas are disposed in the partial slots (preferably one by one) which are not adjacent to each other in the track direction and which are not adjacent to each other throughout the plurality of tracks in the radial direction, it is possible to certainly reduce or eliminate the crosstalk between the pattern signals which can be detected from the plurality of signal detection areas.

<8>

In another aspect of the information recording medium of the present embodiment, the plurality of guide areas and the plurality of signal detection areas are disposed mixedly on the basis of arrangement rules thereof which are different from each other.

According to this aspect, the guide information is read by a predetermined rule corresponding to the arrangement rule of the guide areas at least in the recording. Then, the pattern signal is hardly read from the signal detection areas arranged by the different arrangement rule. On the other hand, in the recording or reproduction, the pattern signal is read by a predetermined rule corresponding to the arrangement rule of the signal detection areas. Then, the guide information is hardly read from the guide areas arranged by the different arrangement rule. In other words, it is possible to reduce the crosstalk between the guide information and the pattern signal in accordance with the difference in the arrangement rule or the predetermined rule in the reading. Thus, with little or practically no worry about the crosstalk, the guide areas and the signal detection areas can be mixed. This makes it possible to read at least one of the guide information and the pattern signal at an arbitrary position or in the vicinity of the arbitrary position in the entire area of the guide layer, as occasion demands. Thus, it is possible to perform the guide operation, such as the stable tracking servo, and to perform the particular type of processing, such as the stable tilt detection and the high-accuracy tilt correction, throughout the entire area of the information recording medium,

<9>

In another aspect of the information recording medium of the present embodiment, the plurality of guide areas and the plurality of signal detection areas are separated in a form of having a buffer area therebetween so as not to be adjacent to each other in the radial direction.

According to this aspect, the guide areas and the signal detection areas are separated in the form of having the buffer area therebetween so as not to be adjacent to each other in the radial direction. Here, “not to be adjacent to each other in the radial direction” includes not only the meaning of being not disposed on the next track but also the meaning of being not disposed on the track that is a plurality of tracks distant. The “buffer area” is an area having a mirror surface or a straight groove or straight land structure. Here, the “mirror surface” means a plain surface in which information is not particularly embedded and is a surface with highest optical reflectance in the guide layer. The “straight groove or straight land structure” means a simple straight groove or a land between the grooves in which wobbles and pits and the like are not formed. Incidentally, the groove and the land are relatively uneven, and either can be concave or convex, as viewed in a direction of irradiating the first and second light beams. For example, a concavity based on a body substrate which constitutes the information recording medium is the groove, and a convexity is the land. In this case, the groove may be convex and the land may be concave, as viewed in the direction of irradiating the first and second light beams.

Therefore, the pattern signal is hardly read from the signal detection areas which are separated in the form of having the buffer area therebetween when the guide information is read from the guide areas at least in the recording. On the other hand, the guide information is hardly read from the guide areas which are separated in the form of having the buffer area therebetween when the pattern signal is read from the signal detection areas in the recording or reproduction. In other words, it is possible to reduce the crosstalk between the guide information and the pattern signal in accordance with an attribute, such as a size, of the buffer area. Thus, with little or practically no worry about the crosstalk, the guide areas and the signal detection areas can be mixed with the buffer area being disposed therebetween. This makes it possible to read at least one of the guide information and the pattern signal at an arbitrary position or in the vicinity of the arbitrary position in the entire area of the guide layer, as occasion demands. Thus, it is possible to perform the guide operation, such as the stable tracking servo, and to perform the particular type of processing, such as the stable tilt detection and the high-accuracy tilt correction, throughout the entire area of the information recording medium,

<10>

In an aspect in which the signal detection areas are arranged, the predetermined pattern may be configured such that a tilt detection signal for tilt detection can be detected as the pattern signal.

By virtue of such a configuration, if the predetermined pattern is formed typically in advance or the predetermined pattern is recorded at an arbitrary time point after starting to use it such that the tilt detection signal can be generated, there is a significant signal change in the tilt detection signal, such as the tilt error signal, when the tilt occurs, which is extremely useful in practice. This makes it possible to perform the tilt correction, highly accurately.

<11>

In another aspect of the information recording medium of the present embodiment, the physical structure includes at least one of a wobble and pre-pit structure and a wobble and partial notch structure.

According to this aspect, each of the plurality of guide areas has the physical structure including at least one of the wobble and pre-pit structure and the wobble and partial notch structure for carrying the guide information for guidance. Here, the “wobble and pre-pit structure” means a structure in which the wobbles and wobbled groove or land tracks are formed and in which the pre-pits are formed in the grooves or lands. Moreover, the “pre-pits” are convex or concave pits or phase pits formed to have a narrower width than a groove width or land width, on the tracks which are in or on the grooves or on or in the lands. In other words, the pre-pits may be land pre-pits or groove pre-pits.

On the other hand, the “wobble and partial-notch structure” means a structure in which the wobbles and the wobbled groove or land tracks are formed and in which notches equivalent with the groove width or land width are formed in the grooves or lands. There are listed a case where one portion of the land which exists between the adjacent grooves is notched, a case where one portion of the groove which exists between the adjacent lands is notched, and a case of a combination thereof. In other words, the physical structure may be configured to include broad-sense pre-pits which are the partial notches. Moreover, the broad-sense pre-pits may be broad-sense land pre-pits or broad-sense groove pre-pits. Furthermore, in addition to such a structure, the aforementioned narrow-sense pre-pits (i.e. pre-pits without the partial notch structure) can be formed together.

As described above, the tracks are established in advance in the guide layer as the groove tracks or land tracks which are wobbled and in which the pits are formed, or as the groove tracks or land tracks in which one portion of the lands or grooves is notched. Thus, the establishment is relatively easy, and eventually, the guide operation with high reliability and stability becomes possible.

<12>

In another aspect of the information recording medium of the present embodiment, the plurality of slots in which the guide areas are disposed are selected as a plurality of slots which are not included in a light spot simultaneously on the basis of (i) a diameter of the light spot formed on the tracks by a light beam irradiated and focused on the tracks at least in information recording for the recording layer, (ii) a pitch in the radial direction of the tracks, (iii) a displacement amount by which a relative position between two slots which are adjacent in the radial direction is shifted in the track direction in every cycle according to the zone CAV method, in comparison with the case of assuming that it complies with the CAV method; and (iv) a length in the track direction of the slot.

According to this aspect, the plurality of slots which are not included in the light spot simultaneously can be determined by arithmetic from the diameter of the light spot, the pitch of the tracks, the displacement amount described above, and the length in the track direction of the slot. Here, the expression of “not included” means in a narrow sense that even one portion, such as an edge and a corner, of two slots are not included in the light spot simultaneously, when it is planarly viewed on a main surface of the guide layer, i.e. the recording surface of the recording layer. In a broad sense, it means that slight portion of two slots may be included in the light spot simultaneously as long as the guide information can be detected without the crosstalk. If the guide areas are disposed only in the slots selected in this manner, it is possible to realize the guide areas with the slots disposed, which can prevent the generation of the crosstalk between the guide information, relatively easily and certainly.

<13>

In another aspect of the information recording medium of the present embodiment, the guide information includes first recording address information directed from an inner circumference to an outer circumference in the track direction, and second recording address information directed from the outer circumference to the inner circumference.

According to this aspect, the first recording address information and the second recording address information are recorded in the guide layer which is a single layer. Alternatively, the first recording address information and the second recording address information are recorded in each of the guide layers which are two layers (or more layers). Then, it is possible to properly and selectively use the recording layers, as a first recording layer in which the recording is performed in accordance with the first address information, and a second recording layer in which the recording is performed in accordance with the second address information. Thus, it becomes efficient or easy to perform the operation of recording information from the inner circumference to the outer circumference in one or more first recording layers, and the operation of recording information from the outer circumference to the inner circumference in one or more second recording layers. Moreover, the reliability or stability of the recording operation can be increased remarkably by properly using the two types of address information. Thus, it is possible to realize the information recording medium that allows the recording, continuously bidirectionally, or arbitrarily or independently bidirectionally.

In particular, if it is set to perform the recording or reproduction from the inner circumference to the outer circumference in the first layer of the recording layers and to perform the recording or reproduction from the outer circumference to the inner circumference in the second layer of the recording layers, that is extremely useful when the recording or reproduction is performed continuously over the plurality of recording layers, because a time to change the recording or reproduction between the two layers is almost a time to perform a layer jump.

At this time, if the first recording address information is recorded in advance in at least one of the two types of slots arranged by a first rule, and if the first recording address information is recorded in advance in at least one of the two types of slots arranged by a second rule which is different from the first rule, it is possible to certainly and stably detect the address information which is necessary at that time point while reducing an influence of the crosstalk.

In the information recording medium in the embodiment as explained above, the plurality of guide areas may be arranged, with disposing therebetween at least one of (i) the buffer area having the mirror surface or the straight groove or straight land structure and (ii) the mirror-surface area having the mirror surface or the straight groove or straight land structure, in the track direction. By virtue of such a configuration, a structure, in which the buffer area, the guide area, and the mirror-surface area are arranged along the track in order as occasion demands, is established in advance in the guide layer. Here, the “mirror surface” means a plain surface in which information is not particularly embedded and is a surface with highest optical reflectance in the guide layer. The “straight groove or straight land structure” means a simple straight groove or a land between the grooves in which wobbles and pits and the like are not formed. Incidentally, the groove and the land are relatively uneven, and either can be concave or convex, as viewed in a direction of irradiating the first and second light beams. For example, a concavity based on a body substrate which constitutes the information recording medium is the groove, and a convexity is the land. In this case, the groove may be convex and the land may be concave, as viewed in the direction of irradiating the first and second light beams.

In this case, moreover, the buffer area may be adjacently disposed in front of a head portion and behind a tail portion of each of the plurality of guide areas in the track direction, and the mirror-surface area may be between the buffer area adjacently disposed behind the tail portion of one guide area out of the plurality of guide areas and the buffer area adjacently disposed in front of the head portion of another guide area next to the one guide area out of the plurality of guide areas, in the track direction.

By virtue of such a configuration, the buffer area is provided in front of and behind each guide area in the track direction, and so to speak, the “guide area with the buffer area” is established. Moreover, the mirror surface area is disposed between the guide area with the buffer areas. Thus, it is easy to find the guide areas along the tracks, and it is possible to detect the guide information, stably and certainly. This makes it possible to perform the stable guide operation.

Incidentally, within the same slot in which one guide area is disposed, the buffer area adjacently disposed in front of the head of the one guide area may be also disposed. Alternatively, instead of this or in addition to this, the buffer area adjacently disposed behind the tail of the one guide area may be also disposed within the same slot.

### (Information Recording Apparatus)

<14>

In order to solve the above object, an information recording apparatus of the present embodiment is an information recording apparatus for recording data onto the above-described information recording medium of the present embodiment (including various aspects), the information recording apparatus is provided with: a light irradiating device capable of irradiating and focusing a first light beam for tracking on the guide layer and capable of irradiating and focusing a second light beam for data recording on one recording layer out of the plurality of recording layers; an information obtaining device for receiving first light based on the irradiated and focused first light beam from the guide layer and obtaining the carried guide information on the basis of the received first light; a tracking servo device for controlling the light irradiating device to perform tracking servo in a predetermined band on the tracks on the basis of the obtained guide information; and a data recording control device for controlling the light irradiating device to record the data by irradiating and focusing the second light beam on the one recording layer when the tracking servo is performed.

According to the information recording apparatus in the embodiment, the first light beam is irradiated and focused on the guide layer by the light irradiating device, which is, for example, an optical pickup including two types of semiconductor lasers. The first light beam may be a light beam with a relatively large spot diameter as in the red laser light beam, as described above. In other words, the first light beam may be a light beam with a large light flux which forms a large light spot irradiated throughout the plurality of tracks.

Then, the first light, such as reflected light, scattered light, refracted light, and transmitted light from the guide layer, based on the first light beam is received by a light receiving device. Here, the light receiving device includes, for example, a photodetector or a light receiving element such as a two-division or four-division charged coupled device (CCD), which is formed integrally with the light irradiating device and which shares an optical system such as an objective lens, at least partially. The light receiving device is configured to receive the first light in an optical path which is different from the optical paths for second light and the first and second light beams from the middle, via a prism, a dichroic mirror, a dichroic prism, and the like.

Then, the guide information carried by the physical structure of each of the guide areas is obtained by the information obtaining device including, for example, a processor, an arithmetic circuit, a logical circuit, etc., on the basis of the received first light.

Then, the light irradiating device such as, for example, an optical pickup, is controlled by the tracking servo device, such as a tracking servo circuit, to perform the tracking servo in the predetermined band on the tracks or to close the tracking servo, on the basis of the obtained guide information. For example, an actuator for tracking control of the light irradiating device is controlled under feedback-control or feed-forward control, and the light beam formed by the first light beam tracks or follows on the tracks. Particularly at this time, in order to perform the tracking servo in the predetermined band, there is no need to provide the guide areas which allow the guide information to be generated in all the slots along the tracks. In other words, it is enough to arrange the slots including the guide areas, separately in both the track direction and the radial direction, in accordance with the predetermined band.

The second light beam, which is modulated in accordance with the information to be recorded, is irradiated and focused by the light irradiating device under the control by the data recording control device, such as, for example, a processor, in a state in which the tracking servo is performed in the predetermined band or the tracking servo is closed, as described above. The second light beam may be a light beam with a relatively small spot diameter, for example, as in the blue laser light beam as described above, aimed at the high density recording of the information recording. From the viewpoint of realizing high-density record information, the second light beam is desirably a smaller light flux.

Then, in the desired recording layer, the data is sequentially recorded into an area which will make the information tracks corresponding to the tracks in the guide layer. At this time, if the recording of the data into the recording layer is performed by a unit corresponding to the slot, such as an integral multiple of the slot, then, the recording operation becomes simple and stable.

As described above, it is possible to record the information to be recorded, such as, for example, content information and user information, preferably into the recording layer of the information recording medium in the embodiment described above, at high density.

### (Information Recording Method)

<15>

In order to solve the above object, an information recording method of the present embodiment is an information recording method of recording data onto the above-described information recording medium of the present embodiment (including various aspect), by using a light irradiating device capable of irradiating and focusing a first light beam for tracking on the guide layer and capable of irradiating and focusing a second light beam for data recording on one recording layer out of the plurality of recording layers, the information recording method is provided with: an information obtaining process of receiving first light based on the irradiated and focused first light beam from the guide layer and obtaining the carried guide information on the basis of the received first light; a tracking servo process of controlling the light irradiating device to perform tracking servo in a predetermined band on the tracks on the basis of the obtained guide information; and a data recording control process of controlling the light irradiating device to record the data by irradiating and focusing the second light beam on the one recording layer when the tracking servo is performed.

According to the information recording method in the embodiment, it acts in the same manner as in the information recording apparatus in the embodiment described above, and eventually, it is possible to preferably record the information to be recorded, such as the content information and the user information, at high density into the recording layer of the information recording medium in the embodiment described above.

### (Information Reproducing Apparatus)

<16>

In order to solve the above object, an information reproducing apparatus of the present embodiment is an information reproducing apparatus for reproducing data from the above-described information recording medium of the present embodiment (including various aspect), the information reproducing apparatus is provided with: a light irradiating device capable of irradiating and focusing a first light beam for tracking on the guide layer and capable of irradiating and focusing a second light beam for data reproduction on one recording layer out of the plurality of recording layers; an information obtaining device for receiving first light based on the irradiated and focused first light beam from the guide layer and obtaining the carried guide information on the basis of the received first light; a tracking servo device for controlling the light irradiating device to perform tracking servo in a predetermined band on the tracks on the basis of the obtained guide information; and a data obtaining device for receiving second light based on the irradiated and focused second light beam from the one recording layer and obtaining the data on the basis of the received second light when the tracking servo is performed.

According to the information reproducing apparatus in the embodiment, the first light beam is irradiated and focused on the guide layer by the light irradiating device, which is, for example, an optical pickup including two types of semiconductor lasers. The first light beam may be a light beam with a relatively large spot diameter as in the red laser light beam, as described above. In other words, the first light beam may be a light beam with a large light flux which forms a large light spot irradiated throughout the plurality of tracks.

Then, the first light, such as reflected light, scattered light, refracted light, and transmitted light from the guide layer, based on the first light beam is received by the light receiving device.

Then, the guide information carried by the physical structure of each of the guide areas is obtained by the information obtaining device including, for example, a processor, an arithmetic circuit, a logical circuit, etc., on the basis of the received first light.

Then, the light irradiating device such as, for example, an optical pickup, is controlled by the tracking servo device, such as the tracking servo circuit, to perform the tracking servo in the predetermined band on the tracks or to close the tracking servo, on the basis of the obtained guide information. Particularly at this time, in order to perform the tracking servo in the predetermined band, there is no need to provide the guide areas which allow the guide information to be generated in all the slots along the tracks. In other words, it is enough to arrange the slots including the guide areas, separately in both the track direction and the radial direction, in accordance with the predetermined band.

The second light beam is irradiated and focused on the desired recording layer by the light irradiating device under the control by the data obtaining device, such as, for example, a processor, in a state in which the tracking servo is performed in the predetermined band or the tracking servo is closed as described above. The second light beam may be a light beam with a relatively small spot diameter, for example, as in the blue laser light beam as described above, aimed at the high density recording of the information recording.

Then, in the desired recording layer, the recorded data is reproduced. At this time, if the recording of the data into the recording layer in the recording is performed by the unit corresponding to the slot, such as an integral multiple of the slot, then, the reproduction operation becomes simple and stable.

As described above, it is possible to reproduce the recorded information, such as, for example, the content information and the user information, preferably from the recording layer of the information recording medium in the embodiment described above, at high density.

Incidentally, it is also possible to reproduce the information from the information tracks while performing the tracking on the information tracks which are established as the arrangement or alignment of the recorded information, by using only the second light beam, without using the tracking by the guide layer, i.e. without using the first light beam. In other words, it is also possible to establish the information reproducing apparatus so as to properly use the light beam in accordance with a distinction between the recording and the reproduction, such as using only the second light beam in the information reproduction and using both the first and second light beams in the information recording. In the information reproduction, only the second light beam is used, and the reproduction can be thus performed with relatively low power consumption and simple control (i.e. in comparison with the case of using the first light beam in the reproduction). In particular, it is extremely useful in practice if the information reproducing apparatus is realized as an “information recording/reproducing apparatus” having a recording function of properly using the light beam between the information recording and the information reproduction.

### (Information Reproducing Method)

<17>

In order to solve the above object, an information reproducing method of the present embodiment is an information reproducing method of reproducing data from the above-described information recording medium of the present embodiment (including various aspect), by using a light irradiating device capable of irradiating and focusing a first light beam for tracking on the guide layer and capable of irradiating and focusing a second light beam for data reproduction on one recording layer out of the plurality of recording layers, the information reproducing method is provided with: an information obtaining process of receiving first light based on the irradiated and focused first light beam from the guide layer and obtaining the carried guide information on the basis of the received first light; a tracking servo process of controlling the light irradiating device to perform tracking servo in a predetermined band on the tracks on the basis of the obtained guide information; and a data obtaining process of receiving second light based on the irradiated and focused second light beam from the one recording layer and obtaining the data on the basis of the received second light when the tracking servo is performed.

According to the information reproducing method in the embodiment, it acts in the same manner as in the information reproducing apparatus in the embodiment described above, and eventually, it is possible to preferably reproduce the recorded information, such as the content information and the user information, at high density from the recording layer of the information recording medium in the embodiment described above.

The operation and other advantages in the embodiments will become more apparent from an example explained below.

As explained above, according to the information recording medium in the embodiment, it is provided with: the guide layer; and the plurality of recording layers, and the plurality of guide areas are disposed on the tracks. Thus, it is possible to improve the track pitch and the recording linear density which allow the recording or reproduction in the recording layer while adopting the zone CAV method.

According to the information recording apparatus in the embodiment, it is provided with: the light irradiating device; the information obtaining device; the tracking servo device; and the data recording control device. According to the information recording method in the embodiment, it is provided with: the information obtaining process; the tracking servo process; and the data recording control process. Thus, it is possible to preferably record the information to be recorded, such as the content information and the user information, at high density into the recording layer of the information recording medium in the embodiment described above.

According to the information reproducing apparatus in the embodiment, it is provided with: the light irradiating device; the information obtaining device; the tracking servo device; and the data obtaining device. According to the information reproducing method in the embodiment, it is provided with: the information obtaining process; the tracking servo process; and the data obtaining process. Thus, it is possible to preferably reproduce the recorded information at high density from the recording layer of the information recording medium in the embodiment described above.

### Examples

Hereinafter with reference to the drawings, various examples of the present invention will be explained. Incidentally, hereinafter, an explanation will be given to an example in which the information recording medium of the present invention is applied to an optical disc of a multilayer recording type.

### <Example of Information Recording Medium>

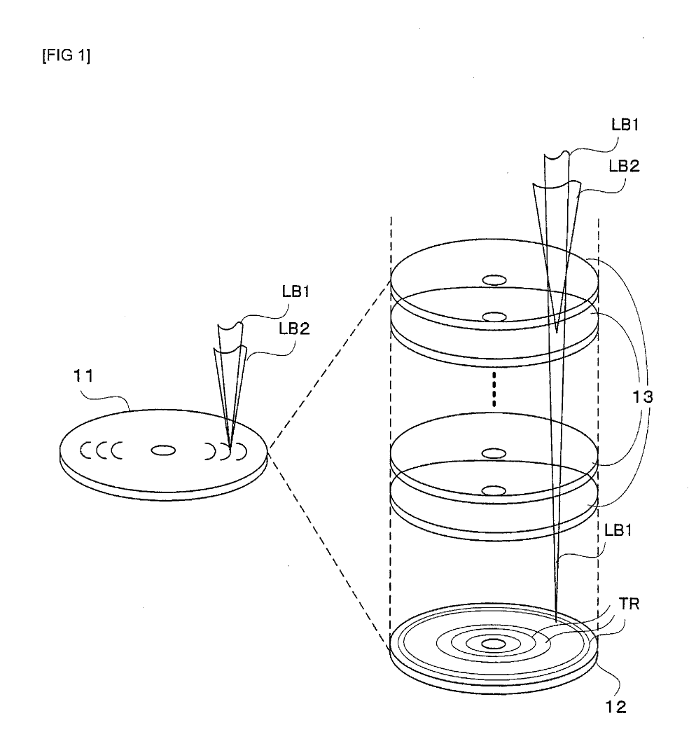

Firstly, with reference to FIG. 1 to FIG. 21, an explanation will be given to an example of the optical disc of a multilayer recording type as one example of the information recording medium of the present invention.

Firstly, with reference to FIG. 1 to FIG. 8, a basic configuration (mainly a physical structure) and a basic principle of an optical disc 11 in the example will be explained.

In FIG. 1, the optical disc 11 is of a multilayer recording layer type and is provided with a single guide layer 12 and a plurality of recording layers 13. FIG. 1 is a schematic perspective view in which visualization of each layer is facilitated by spacing out a plurality of layers which constitute one optical disc illustrated in the left half of the drawing, in their lamination direction (a vertical direction in FIG. 1) in the right half of the drawing.

The optical disc 11 is irradiated simultaneously with a first beam LB1 for tracking servo as one example of the “first light beam” of the present invention and a second beam LB2 for information recording as one example of the “second light beam” of the present invention, in recording. In reproduction, the optical disc 11 is irradiated simultaneously with the first beam LB1 and the second beam LB2 for information reproduction. Incidentally, in the information reproduction, the second beam LB2 can be also used as a single light beam for the tracking servo and for the information reproduction (i.e. the first beam LB1 is not used).

The optical disc 11 adopts the zone CAV method, and a tracking error signal (or a wobble signal as a basis thereof), address information (or a pre-pit signal as a basis thereof), and the like, which are recorded in advance in concentric tracks or a spiral track TR and which are detected in the information recording or reproduction, are arranged along the tracks in accordance with the zone CAV method. In FIG. 1, as illustrated in the right half of FIG. 1, the first beam LB1 is tracking-controlled to be focused on the guide layer 12 and to follow the tracks TR (i.e. guide tracks).

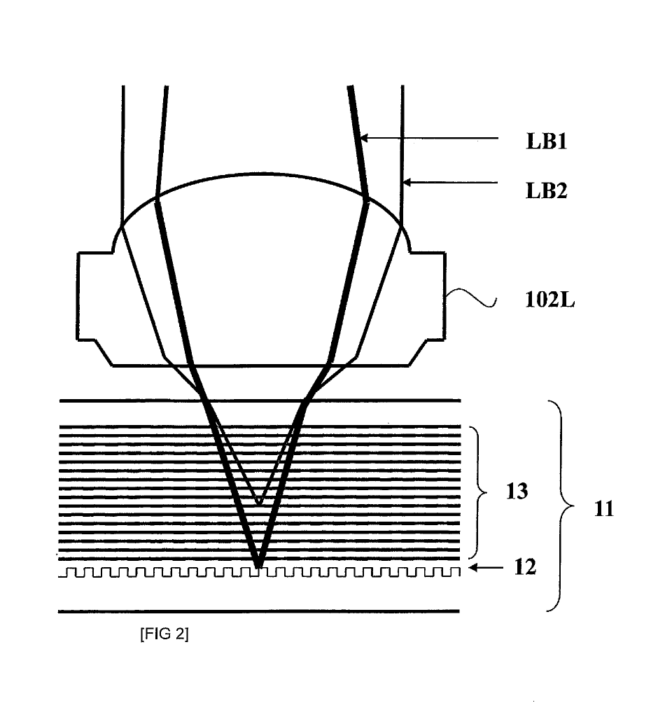

As shown in FIG. 2, the second beam LB2 is focused on one desired recording layer 13 which is a recording target or a reproduction target, out of the plurality of recording layers 13 laminated on the guide layer 12. The second beam LB2 is a blue laser beam with a relatively small diameter, for example, as in a Blu-ray (BR) disc. As opposed to this, the first beam LB1 is a red laser beam with a relatively large diameter, for example, as in a DVD. The diameter of a light spot formed by the first beam LB1 is, for example, several times as large as the diameter of a light spot formed by the second beam LB2.

The plurality of recording layers 13 are configured such that information can be optically recorded or further reproduced independently in each of the recording layers 13, such as, for example, 16 layers. More specifically, each of the plurality of recording layers 13 is made of a semitransparent thin film including a two-photon absorption material. For example, as the two-photon absorption material, it is possible to adopt a fluorescent type using a fluorescent material in which fluorescent intensity changes in an area in which two-photon absorption occurs, a refractive-index change type using a photorefractive material in which a refractive index changes due to electron localization, and the like. As the two-photon absorption material of the refractive-index change type, the use of a photochromic compound, a bis(alkylidene)cycloalkanone, or the like is highly expected.

As an optical disc structure using the two-photon absorption material, there are (i) a bulk type in which the entire optical disc 11 is made of the two-photon absorption material and (ii) a layered structure type in which the recording layers 13 made of the two-photon absorption material and spacer layers made of another transparent material are alternately laminated. The layered structure type has the advantage that focus servo control can be performed by using light reflected on an interface between one recording layer 13 and the spacer layer. The bulk type has the advantage that it has less multilayer film formation processes and production costs can be kept low.

As the material of the recording layers 13, there may be listed a material which reacts to at least one of intensity and wavelength of the second beam LB2, which allows the recording by changing optical properties, such as a refractive index, transmittance, absorptivity, and reflectance, and which is stable. For example, a translucent or semitransparent photoresponse material, such as a photopolymer which allows a photopolymerization reaction, an optical anisotropic material, a photorefractive material, a hole burning material, and a photochromic material which absorbs light to change an absorption spectrum can be listed. For example, as the recording layers 13, a phase-change material, the two-photon absorption material, and the like are used, each of which reacts to the second beam LB2 with a wavelength of λ2 but does not react to the first beam LB1 with λ1 (λ2<λ1).

Each of the plurality of recording layers 13 may be made of, for example, a dye material, in addition to the two-photon absorption material and the phase-change material described above. In each of the plurality of recording layers 13, the track TR is not formed in advance in an unrecorded state, and for example, the entire area is a mirror surface or a smooth plane.

The optical disc 11 having the plurality of recording layers 13 laminated on the guide layer 12 is irradiated with the first beam LB1 and the second beam LB2 having different diameters and focal depths, in a condition that the first beam LB1 and the second beam LB2 are almost coaxial or practically completely coaxial, via a common objective lens 102L provided for an optical pickup, at least in the information recording.

In FIG. 1 and FIG. 2, a tracking operation related to the second beam LB2 is performed indirectly by a tracking operation for the tracks TR of the guide layer 12 performed by the first beam LB1 (because there is no track on the recording layers 13 particularly in the recording). In other words, the first beam LB1 and the second beam LB2 are irradiated via a common optical system such as the objective lens 102L (in other words, an optical system in which a positional relation between the irradiated light beams is fixed). Thus, the positioning of the first beam LB1 in the surface of the optical disc 11 can be used as the positioning of the second beam LB2 in the surface of the optical disc 12 (i.e. in the recording surface of each recording layer 13) as it is.

On the tracks TR of the guide layer 12, a plurality of servo areas are arranged, each of which has a physical structure for carrying the tracking error signal (or a signal for generating a tracking error, such as the wobble signal as the basis thereof) and the pre-pit signal. Here, the tracking error signal and the pre-pit signal constitute one example of the “guide information for guidance” according to the present invention. The plurality of servo areas constitute one example of the “plurality of guide areas” according to the present invention.

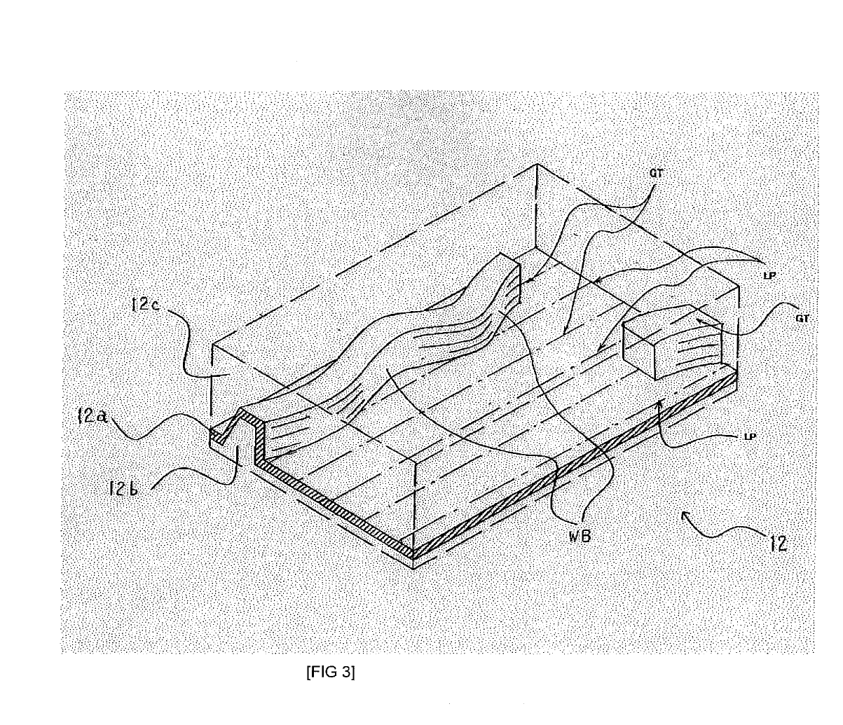

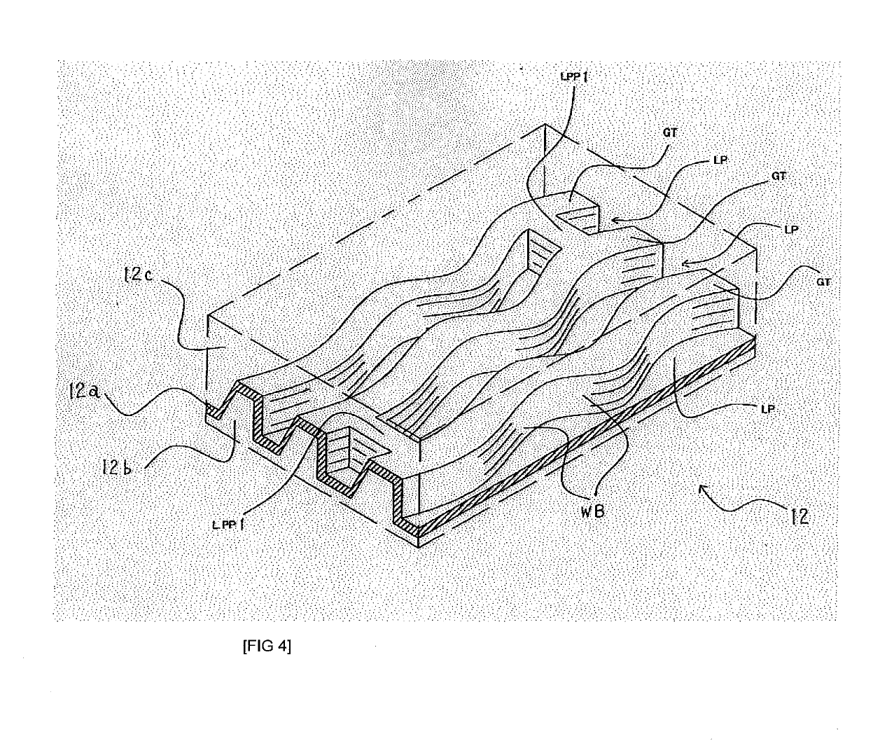

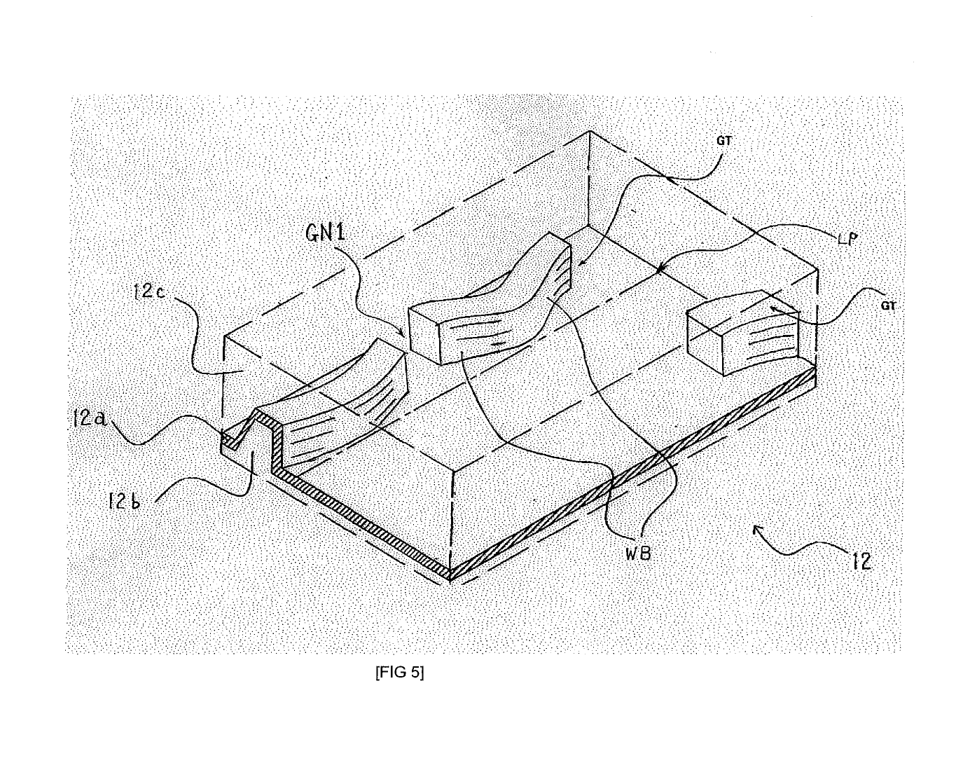

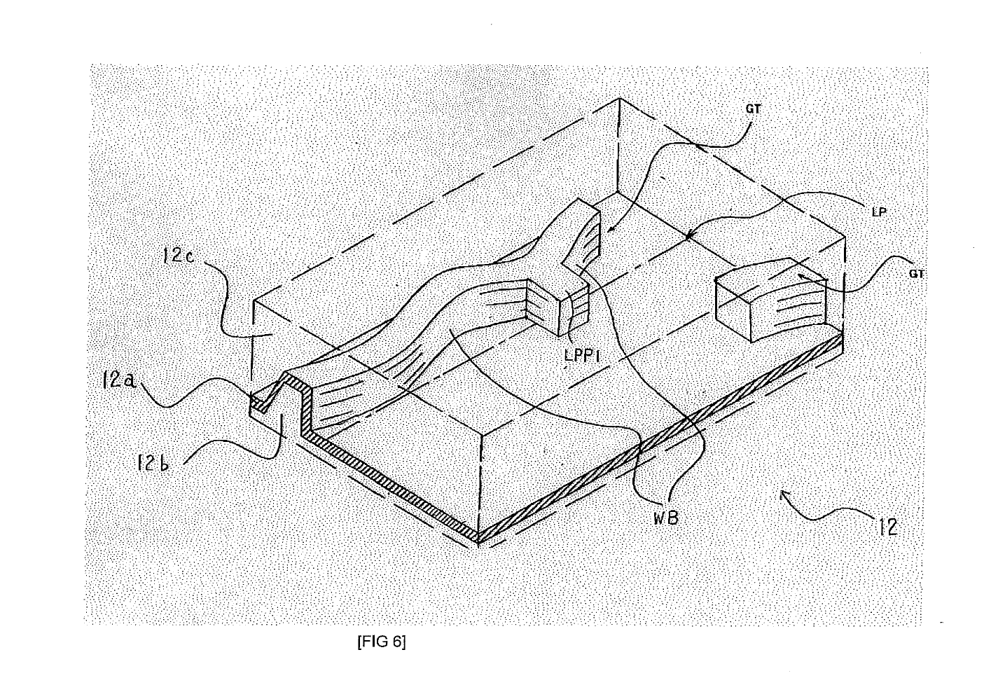

Now, with reference to FIG. 3 to FIG. 6, the physical structure of the guide layer 12 will be described in detail. Each of FIG. 3 to FIG. 6 enlarges an extracted track portion which is subject to wobbling in the guide layer 12. In particular, FIG. 3 illustrates a track portion which is simply subject to the wobbling in the example. FIG. 4 illustrates a track portion of the guide layer 12 in a comparative example in which grooves and lands or the like are formed without gaps throughout the entire area of each track. FIG. 5 illustrates a track portion which has a “wobble and partial-notch structure” in the example and which is subject to the wobbling. FIG. 6 illustrates a track portion which has a “wobble and narrowly defined land pre-pit” in the example and which is subject to the wobbling.

As illustrated in FIG. 3, in the guide layer 12, groove tracks GT corresponding to a specific example of the tracks TR in FIG. 1 are formed. The groove tracks GT are formed by that a reflective film 12a, which is a thin film made of, for example, a photorefractive material, is formed on a transparent film 12c as a base material with uneven grooves formed and is further buried under a transparent or opaque film 12b as a protective film. In the sense of the grooves formed in the transparent film 12c as the base material positioned on the upper side in FIG. 3, the groove tracks GT or grooves are formed in a convex shape toward the upper side in FIG. 3. Alternatively, on the other hand, the groove tracks GT are formed by that the reflective film 12a is formed on the transparent or opaque film 12b as the base material with the uneven grooves formed and is further buried under the film 12c as the protective film.

The groove tracks GT have wobbles WB on the side walls thereof. In other words, the groove tracks GT are formed such that the side walls thereof wobble in a track direction.

In FIG. 3, the grooves are provided only locally. Each of the groove tracks GT, illustrated by an alternate long and short dash line, is positioned at a track pitch corresponding to a track pitch of recorded information tracks constructed from record information owned by each recording layer 13 (refer to FIG. 1) after the recording. Here, a series of the record information on the recording layer 13 along the tracks TR, which is already recorded along the tracks TR of the guide layer 12, is hereinafter simply referred to as “recorded information tracks”, as occasion demands. The information recorded tracks can be said, physically, to be a series of portions along the tracks TR of the guide layer 12, such as a portion in which the fluorescent intensity changes, a portion in which the refractive index changes, a phase-change portion, and a dye-change portion, which is formed on the recording surface of the recording layer 13 by the irradiation of the second beam LB2 in the recording. In other words, even in the groove tracks GT having no grooves formed in FIG. 3, the grooves are formed at a frequency which allows the tracking error to occur at a predetermined frequency. In other words, at a radial position and a track-direction position which are not illustrated in FIG. 3, the grooves are appropriately formed on the groove tracks GT, and basically, there is no groove track GT that has no grooves formed throughout one cycle.

In FIG. 4, in the comparative example, grooves and lands are formed throughout the entire area in the track direction and in the radial direction at the track pitch corresponding to the track pitch of the recorded information tracks constructed from the record information owned by each recording layer 13 (refer to FIG. 1) after the recording. In the typical DVD, BR disc, or the like, the groove tracks GT are configured as in the comparative example in FIG. 4 even in the guide layer, because the recording layer also serves as the guide layer or because the recorded information tracks in the recording layer correspond to the guide tracks in the guide layer in a one-to-one manner.

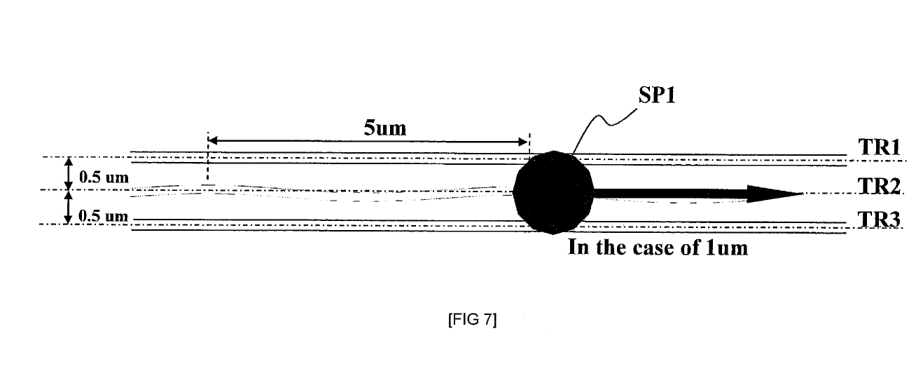

In contrast, in the specific example in FIG. 3, the grooves are not formed throughout the entire area in the track direction on the groove tracks GT. The grooves are not formed on the groove tracks GT which are adjacent to each other in the radial direction either. The quantitative explanation of such arrangement (more specifically, an arrangement interval in the track direction and the radial direction) and an operational effect due to the arrangement will be detailed later with reference to FIG. 7 to FIG. 13.

Incidentally, as illustrated in FIG. 5, groove notches GN1 having a partial-notch structure may be formed in the groove tracks provided in the guide layer 12. The notch is a mirror surface cut throughout one track width of the groove track.

Alternatively, as illustrated in FIG. 6, land pre-pits LPP1 may be formed in land parts LP. Incidentally, even in the comparative example in FIG. 4, the land pre-pits LPP1 are formed. The groove notches GN1 in FIG. 5 and LPP1 in FIG. 6 oppositely appear but have the same effect in reproducing the guide layer.

In addition, in FIG. 6, even in the land parts LP in which there are no pre-pits formed, the pre-pits may be formed as occasion demands.

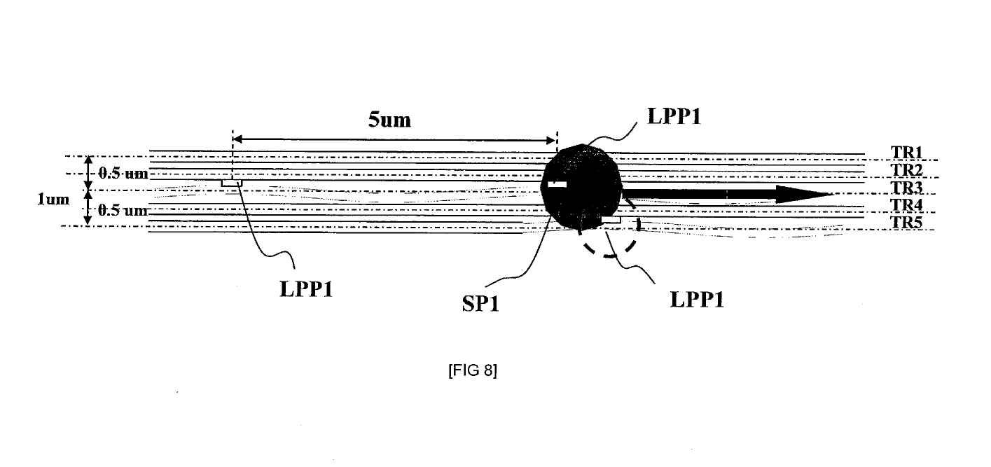

Now, with reference to FIG. 7 and FIG. 8, consideration is given to points to be noted in establishing the tracks TR having the physical structure in which the tracks TR of the guide layer 12 carry the tracking error signal (or the wobble signal as the basis thereof), as described above.

As illustrated in FIG. 7, it is assumed that low-density tracking is performed in which a light spot SP1 is not relatively large with respect to the track pitch. In this case, the light spot SP1 is about 1 μm in diameter (with respect to a track pitch of 0.5 μm) and has little or practically no influence as noise of signals on tracks TR1 and TR3 other than a track TR2 on which the light spot SP1 is focused and which is followed. In other words, even if the groove structure and the wobble structure (refer to FIG. 3), and further, the partial-notch structure (refer to FIG. 5) and the pre-pit structure (refer to FIG. 6) are provided for all the tracks TR1, TR2, TR3, and so on, without gaps in the radial direction and the track direction thereof, the crosstalk does not occur in the tracking error signal (or the wobble signal as the basis thereof). Thus, the tracking can be performed.

As illustrated in FIG. 8, as opposed to this, it is assumed that high-density tracking is performed in which the light spot SP1 is relatively large with respect to the track pitch. In this case, the light spot SP1 is about 1 μm in diameter (with respect to a track pitch of 0.25 μm) and has a significant influence as noise of signals on tracks TR1, TR2, TR4, and TR5 other than the track TR3 on which the light spot SP1 is focused and which is followed. In other words, if the groove structure, the wobble structure, and the like (refer to FIG. 3 to FIG. 6) are provided for all the tracks TR1, TR2, TR3, and so on, without gaps in the radial direction and the track direction thereof, the crosstalk significantly occurs in the tracking error signal. Thus, the tracking cannot be performed.

In particular, in the case of the zone CAV method as in the example, as opposed to the case of the CAV method, an address positional relation (an address difference) on the plurality of adjacent tracks TR changes depending on the radial position. Thus, even if the tracking is possible in one place, there is a significant possibility that the tracking is impossible in another place (i.e. in a position in which the degree of an approach of other signal generation areas is high, where the signal generation areas are adjacent in the radial direction).

The same is true in cases where the land pre-pits LPP1 adjacently exist, as illustrated in FIG. 8. In other words, with respect to the land pre-pits LPP1 provided on the track TR3 which is a tracking target, the pre-pit signal (i.e. a land pre-pit signal) recorded in the land per-pit signal LPP1 surrounded by a dashed line and provided in another track TR5 functions as noise. As a result, the land pre-pit LPP1 cannot be detected at any position, or the land pre-pit LPP1 cannot be detected at some radial-direction position or track-direction position. In other words, the address information or the like by the pre-pit signal cannot be detected. As described above, arrangement is required for reducing the crosstalk not only on the adjacent tracks but also on tracks which are separated by two tracks or more.

The situation as illustrated in FIG. 8 occurs naturally in cases where the first beam LB1 corresponding to the low-density recording (e.g. red laser as in the DVD) is used for the guide layer 12, the second beam LB2 corresponding to the high-density recording (e.g. blue laser as in the BR disc) is used for the recording layer 13 and the narrow-pitch tracks TR is formed in advance in the guide layer 12 such that the information recorded tracks have a narrow pitch after the recording. In other words, it can be said that this is a technical restriction which occurs naturally in cases where the first beam LB1 is used for the guide layer and the second beam LB2, which has a smaller diameter than that of the first beam, is used for the recording layer 13. If the tracks TR with a pitch corresponding to the first light beam LB1 are formed in the guide layer 12, the tracks TR are useless for performing the tracking for the high-density recording in the recording layer 13.

However, the special purpose of performing the tracking in a predetermined frequency band can be achieved without forming the wobble structure for detecting the tracking error signal and the pre-pit structure (refer to FIG. 3 to FIG. 6), on the tracks TR continuously in the track direction, even if it is necessary to generate the tracking error signal in any timing on any track TR. In other words, in the case of an arrangement interval (i.e. arrangement pitch) which is less than or equal to the longest distance that allows the tracking servo to operate in the predetermined frequency band, the wobble structure and the like (refer to FIG. 3 to FIG. 6) for generating the tracking error signal are not required to be formed in the entire area in the track direction on the tracks TR. Moreover, in terms of the plurality of tracks TR which are adjacent to each other, it is not necessary to align the wobble structure for generating the tracking error, in each of positions aligned in the radial direction (i.e. the same phase, or positions or areas providing the same phase, in other words, the same angle, or positions or areas providing the same angle on the optical disc 11) in order to achieve the special purpose.

In addition, for the special purpose of detecting not only the tracking error signal but also another control information for recording control or reproduction control, such as the address information by using the pre-pits such as the land pre-pits LPP1, it is not necessary to form the wobble structure, the pre-pit structure and the like (refer to FIG. 3 to FIG. 6) in the entire area in the track direction on the tracks TR. For example, even if some information is not recorded everywhere in the track direction and the radial direction in advance as if an unrecorded track were filled with stuffing bits, the control information can be detected.

Thus, in the example, in particular, in order to achieve the special purpose of enabling mainly the tracking, the plurality of servo areas are provided on the tracks TR, discretely, in both the track direction and the radial direction, as explained below.

Next, with reference to FIG. 9 to FIG. 11, the physical configuration of three areas, which are a mirror-surface area 21, a servo area 22, and a pattern area 23 as an “area 3”, in the guide layer 12 will be explained in detail.

As illustrated in FIG. 9, the mirror-surface areas 21 as an “area 1”, the servo area 22 as an “area 2” which is used as a “mark area” in which mark information for a detection pattern can be generated, and the pattern area 23 as the “area 3” having a predetermined pattern 23a which allows a tilt detection signal to be generated, are disposed in the guide layer 12.

Here, the mirror-surface area 21 may have a straight groove or a straight land formed. In this case, the mirror-surface area 21 can be referred to as a “groove area”. Alternatively, since the mirror-surface area 21 has a buffering function in reading the other servo area 22 and the other pattern area 23, the mirror-surface area 21 can be referred to as a “buffer area”. In this case, the mirror-surface area 21 is one example of the “buffer area” of the present invention.

In FIG. 9, the mirror-surface area 21, which is one example of the “buffer area” of the present invention, is, for example, an area having the straight groove. The mirror-surface area 21 is adjacently disposed in front of a head portion and behind a tail portion of each of a plurality of servo areas 22 in the track direction.

By the buffer function of the mirror-surface area 21, a preparation period for the detection of a signal from the servo area 22 is given in a servo system in the information recording or the like. In particular, the first beam LB1 can be moved into the servo area 22 in a tracking-on state in the information recording. In other words, the mirror-surface area 21 disposed on the head side of the servo area 22 gives an extremely effective preparation period to stably operate the tracking servo.

The servo area 22 is an area in which the wobble structure and the pre-pit structure are formed in advance, as illustrated in FIG. 3 to FIG. 6, i.e. an area in which the tracking error signal and the pre-pit signal can be detected. The servo areas 22 are mutually arranged discretely at arrangement intervals (i.e. arrangement pitch) of predetermined distance which is set in advance or distance that is less than the predetermined distance in the track direction (a horizontal direction in FIG. 9). Moreover, the plurality of servo areas 22 are disposed throughout the plurality of tracks TR which are adjacent to each other in the radial direction (i.e. a vertical direction in FIG. 9), such that the plurality of servo areas 22 are positively or actively shifted in the horizontal direction (i.e. in the track direction) between the plurality of tracks TR.

The mark information is disposed immediately before the pattern area 23 on a center track 23TR and indicates that the pattern area 23 is located immediately thereafter. Thus, in the recording or reproduction, if the mark information is firstly detected in the servo area 22, it is found that a pattern signal of the pattern area 23 will arrive later without a delay. Alternatively, the mark information indicates timing to sample the pattern area 23 located thereafter, or an address position of the pattern area 23 located thereafter directed from the inner circumference to the outer circumference, or from the outer circumference to the inner circumference, in the track direction, on the center track 23TR. Thus, in the recording or reproduction, if the mark information is firstly detected in the servo area 22, it is found in which timing or at which address position the pattern signal will arrive.

If the first light beam is not on the integrated one center track composed of a plurality of tracks, the wobble signal detected by using a push-pull signal is detected with offset in the pattern area 23. Thus, it can be recognized whether or not the first light beam is on the center track 23TR.

The pattern area 23, which is one example of the “signal detection area” of the present invention, has an integrated predetermined patterns 23a which covers seven tracks adjacent to each other in the radial direction (in a vertical direction in FIG. 9) such that a particular type of pattern signal can be detected, on the center track 23TR (the track illustrated by an alternate long and short dash line extending in a horizontal line in FIG. 9).

On the other hand, the track portion other than the center track 23TR dares to be excluded from a pattern signal detection target even when the center of a first light spot LS1 by the first light beam is directly on the track portion.

The pattern areas 23 are discretely arranged in the track direction (in the horizontal direction in FIG. 9) and are discretely arranged in the radial direction (in the vertical direction in FIG. 9). Thus, even if a track density is increased until the spot of the light beam covers the mutually adjacent seven tracks, it is possible to avoid a situation in which the pattern signal cannot be detected due to the crosstalk of the detected pattern signal.

As the pattern signal, the predetermined pattern 23a is prepared in advance such that the tilt detection signal, such as a tilt error signal, can be generated. Thus, a significant signal change in the tilt detection signal can be obtained when the tilt occurs.

The predetermined pattern 23a is formed of shortly notched grooves or lands which are locally concavo-convex, or short pits or embosses formed in groove tracks or land tracks, or a plurality of pieces of embossed pits. For example, if covering the seven tracks, the predetermined pattern 23a is provided with a set of five embossed pits on either side, i.e. a set of 10 embossed pits on both sides in total, or the like. The predetermined pattern 23a is formed to substantially fit an outer rim shape of the light spot LS1 and has a shape which is substantially along a if the bright ring LS1a is generated. The predetermined pattern 23a may be combined with the wobbles.

Incidentally, the predetermined pattern 23a in the pattern area 23 may be configured such that various signals are detected as the pattern signal, such as an eccentricity signal for eccentricity correction of a disc, an inclination signal for inclination correction of a disc surface, an aberration signal for aberration correction of an optical system, a phase difference signal for phase difference correction of a light beam, a distortion signal for distortion correction, a light absorption signal for light absorption correction, and a strategy signal for setting of a strategy, in addition to the tilt detection signal.

Here, a particular purpose of enabling tilt correction based on the tilt detection signal can be achieved without forming the tilt detection signal continuously on all the tracks TR, even though there is a need to make it possible to detect the tilt detection signal on any of the tracks TR. In other words, the particular purpose can be achieved if the tilt detection signal is detected in accordance with frequency or a period to perform the tilt correction, such as the tilt detection signal being detected once in each period in which tilt servo is locked.

Thus, on one hand, if the tilt detection signal can be obtained on every seven tracks in one GR, the tilt correction can be performed. On the other hand, in the case of an area along the track TR, if the tilt detection signal can be obtained at some intervals or at any phase (e.g. angles on a disc), the tilt correction can be performed. After all, it is enough to obtain the tilt detection signal intermittently on every seven tracks in one GR on the center track 23TR which represents the seven tracks.

In the example, the fact that the first beam LB1 (e.g. red laser) has a larger beam diameter than that of the second beam LB2 (e.g. blue laser) is extremely advantageous to detect the group of predetermined patterns 23a which covers the seven tracks TR which constitute one group GR, by using the first beam LB1.

In the pattern area 23 having the tilt detection pattern as described above, arrangement with degree of freedom is possible. In addition, by providing a pattern signal other than the tilt detection signal in response to processing other than the tilt correction, it is also possible to perform other processing in parallel with the tilt correction or as occasion demands.

Moreover, in the example, in particular, the servo area 22 carrying the mark information, which indicates that the pattern area 23 is located thereafter, is disposed in front of the pattern area 23 on the center track 23TR in the track direction. The mark information is information reproduced by using the wobble signal and the pre-pit signal or the like corresponding to the wobbles and the pre-pits or the like which are discretely formed in the servo area 22.

Thus, the tilt detection signal can be read, easily and certainly, on the basis of the arrival of the mark information. For example, it is possible to start preparation for starting to detect the tilt detection signal after the detection of the mark information, or further preparation for starting the tilt correction based on the tilt detection signal. For example, by defining in advance a phase relation and an interval between the tilt detection signal and the mark information, it is possible to easily specify sampling timing to detect the tilt detection signal from the mark information. Alternatively, by providing the mark information with the address position at which the tilt detection signal is recorded, it is possible to easily specify the sampling timing to detect the tilt detection signal.

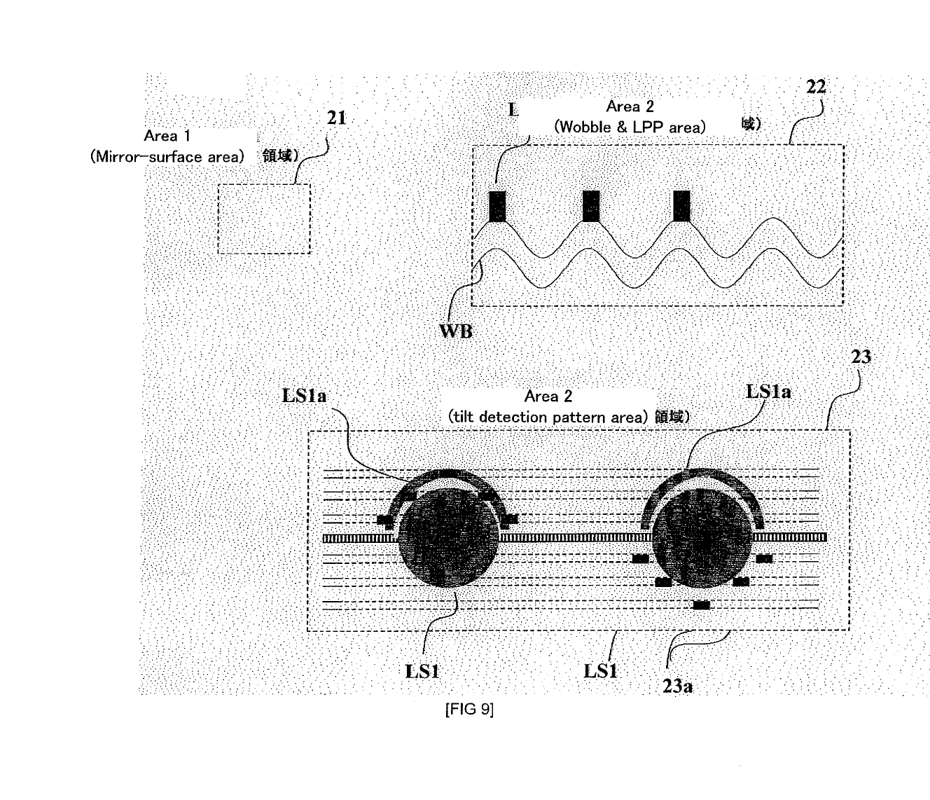

As illustrated in FIG. 10, a track-formed surface on the guide layer 12 on which the concentric or spiral tracks TR as configured above are formed is divided in accordance with the zone CAV method. In other words, long and narrow areas along circumferences in substantially the same radial direction are assigned as a zone 1, a zone 2, a zone 3, and so on.

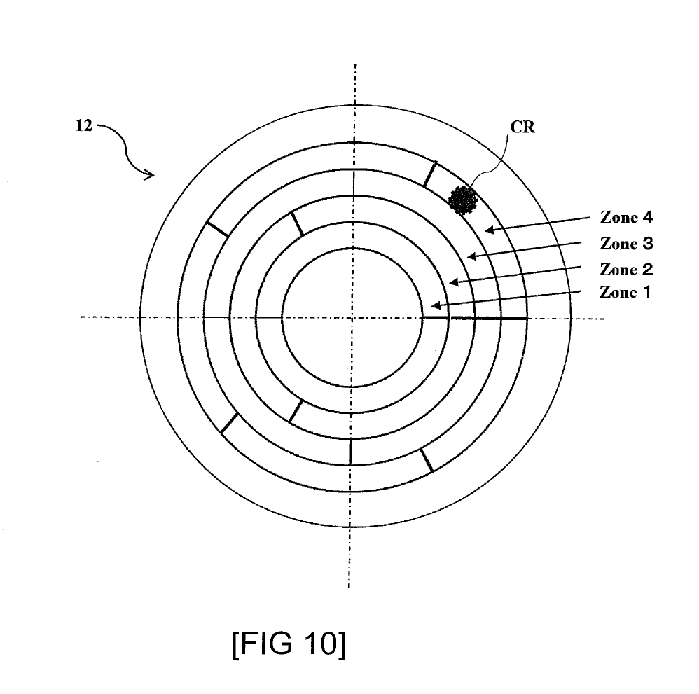

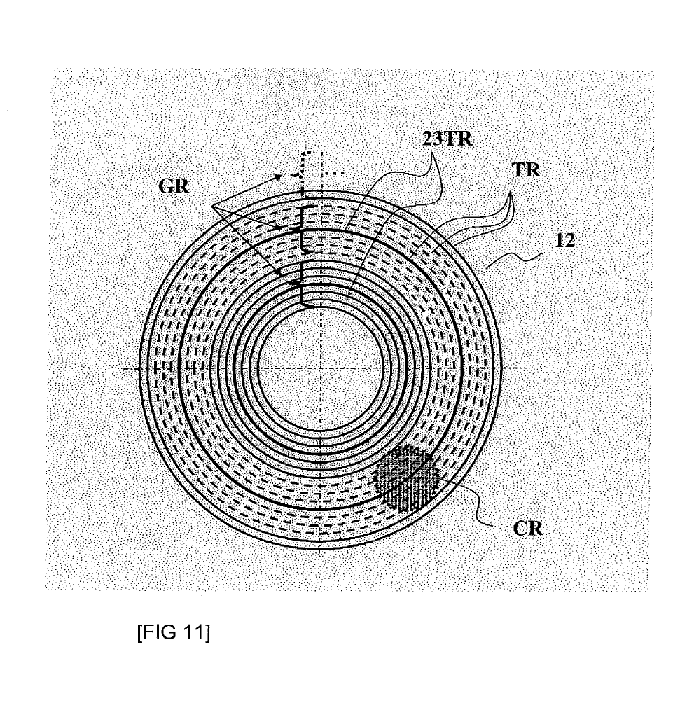

As illustrated in FIG. 11, the concentric or spiral tracks TR as configured above are grouped in units of a plurality of groups GR, and the track located in the center of each group is determined to be the center track 23TR. On the basis of the position of the center track 23TR determined in this manner, in particular, the predetermined pattern of the pattern area 23 is determined.

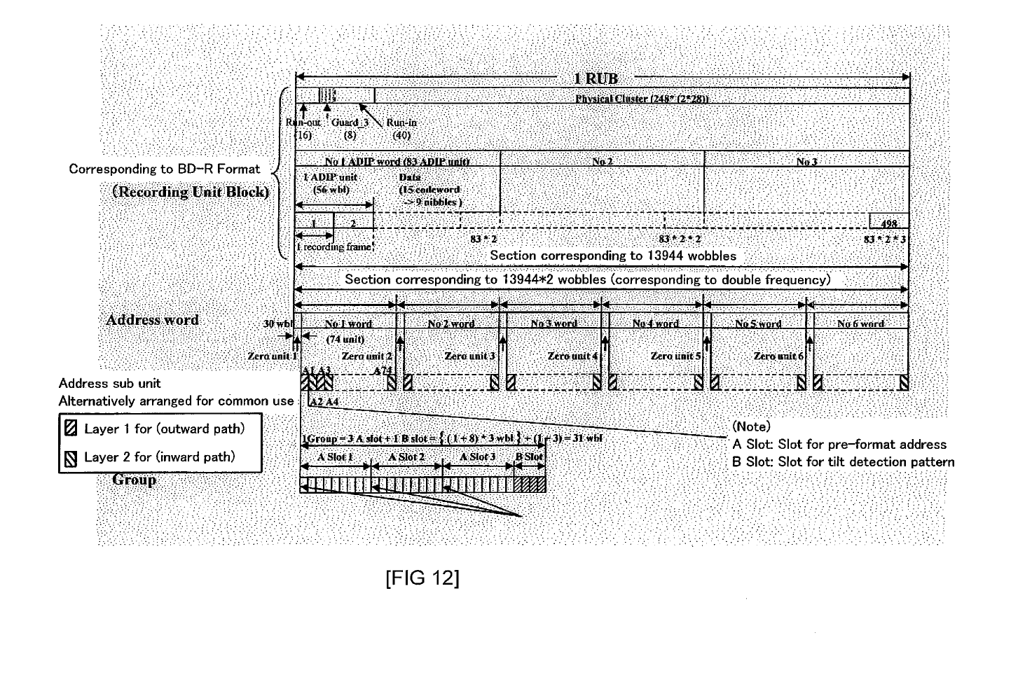

Next, a detailed configuration of a small area illustrated by a CR portion in FIG. 10 and FIG. 11 will be explained with reference to FIG. 12 to FIG. 17.

Next, with reference to FIG. 12 to FIG. 17, a specific data configuration of the servo area 22 and the pattern area 23 in the guide layer 12 will be explained in detail.

Incidentally, in this example, signals recorded in the servo area 22 and the pattern area 23 are provided in units of slots. Here, the “slot” is a logical section or division or a physical section or division obtained by dividing the track TR in the track direction. The slots are typically arranged continuously without gaps in the track direction and arranged without gaps in the radial direction or adjacently to each other. In this case, since control such as the tracking servo and the tilt servo is performed indirectly in the guide layer 12, the control becomes easy to be performed if a data format in the recording layer 13 is set to have a constant relation with the slot.

FIG. 12 illustrates one configuration example of a pre-format in the servo area 22 and the pattern area 23 in the guide layer 12.

In FIG. 12, the pre-format configuration is configured to be commonly used for two layers of the recording layers 13 (i.e. a recording layer for an outward path and a recording layer for an inward path). Thus, the recording layer for the outward path has a three-address configuration, and the recording layer for the inward path has a three-address configuration. Moreover, there is provided the pattern area 23 for the tilt detection.

More specifically, one RUB is configured to correspond to the format of a BD-R (Blue ray Disc-Recordable: a Blue ray disc in which recording can be performed once).

Specifically, one RUB physically includes (248×(2×28)) physical clusters and logically includes three ADIP words (ADIP words No. 1 to No. 3).

One ADIP word consists of 83 ADIP units. One ADIP unit consists of 56 wobbles (wbl), which corresponds to two recording frames. The data to be recorded has a unit of 15 code words, i.e. nine nibbles. Therefore, one RUB is a section corresponding to 13944 wobbles.

Each of six address words (i.e. No. 1 to No. 6) included in one RUB has 74 address mark sub-units (servo mark sub-units) (i.e. A1 to A74). At the head of each servo mark word, a zero unit, which is 30 wbl, is disposed.

Moreover, each servo mark sub-unit consists of four slots. The first three slots (A Slots) are assigned to a slot for a servo mark (i.e. a “slot for a pre-format address”). The following one slot (B Slot) is assigned to a slot for the tilt detection (i.e. a slot for the tilt detection pattern). In other words, one servo mark sub-unit corresponds to the four slots in total, which are the three A Slots and the one B Slot, and thus includes {(1+8)×3}(+3)=31 wbl in total.

Thus, in the example, the length of one RUB is 2{(31×74)×3+(30×3)}=13944 wbl. Moreover, in the example, a length D of one wobble disposed at the head of each slot is set such that D=1 wbl>1.2 μm (the maximum diameter of the light spot).

As described above, in terms of a pre-address configuration example, six-address configuration is adopted for one RUB, and each address includes 70 units. It also includes address data (37 bits) and is (1 Slot Data)×37 Units=2 bits×37 Units=74 bits.

Incidentally, regarding the configuration of an ECC block, for example, by using 72 bits (=8 bits×9) out of 74 bits, 4 Bytes is used as an ECC code as 5 Bytes raw data.

For example, regarding codes C₀, . . . , C₉ (Parity C₅, . . . , C₈), a Reed-Solomon code is generated in the following manner.

$$\begin{matrix}\begin{matrix}Parity A ( X ) = {\sum }_{J = 5}^{9} {C}_{j} \cdot {X}^{9 - j} \\ = \{ I ( X ) \cdot X \} mod \{ {G}_{E} ( X ) \}\end{matrix} & [ Equation 1 ] \\ {I}_{j} ( X ) = {\sum }_{J = 0}^{4} {C}_{j} \cdot {X}^{4 - j } & [ Equation 2 ] \\ {G}_{E} ( X ) = {\prod }_{k = 0}^{4} ( X + {α}^{k} ) & [ Equation 3 ]\end{matrix}$$

Here, α is a primitive element.

Gₚ(x)=X⁸+X⁴+X³+X²+1

According to the configuration example in one RUB unit as described above, if the recording data format in another recording layer 13 complies with, for example, a BD-R format, the cycle of the wobbles provided for the servo area 22 has a predetermined integral ratio relation with a constituent unit of the data format in one recording layer. A section of the pattern area 23 and a position to be disposed thereof are also set to have a predetermined relation with the cycle of the wobbles. Thus, the predetermined position of the pattern area 23 can be specified from the wobble signal detected from the mark area of the servo area 22. Thus, a recording/reproducing apparatus described later can easily prepare timing to sample a specific parameter detection error.

In particular, even if a measure is taken to solve a new problem caused by that the first beam LB1 for reading the guide layer 12 is for lower-density than a reading beam for the BD-R format, data such as a pre-address required as a pre-format for recording can be formed by a desired information amount. Since a buffer area D (i.e. one portion of the mirror-surface area 21) for removing an influence by the beam diameter and the four slots are provided in one unit, and it is thus possible to remove an influence of the servo area 22 and the pattern area 23, which are disposed in adjacent tracks, when obtaining the pre-format data. It is also possible to remove the influence by the beam diameter of a pickup 102, thereby stably obtain the pre-format information.

In the example, in particular, the address sub-units A1 to A74 are alternately assigned to the outward path (i.e. for the recording layer for the outward path) and to the inward path (i.e. for the recording layer for the inward path).

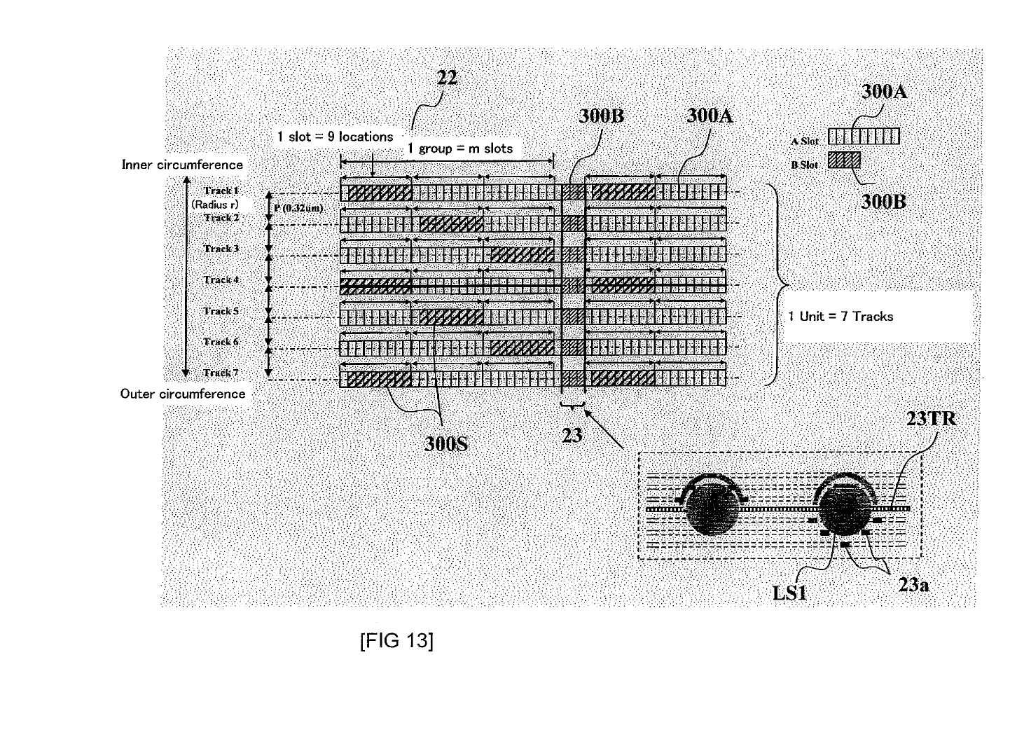

FIG. 13 illustrates a configuration example of a slot 300A (i.e. “A Slot”).

In FIG. 13, the slot 300A consists of nine locations. Out of the nine locations, the first one location is assigned to a buffer area for avoiding an influence caused by a beam size or the like. The remaining eight locations are assigned to an area for disposing a physical shape (area 2) for the following two purposes; namely, (1) to generate a sample error signal for the tracking servo, and (2) to constitute one portion of pre-format address data. One group consists of m slots (m=3 in the example).

For example, the value of m is determined from a predetermined condition. The servo area 22 is disposed at least in any one of the slots in one group. A condition for the arrangement (including the determination of the value of m) of the slots 300A (i.e. “A Slots”) will be explained later with reference to FIG. 14.

In FIG. 13, in the servo areas 22, the wobbles are formed in units of slots, as the mark information. Sample servo marks 300S are also formed in units of slots, discretely in the track direction (in a horizontal direction in FIG. 13) and at intervals of two tracks in the radial direction (in a vertical direction in FIG. 13) in respective tracks TR (Track 1 to Track 7) in a form of being widely distributed in a left-side area in FIG. 13 in the servo area 22 (the servo area 22 also used as a servo area).

In the servo area 22, the slots 300A (i.e. “A Slots (refer to FIGS. 11 12)”) are arranged in the form that the sample servo marks 300S are widely distributed according to a predetermined rule, as described above. In the pattern area 23, slots 300B (i.e. “B Slots (refer to FIG. 12)”) are arranged in a form of aligning substantially in the radial direction. Before or after the pattern area 23, three wobbles are ensured as an overlap area 400.

In the example, the length in the track direction of the tilt detection signal on the track TR and the length in the track direction of the constituent unit, such as an ECC block, a recording unit block (RUB), and an ADIP unit, in the format of data which is recorded into each of the recording layers 13 may be configured to have a predetermined integral ratio. In this manner, it becomes easy to maintain the frequency of generating the tilt detection signal and the cycle of recording the data into the recording layer 13 at a position in the recording surface corresponding to the track TR, in a constant relation, regardless of the radial position or the track position. In particular, if the zone CAV method is adopted, the tilt correction can be stably performed on the basis of the detected tilt detection signal at any radial position, even though an angular velocity varies depending on the radial position. Moreover, even if the zone CAV method is adopted, the stable tilt correction can be performed on the basis of the detected tilt detection signal without any problem in each zone.

In FIG. 13, in the pattern area 23, the tilt detection pattern is formed by a slot unit as the pattern signal in the slot 300B. In the pattern area 23, one pattern is established in a form of covering the seven tracks, as the tilt detection pattern. As illustrated as the pattern area 23 in a rectangle at the lower right of the drawing, in this example, a pattern which fits an upper half on the outer rim of the light spot LS1 (i.e. the bright ring LS1a) is formed immediately after the servo area 22, and subsequently, at a slight distance therefrom, a pattern which fits a lower half on the outer ring of the light spot LS1 (i.e. the bright ring LS1a) is formed. One tilt detection pattern is established from the two patterns.

Now, with reference to FIG. 14, the condition for the arrangement (including the determination of the value of m) of the slots 300A will be explained.

As illustrated in FIG. 14, in the determination condition for m (wherein m is the number of the slots that constitute one group), firstly, the number of tracks “n” in which the reading is possibly simultaneously performed is determined from (1) the beam size and (2) the track pitch for recording in the recording layer 13, and then, m is determined to be m=(n−1)/2.

At this time, as the arrangement condition for the servo area 22, the slot 300A is disposed in at least one of “Slot 1” to “Slot m+1” so as not to overlap, in the radial direction, the servo areas 22 which are already arranged one track before (an inner-side adjacent track), two tracks before (an inner-side adjacent track of the track one track before), . . . , and m tracks before.

In the example, n=5 and m=2. Thus, the slot 300A is disposed in any of “Slot 1” to “Slot 3”. For example, regarding a slot 300A-1, as illustrated by a dashed-line arrow therefrom, it may be adaptively arranged from the “Slot 1” to “Slot 2”. For example, regarding a slot 300A-2, as illustrated by a dashed-line arrow therefrom, it may be adaptively arranged from the “Slot 1” to “Slot 3”.

By arranging the slots 300A and the slots 300B in the relation as illustrated in FIG. 13 and FIG. 14, there is no longer any influence by the format in which the arrangement is performed in mutually different conditions. Thus, the two types of slots can be used for making and recording the data, as occasion demands, in response to their respective purposes.

In the pattern area 23, a predetermined specific parameter detection pattern for the pattern area 23 is formed such that a predetermined tilt error can be detected on the center track 23TR, with the seven tracks grouped in one group GR (refer to FIG. 13). Thus, by tracking or following the center track 23TR of the pattern area 23, it is possible to detect the predetermined specific parameter detection pattern at that position.

In FIG. 13, in grouping a plurality of tracks into one group GR, the number of the tracks is seven in the example, as a result of determination in view of the track pitch, the beam diameter of the first beam LB1, expanse of the first beam LB1 on a guide layer surface in cases where the disc is tilted or inclined with respect to the pickup, and the like. The tilt detection pattern formed in the pattern area 23 is detected bilaterally symmetrically to the tracks TR. Thus, generally, the tracks are odd-numbered.

As described above, the servo area 22 is disposed immediately before the center track TR in which the specific parameter detection error can be detected by the specific parameter detection pattern from among the seven tracks TR which belong to the pattern area 23, and it is thus possible to recognize that the first beam LB1 as a reading beam is located on the center track TR in which the specific parameter detection error can be detected. Therefore, it is possible to easily prepare the sample timing of detecting the specific parameter detection error.

On the other hand, if the first beam LB1 is not on the center track TR in one pattern area 23 composed of the plurality of tracks, the wobble signal detected by using the push-pull signal is detected with offset. Thus, it is possible to recognize that the first light beam is not on the center track TR.

In addition, in the example, the sample servo marks 300S are arranged in the separated slots in both the track direction and the radial direction (refer to FIG. 13). Thus, when the data is recorded into one recording layer 13 while the tracks TR of the guide layer 12 are tracked or followed by the first beam LB1, it is possible to stably and continuously generate the tracking error signal by sampling the push-pull signal or by sampling the phase difference signal in differential phase detection (DPD). For example, if a high-frequency component of the push-pull signal, which is a difference between left and right partition detectors, is removed by a low pass filter (LPF), a wobble component and an unnecessary high-frequency noise component can be removed. Here, by sampling the tracking error signal including an eccentric component from the inner circumference to the outer circumference, the tracking error signal can be obtained continuously and it can be used as the tracking error signal in performing the recording into the recording layer 13.

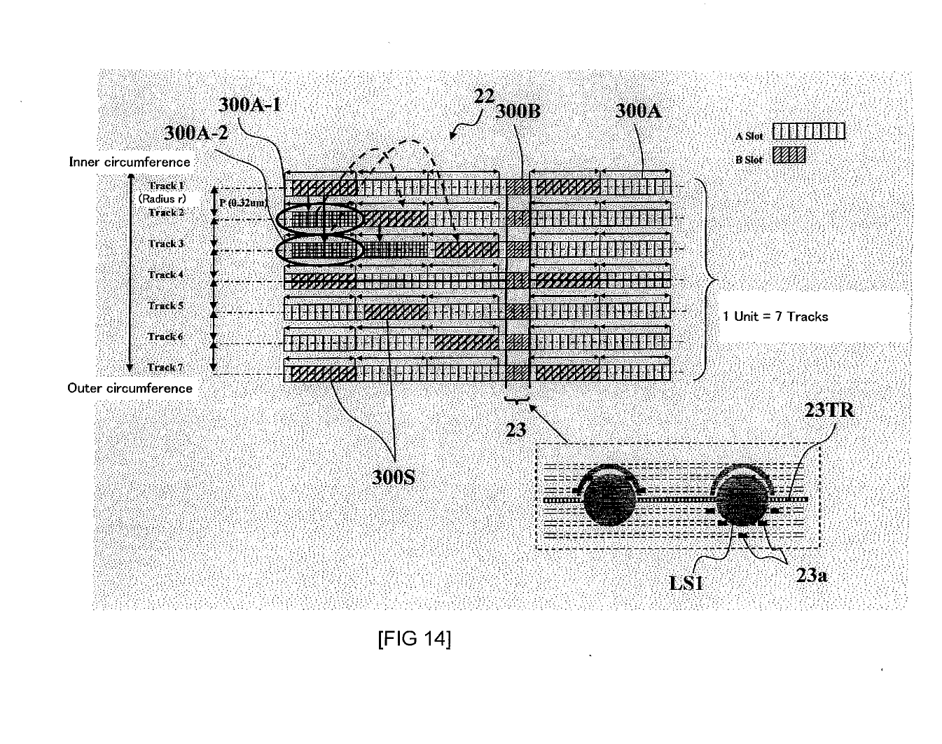

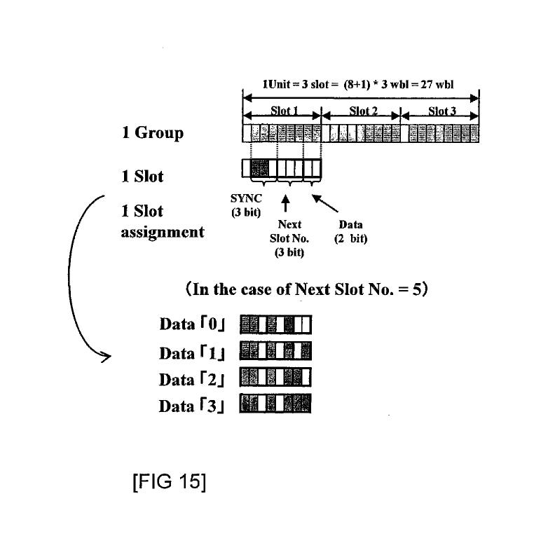

As illustrated in FIG. 15, in one example of the assignment of data in one slot, the first two or three bits out of nine bits in each slot are assigned to a SYNC signal (i.e. a sync signal capable of detecting the tracking error signal). The subsequent three bits are assigned to a slot number (Slot NO.), and the subsequent two bits are assigned to the data (i.e. control data, address data, etc.). For example, the two-bit data allows each of data values (Data) “0” to “3” to be expressed as bit arrangement as illustrated in the lower half of the drawing (if the following slot number is “5”).

Incidentally, regarding the configuration of the ECC block, for example, by using 192 bits (=8 bits×24) out of 206 bits, 12 Bytes raw data+12 Bytes is used as an ECC code.

Incidentally, in the example, one wobble is regarded as 69×2=138 channel bits. The first one wobble (in other words, one bit) of each slot may be assigned to the mirror-surface area 21 (refer to FIG. 9).

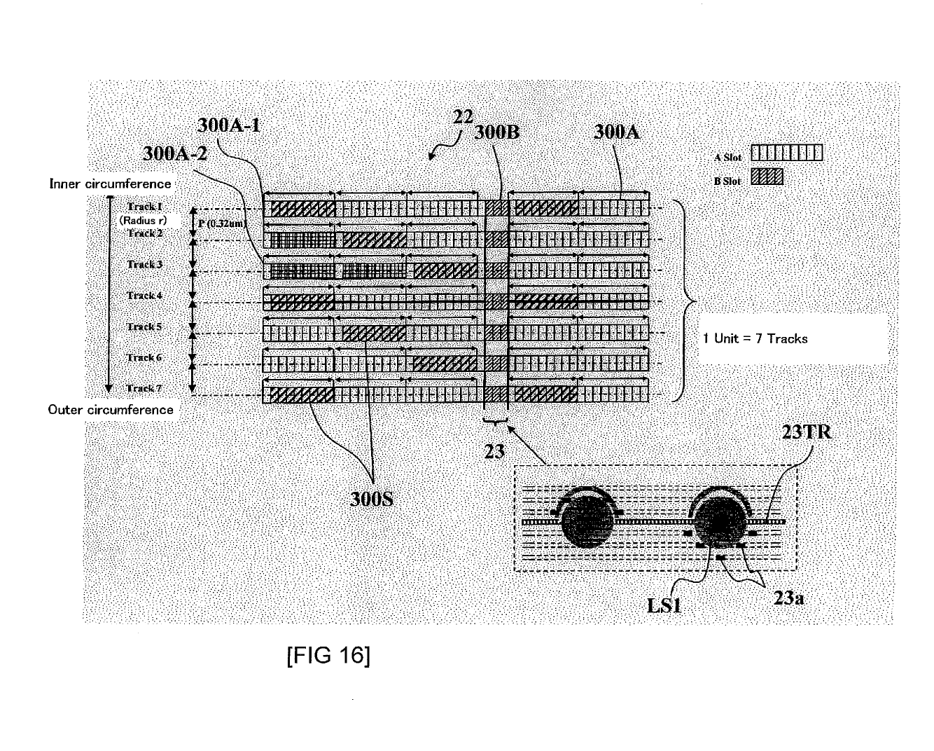

Next, with reference to FIG. 16, a configuration example of the slot 300B (i.e. “B Slot”) will be explained.

In FIG. 16, one slot B consists of four locations. The first one location is a buffer area for avoiding the influence caused by the beam size or the like. The remaining three locations are an area for disposing the tilt detection pattern. One unit consists of k tracks.

Here, regarding a determination condition for “k”, “k” may be determined from the beam size, the track pitch for performing the recording into the recording layer, and the track in which amount of return light is influenced by the tilt. In the example, k=7. Regarding an arrangement condition of the pattern area 23, with respect to the slot 300A (i.e. “A Slot”). the B Slot is disposed at a predetermined ratio (e.g. an arrangement ratio of A:B is 9:4 in the example).

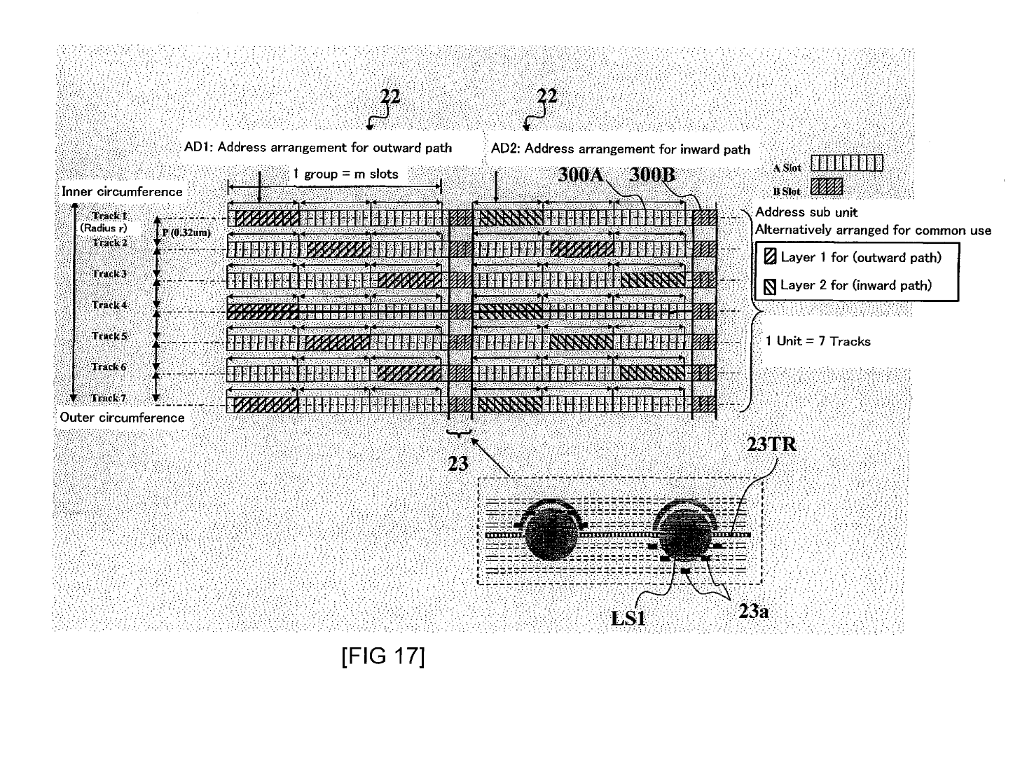

With reference to FIG. 17, the pre-address configuration will be further explained. FIG. 17 illustrates a configuration example of the slot A (configuration for both the outward path and the inward path).

In FIG. 17, the left side in the drawing of the slots 300B arranged in the pattern area 23 is address arrangement for the outward path, and the sample servo marks 300S in this area are, for example, outward path addresses for the first layer of the recording layers 13. In contrast, the right side in the drawing of the slots 300B is address for the inward path, and the sample servo marks 300S in this area are, for example, outward and inward addresses for the second layer of the recording layers 13. The slots or record information used for both the outward path and the inward path are alternately arranged because they are used for the two purposes.

As the pre-address configuration for the outward path and the inward path, the pre-address corresponding to one RUB has a six-address configuration, including a three-address configuration for the outward path and a three-address configuration for the inward path. Each address consists of (74/2)=37 sub-units. The address data is (1 Slot Data)×(37 sub-units)=2 bits×37=74 bits. If the ECC configuration is configured as described above, it can be configured separately for the outward path and for the inward path.

As described above, according to the pre-address configuration example in the example, the tracks are concentric or spiral, and the outward path addresses and the inward path addresses are alternately arranged as the CAV method in the zone. Thus, in one format, a pre-format for outward path recording and a pre-format for inward path recording can be used in one guide layer.

For example, if the recording is performed from the inner circumference to the outer circumference, only the pre-format portion for the outward path is obtained as the address, while the pre-format address portions for the outward path and the inward path are used for tracking signal detection. In the recording, in the case of the concentric tracks, the recording is performed with a one-track jump. Alternatively, in the case of the spiral track, the recording is performed continuously. If the recording is performed from the outer circumference to the inner circumference, only the pre-format portion for the inward path is obtained as the address, while the pre-format address portions for the outward path and the inward path are used for the tracking signal detection. In the recording, in the case of the concentric tracks, the recording is performed with a one-track jump. Alternatively, in the case of the spiral track, the recording is performed with a two-track jump.

As explained above in detail with reference to FIG. 1 to FIG. 17, according to the track formation method in the example (refer to FIG. 9), if the tracks TR in the guide layer 12 are formed by using, for example, the sample servo marks (refer to FIG. 13, etc.) discretely arranged in positions corresponding to recorded information tracks such that the recorded information tracks in the recording layer 13 are spirally formed, continuously from the inner circumference to the outer circumference, the servo area 22 and the pattern area 23 are discretely formed in predetermined positions or at predetermined intervals. Thus, the detection of the specific parameter detection error by a recording/reproducing apparatus described later can be performed in any position of the entire surface of the optical disc 11. As a result, it is possible to perform high-accuracy tilt detection and high-accuracy tilt correction by stably and efficiently obtaining the tilt detection signal in the guide layer 12 which is different from the recording layer 13 while improving the track pitch and the recording linear density (e.g. a linear recording density, a pit pitch, or an information transfer rate (i.e. recording linear density×moving speed)) which allow the recording or reproduction in each recording layer 13 to the extent that it can be said as the “high-density recording”, which is an intended purpose in the optical disc 11 of the multilayer type.

Particularly in the example illustrated in FIG. 12 to FIG. 17, the sample servo marks 300S are disposed in the slots separated in both the track direction and the radial direction. Thus, when the data is recorded into one recording layer 13 while the tracks TR of the guide layer 12 are tracked or followed by the first beam LB1, it is possible to stably and continuously generate the tracking error signal by sampling a push-pull signal or by sampling a phase difference signal in differential phase detection (DPD). For example, if a high-frequency component of the push-pull signal, which is a difference between left and right partition detectors, is removed by a low pass filter (LPF), a wobble component and an unnecessary high-frequency noise component can be removed. Here, by sampling the tracking error signal including an eccentric component from the inner circumference to the outer circumference, the tracking error signal can be obtained continuously and it can be used as the tracking error signal in performing the recording into the recording layer 13.

In particular, as illustrated in FIG. 12, in the example, the SYNC, the data, and the like are assigned to the bits in each slot, and the pre-pits are formed or not formed for one wobble wave, and partial information required for a pre-format address configuration as the servo area 22 or the sample servo mark 300S can be appropriately disposed in the desired slot. The pre-pit is to judge presence/absence, and the data is not recorded into the guide layer 12 in the optical disc 11 as in the example, and it is thus enough to detect the LPP in the initial state. This facilitates the detection of the pre-pit signal on a recording apparatus or reproducing apparatus detailed later.

Particularly in the example illustrated in FIG. 12 and FIG. 13, one slot including the servo area 22 or the sample servo mark 300S is appropriately disposed not to overlap another slots including the servo areas 22 or the sample servo marks 300S disposed not only on the adjacent track which is one track before but also on two tracks before. Thus, even if the first beam LB1 (e.g. red laser) for reading the guide layer 12 is for lower-density than the second beam LB2 for the BD-R format, it is possible to avoid the influence by the servo areas 22 disposed on the plurality of adjacent tracks TR in detecting the wobbles and the pre-pits. Thus, the good pre-format data can be obtained.

Incidentally, in the example, the servo area 22 means an area in which the mark information is disposed, and the mark area is also used as the “guide area” or the “servo area” in the present invention. In other words, information for the tracking servo, such as the guide information or the sample servo mark, is also recorded in the servo area 22. In this sense, the servo area 22 can be also referred to as the “servo area 22”. The servo area 22 is an area having the two functions because both the mark information and the guide information are mixedly disposed.

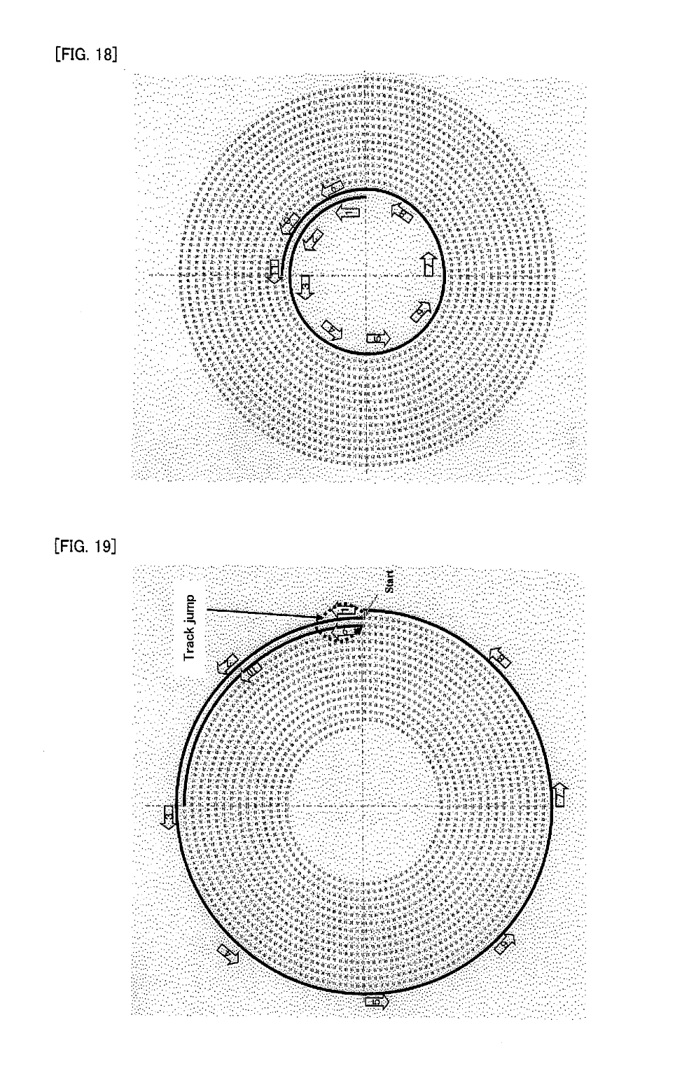

Firstly, with reference to FIG. 18 and FIG. 19, consideration will be given to the occurrence of the track jump and a reciprocating recording operation in the case where the tracks TR in the zone CAV method in the guide layer 12 are concentric.

In FIG. 18, it is assumed that the reciprocating recording operation is started from the innermost circumference of the concentric tracks TR and that the tracking by the first light beam is performed from a “Start” point in the drawing as illustrated by “arrow 1”, “arrow 2”, . . . , and “arrow 8”. At this time, if a track jump TJ is performed toward the track TR on the outer circumferential side, the subsequent tracking by the first light beam is performed on a slightly outer circumferential side as illustrated by “arrow 9”, “arrow 10”, and so on. If the recording is performed from the inner circumference to the outer circumference as described above, the track jump TJ is performed without any problem.

In FIG. 19, it is assumed that the reciprocating recording operation is started from the outermost circumference of the concentric tracks TR and that the tracking by the first light beam is performed from a “Start” point in the drawing as illustrated by “arrow 1”, “arrow 2”, . . . , and “arrow 8”. At this time, if the track jump TJ is performed toward the track TR on the inner circumferential side, the subsequent tracking by the first light beam is performed on a slightly inner circumferential side as illustrated by “arrow 9”, “arrow 10”, and so on.

As described above, even on the premise of the concentric tracks TR, if the recording is performed from the inner circumference to the outer circumference and if the recording is performed from the outer circumference to the inner circumference, the track jump TJ allows the reciprocating recording operation to be performed without any problem.

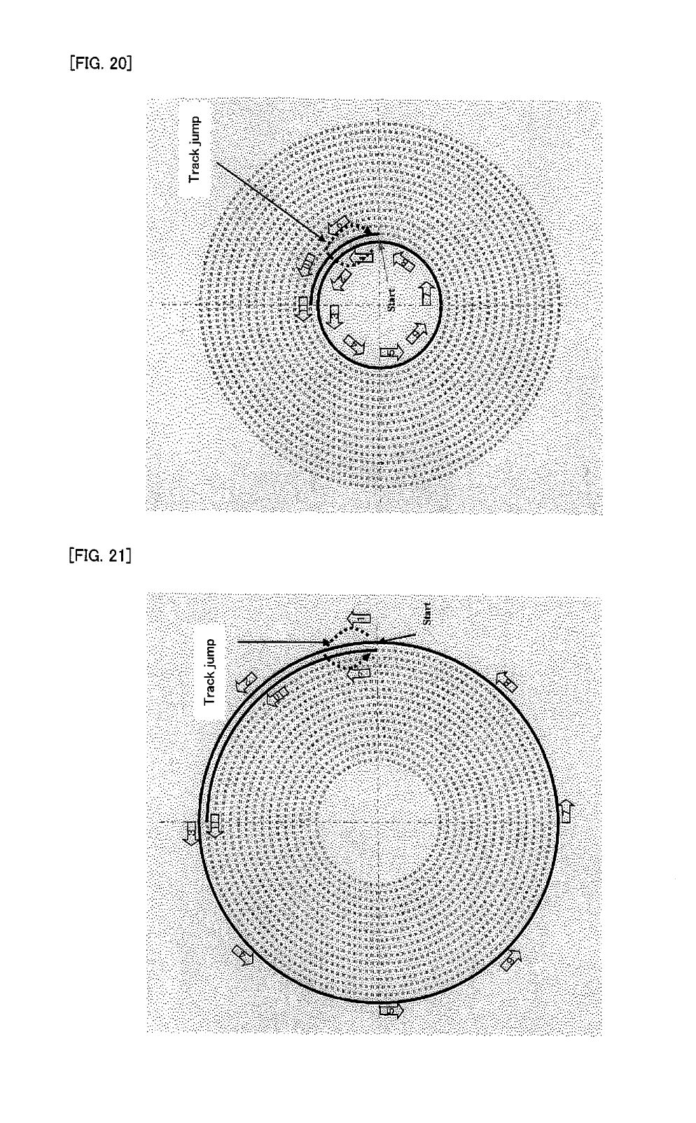

Next, with reference to FIG. 20 and FIG. 21, consideration will be given to the occurrence of the track jump and the reciprocating recording operation in the case where the track TR in the zone CAV method in the guide layer 12 is spiral.

In FIG. 20, it is assumed that the reciprocating recording operation is started from the innermost circumference of the spiral track TR and that the tracking by the first light beam is performed as illustrated by “arrow 1”, “arrow 2”, . . . , and “arrow 8”. At this time, even if the track jump TJ is not performed, the tracking by the first light beam can be moved to the outer side as illustrated by “arrow 9”, “arrow 10”, and so on, on the slightly outer circumferential side. If the recording is performed from the inner circumference to the outer circumference as described above, there is no problem even without the track jump TJ.

In FIG. 21, it is assumed that the reciprocating recording operation is started from the outermost circumference of the spiral track TR and that the tracking by the first light beam is performed from a “Start” point in the drawing as illustrated by “arrow 1”, “arrow 2”, . . . , and “arrow 8”. At this time, if the track jump TJ is performed toward the track TR on a two-track inner circumferential side, the subsequent tracking by the first light beam is performed on a slightly inner circumferential side as illustrated by “arrow 9”, “arrow 10”, and so on.

As described above, even on the premise of the spiral track TR, if the recording is performed from the inner circumference to the outer circumference and if the recording is performed from the outer circumference to the inner circumference, the track jump TJ allows the reciprocating recording operation to be performed without any problem.

### <Example of Information Recording/Reproducing Apparatus and Method>

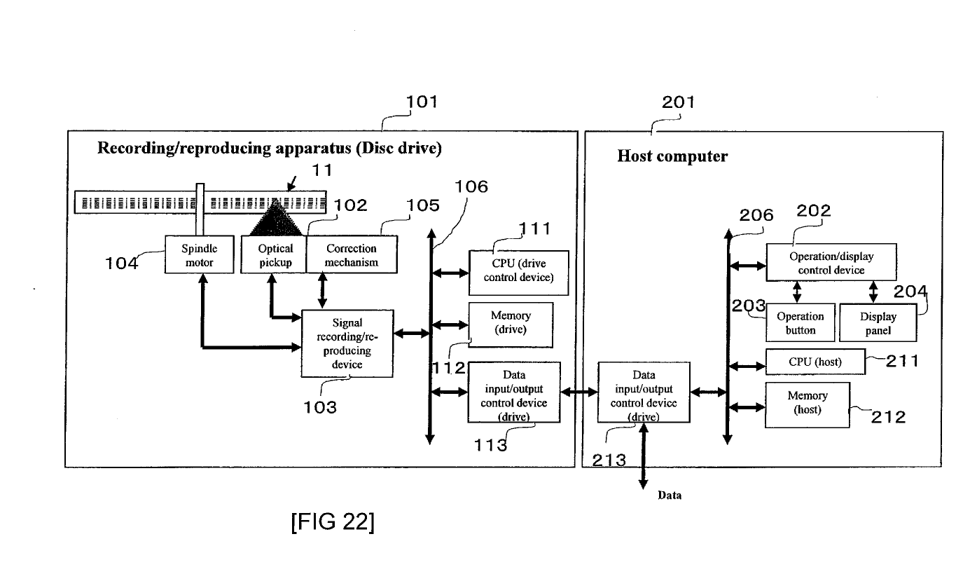

Next, with reference to FIG. 22 to FIG. 27, an example of the information recording/reproducing apparatus and method of the present invention will be explained.

In FIG. 22, a recording/reproducing apparatus 101 is configured as a disc drive as one example of the “information recording apparatus” and the “information reproducing apparatus” of the present invention, and it is connected to a host computer 201.

The recording/reproducing apparatus 10 is provided with: an optical pickup 102; a signal recording/reproducing unit 103; a spindle motor 104; a bus 106; a CPU (drive control unit) 111; a memory 112; and a data input/output control unit 113. In the recording, the first beam LB1 and the second beam LB2 are irradiated via the objective lens 102L (refer to FIG. 2) provided for the optical pickup 102. In the reproduction, only the second beam LB2 which also serves as a light beam for tracking, or both the first beam LB1 and the second beam LB2 are irradiated via the objective lens 102L in the same manner.

The host computer 201 is provided with: an operation/display control unit 202; an operation button 202; a display panel 204; a bus 206; a CPU 211; a memory 212; and a data input/output control unit 213. In the recording, the data to be recorded is inputted from the data input/output control unit 213. In the reproduction, reproduced data is outputted from the data input/output control unit 213.

The optical pickup 102 is provided with: a red semiconductor laser for emitting the first beam LB1; a blue semiconductor laser for emitting the second beam LB2; and a synthesis/separation optical system provided with a prism, a mirror, or the like including the objective lens 102L. The optical pickup 102 is configured to irradiate the first beam LB1 and the second beam LB2 via the common objective lens 102L, coaxially and with different focuses (refer to FIG. 1 and FIG. 2).

Moreover, the optical pickup 102 includes: a light receiving element such as a two-division or four-division CCD for receiving reflected light from the optical disc 11 caused by the first beam LB1 via the objective lens 102L; and a light receiving element such as a two-division or four-division CCD for receiving reflected light from the optical disc 11 caused by the second beam LB2 via the objective lens 102L. The optical pickup 102 can modulate the second beam LB2 at recording intensity which is relatively high in the recording and can set the second beam LB2 at reproduction intensity which is relatively low in the reproduction.

The optical pickup 102 and the signal recording/reproducing unit 103 are configured to generate the tracking error signal, for example, by a push-pull method or differential phase detection (DPD), and to further reproduce the pre-pit signal or the address information, by using a light receiving signal from the light receiving element for receiving the reflected light from the guide layer 12, at least in the recording.

The optical pickup 102 and the signal recording/reproducing unit 103 are configured to generate the tracking error signal, for example, by the push-pull method or differential phase detection, and to generate, for example, a data signal as a signal corresponding to the entire quantity of light, by using a light receiving signal from the light receiving element for receiving the reflected light from the recording layer 13, at least in the reproduction.

Alternatively, the optical pickup 102 and the signal recording/reproducing unit 103 are configured to generate the tracking error signal by using the light receiving signal from the light receiving element for receiving the reflected light from the guide layer 12 and to generate the data signal by using the light receiving signal from the light receiving element for receiving the reflected light from the recording layer 13, in the reproduction.

The memory 112 and the memory 212 are used as occasion demands to temporarily or permanently hold (i) a computer program for controlling each element such as the CPU 111 of the recording/reproducing apparatus 101 and each element such as the CPU 211 of the host computer 201 so as to perform a recording/reproducing operation explained below and (ii) various data such as control data, processing data, and processed data, required for the recording/reproducing operation, via the bus 106, the bus 206, or the like.

Particularly in the example, the recording/reproducing apparatus 101 is further provided with a correction mechanism 105. The correction mechanism 105 is one example of the “processing device” of the present invention and is typically a tilt correction mechanism. The correction mechanism 105 may be various correction mechanisms, such as a mechanism for eccentricity correction of the optical disc 11, a mechanism for inclination correction of a disc surface, a mechanism for aberration correction of an optical system, a mechanism for phase difference correction of a light beam, a mechanism for distortion correction, a mechanism for light absorption correction, and a mechanism for setting of a strategy, in addition or instead of the tilt correction mechanism. By the correction mechanism 105, a particular type of processing (typically, the tilt correction) is performed on the optical pickup 102, on the basis of the pattern signal (typically, the tilt detection signal) detected from the guide layer 12. For example, in the case of the tilt correction, it is performed every time the tilt detection signal is detected, and the tilt servo is locked in a period until the next tilt detection signal is detected.

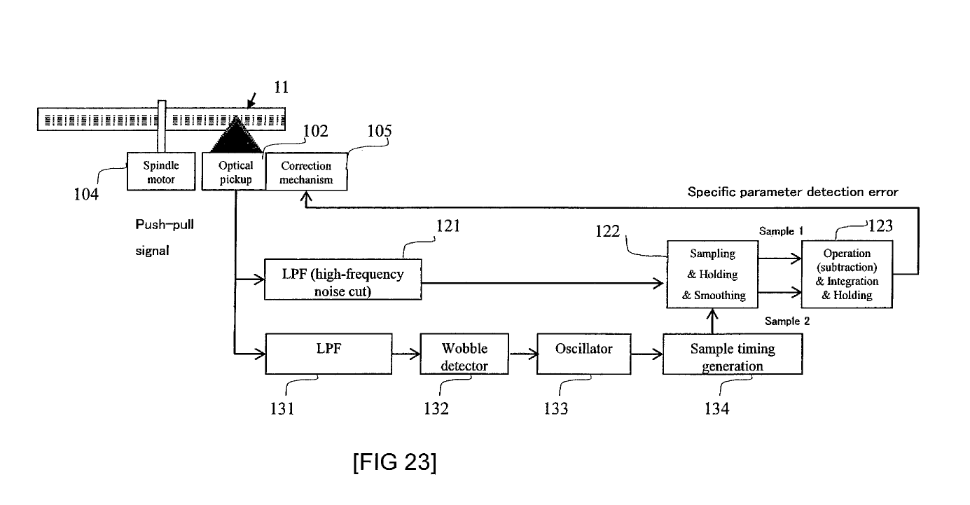

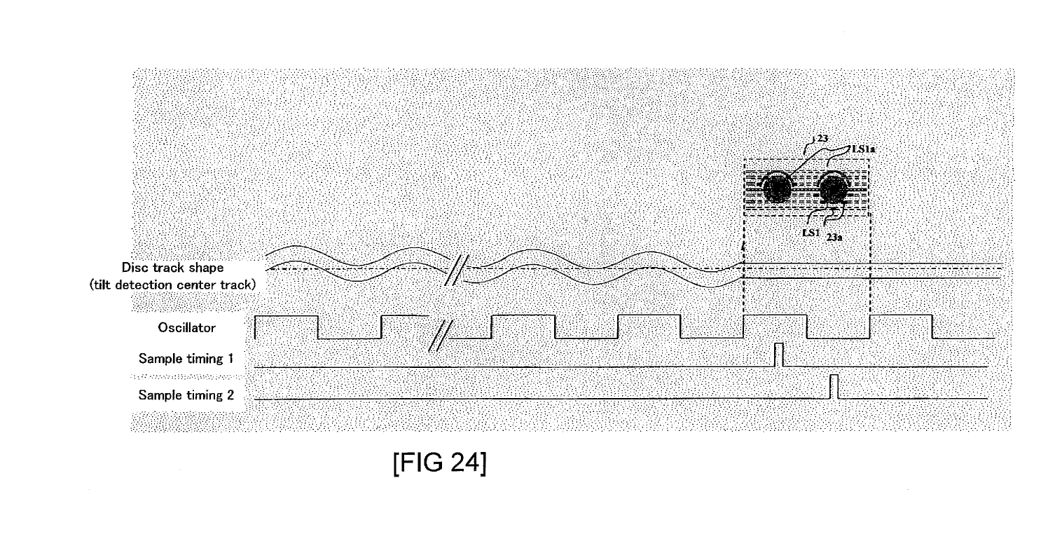

Now, with reference to FIG. 23 and FIG. 24, out of the recording/reproducing apparatus 101, the details of a part associated with the correction performed on the correction mechanism 105 will be explained.

In FIG. 23, the correction mechanism is provided with a low pass filter (LPF) 121, a sampling & holding & smoothing circuit 122, an operation (subtraction) & integration & holding circuit 123, a LPF 131, a wobble detector 132, an oscillator 133, and a sample timing generation circuit 134.

Firstly, the push-pull signal from the light receiving element of the optical pickup 102 is inputted to each of the LPF 121 and the LPF 131, and a high-frequency noise is cut.

Then, on one hand, an output signal with the high-frequency noise cut on the LPF 131 is subject to wobble detection by the wobble detector 132, and oscillation is performed on the oscillator 133 at a frequency corresponding to the detected wobble.

As illustrated in FIG. 24, here, a rectangular wave corresponding to the wobble in a disc track shape is outputted from the oscillator 133.

In FIG. 23, in accordance with the oscillation output, a sample timing signal is generated by the sample timing generation circuit 134. As illustrated in FIG. 24, the sampling timing signal is a rectangular pulse for closing a sampling switch located in the center of the output pulse from the oscillator 133.

On the other hand, an output signal with the high-frequency noise cut on the LPF 121 is sampled, held, and further smoothed by the sampling & holding & smoothing circuit 122. At this time, the timing of the sampling is based on the sample timing signal generated by the sample timing generation circuit 134. As illustrated in FIG. 24, in accordance with the sample timing signal, the pattern signal (e.g. the tilt detection signal) can be detected in good timing from the pattern area 23.

Output signals, which are a sample 1 and a sample 2 from the sampling & holding & smoothing circuit 122, are subtracted, integrated, and further held by the operation (subtraction) & integration & holding circuit 123. As a result, a specific parameter error signal is generated, for example, as the pattern signal which makes one pattern by covering the seven tracks, or on the basis of the pattern signal obtained in this manner.

If the specific parameter error signal is inputted to the correction mechanism 105, a driving operation on the correction mechanism 105 is performed in accordance with characteristics, such as a value of the signal, a positive or negative sign, or the degree of modulation. For example, in the case of the tilt correction, the driving is performed so as to reduce a tilt error by using an actuator for the tilt correction.

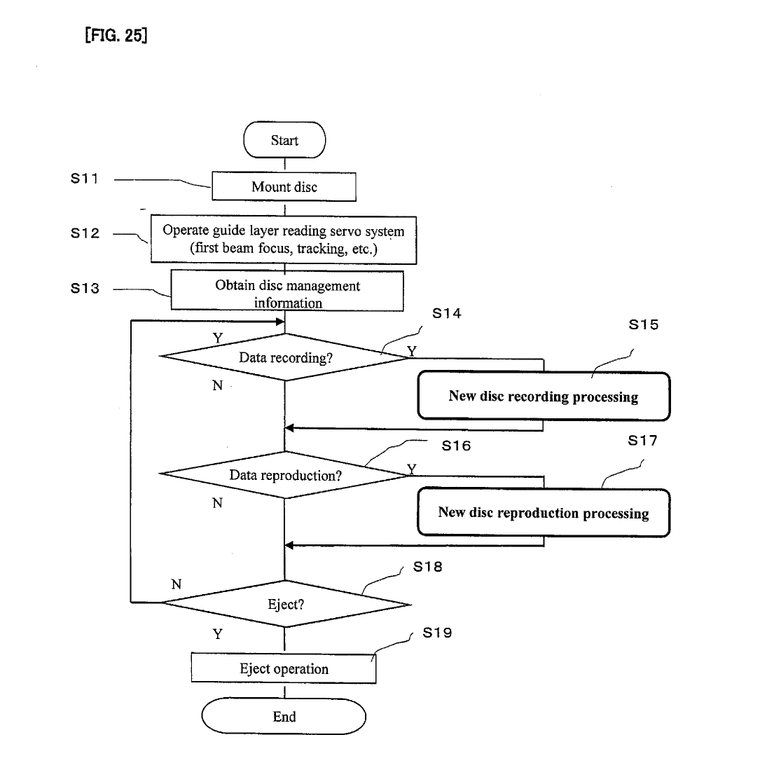

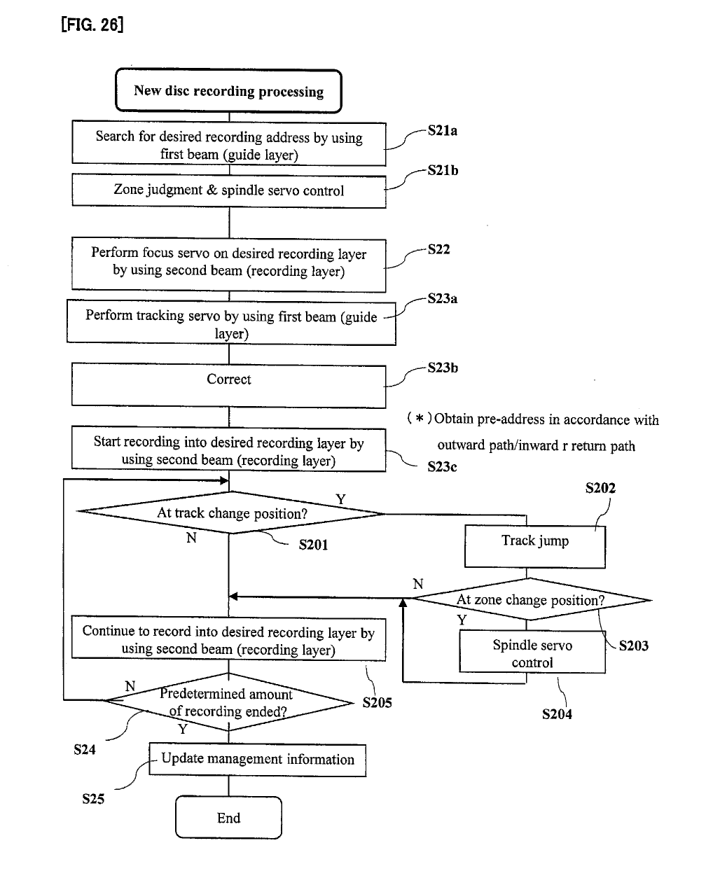

Hereinafter, with reference to FIG. 25 to FIG. 27 in addition to FIG. 22, the configuration and operation of each constituent of the recording/reproducing apparatus 101 in the example will be explained, with the entire operation of the recording/reproducing apparatus 101. FIG. 25 illustrates the recording/reproducing operation of the recording/reproducing apparatus 101. FIG. 26 illustrates the details of one example of the recording operation. FIG. 27 illustrates one example of the reproducing operation.

In FIG. 25, firstly, the optical disc 11 in the format according to the example described above is mounted on the recording/reproducing apparatus 101 by mechanical or manual operation by a user (step S11).

Then, an operation start command according to operation performed on the operation button 203 by the user while watching the display panel 204 is issued by the operation/display control unit 202 and the CPU 111 on the drive side and the CPU 211 on the host side or the like. In response to the operation start command, under the control by the signal recording/reproducing unit 103, the rotation of the optical disc 11 is started by the spindle motor 104. Before or after this, under the control by the signal recording/reproducing unit 103, light irradiation by the optical pickup 102 is started. Moreover, a reading servo system for the guide layer 12 is operated. In other words, the first beam LB1 is irradiated and focused on the guide layer 12, by which the tracking operation is started (step S12).

Incidentally, the transfer of various commands including the operation start command and the various data including user data and control data is performed via the bus 206 and the data input/output control unit 213 on the host side and the bus 106 and the data input/output control unit 113 on the drive side.

Then, the irradiation onto the tracks TR by the first beam LB1 is kept on the guide layer 12, and the wobble signal and the pre-pit signal (moreover, the tracking error signal obtained from at least one of these signals by the push-pull method or DPD) are detected from the servo area 22. Moreover, disc management information recorded in advance as at least one of these signals is obtained by the CPU 111 on the drive side or the CPU 211 on the host side or the like.

Incidentally, the disc management information may be collectively recorded and read in a lead-in area, a table-of-content (TOC) area, and the like which are located on the innermost circumferential side of the guide layer 12. The content may comply with the disc management information of the existing DVD, BR disc, or the like. Management information may be recorded in advance or separately previously, in the lead-in area, the TOC area, and the like which are specially provided for the recording layers, and this may be read at this time point or an arbitrary time point.

Then, it is judged whether or not operation required by the CPU 111 on the drive side or the CPU 211 on the host side or the like is data recording (step S14). If it is the data recording (the step S14: Yes), recording processing for a new optical disc 11 is performed (step S15). The recording processing will be detailed later (refer to FIG. 26).

On the other hand, if it is not the data recording in the judgment in the step S14 (the step S14: No), or if the recording processing for the new optical disc 11 is completed in the step S15, it is judged whether or not the operation required by the CPU 111 on the drive side or the CPU 211 on the host side or the like is data reproduction (step S16). Here, if it is the data reproduction (the step S16: Yes), reproduction processing for the new optical disc 11 is performed (step S17). The reproduction processing will be detailed later (refer to FIG. 27).

If it is not the data reproduction in the judgment in the step S16 (the step S16: No), or if the reproduction processing for the new optical disc 11 is completed in the step S17, it is judged whether or not ejection, i.e. tray ejection or the like, is required via the operation button 203 or the like (step S18). Here, if the ejection is not required (the step S18: No), the operational flow returns to the step S14, and the subsequent steps are performed again.

On the other hand, if the ejection is required in the judgment in the step S18 (the step S18: No), the ejection operation is performed (step S19), and a series of recording/reproducing processing for the optical disc 11 is completed.

Next, with reference to FIG. 26, one example of the recording processing for the new optical disc 11 (the step S15 in FIG. 27(25?)) will be explained.

In FIG. 26, if the recording processing is started, firstly, the wobble signal and the pre-pit signal are detected from the servo area 22 while the irradiation onto the tracks TR by the first beam LB1 is kept (i.e. while the tracking operation remains performed) on the guide layer 12, under the control by the CPU 111 and the signal recording/reproducing unit 103. By this, the address information on the tracks TR is obtained by the CPU 111 or the like. By referring to the address information, a desired recording address specified as an address to start the data recording is searched for by the CPU 211 or the like. In other words, the first beam LB1 is moved to the address position. By this search operation, the second beam LB2 which shares the optical system such as the objective lens 102L in the optical pickup 102 with the first beam LB1 (refer to FIG. 1 and FIG. 2) is also moved to a planar position in the recording surface corresponding to the searched recording address on the recording layer 13 (step S21a).

Then, a zone of the optical disc 11 in the zone CAV method is judged, and spindle servo control is performed in accordance with the judged zone to set a rotational speed suitable for the zone (step S21b).

Then, under the control by the CPU 111 and the signal recording/reproducing unit 103, focus servo by the second beam LB2 is performed by the optical pickup 102 on the desired recording layer 13 to record the data therein (step S22).

Then, the tracking servo for the tracks TR by the first beam LB1 is kept in a state in which the focus servo by the second beam LB2 is closed, by the optical pickup 102. In other words, the tracking servo for the desired recording layer 13 is performed indirectly by the tracking servo for the guide layer 12 (step S23a).

Then, correction is performed on the correction mechanism 105 on the basis of a specific parameter detection result (refer to FIG. 23 and FIG. 24). The correction is performed intermittently, regularly, or irregularly, in accordance with the detection of the pattern signal, such as the tilt detection signal. For example, in the case of the tilt correction, the tilt correction is performed in accordance with the tilt error signal, the tilt servo is locked after the correction, and the next correction opportunity is waited for (step S23b).

The correction in the step S23b may be performed, at least partially, in a process of recording the data in a next step S23c.

Then, the data recording into the desired recording layer 13 is started by irradiating the second beam LB2 with it modulated in accordance with the value of the data to be recorded (step S23c).

Then, it is judged whether or not the optical pickup 102 reaches a track change position by the CPU 111 or the like (step S201). Here, if the optical pickup 102 reaches the track change position (the step S201: Yes), the track jump is performed (step S202).

Then, it is judged whether or not the optical pickup 102 reaches a zone change position by the CPU 111 or the like (step S203). Here, if the optical pickup 102 reaches the zone change position (the step S203: Yes), the spindle servo control is performed to set a rotational speed corresponding to a new zone, and the rotational speed suitable for the zone is set (step S204).

After the step S204, or if the optical pickup 102 does not reach the zone change position in the judgment in the step S203 (the step S203: No), or if the optical pickup 102 does not reaches the track change position in the judgment in the step S201 (the step S201: No), then, the recording of the data into the recording layer 13 is continued (step S205).

Then, it is monitored whether or not a predetermined amount of recording is ended by the CPU 111 or the like (step S24). Here, unless the recording is ended, the data recording into the recording layer 13 is continued (the step S24: No).

Here, if the recording is ended (the step S24: Yes), the management information is updated in accordance with the recorded data (step S25). The management information may be collectively recorded in the lead-in area, the TOC area, or the like which is provided for at least one of the plurality of recording layers 13. The position may be on the inner circumferential side, but may be on the outer circumferential side or in the middle, or may be recorded in a somewhat dispersed form. In addition to or instead of this, management information provided for the memory 112, the memory 212, or the like and linked to the optical disc 11 may be updated.

This is the completion of the series of recording processing for the new optical disc 11 (the step S15 in FIG. 25).

Next, with reference to FIG. 27, one example of the reproduction processing for the new optical disc 11 (the step S17 in FIG. 25) will be explained. This example is an example in which the first beam LB is not used for the tracking or the like in the reproduction processing. In other words, in this example, as opposed to the recording processing, the second beam LB2 is used also for the tracking.

In FIG. 27, the focus servo by the second beam LB2 is performed on the desired recording layer 13 to reproduce the data therefrom by the optical pickup 102, under the control by the CPU 111 and the signal recording/reproducing unit 103, and before or after this or in parallel with this, the tracking servo by the second beam LB2 is performed on the recorded information tracks (step S31).

Then, the recorded address information on the recorded information tracks is obtained by the CPU 111 or the like. A desired reproduction address, which is specified as an address to start the reproduction of the desired data, is searched for by the CPU 211 or the like, by referring to the address information. In other words, the second beam LB2 is moved to the address position (step S32).

Then, correction is performed on the correction mechanism 105 on the basis of a specific parameter detection result (refer to FIG. 23 and FIG. 24). The correction is performed intermittently, regularly, or irregularly, in accordance with the detection of the pattern signal, such as the tilt detection signal. For example, in the case of the tilt correction, the tilt correction is performed in accordance with the tilt error signal, the tilt servo is locked after the correction, and the next correction opportunity is waited for (step S33a).

The correction in the step S33a may be performed, at least partially, in a process of reproducing the data in a next step S33b.

Then, the data reproduction from the desired recording layer 13 is started by receiving the reflected light caused by the second beam LB2 via the objective lens 102 L, in a state in which the tracking servo and the focus servo are closed, by the optical pickup 102 (step S33b).

Then, it is monitored whether or not a predetermined amount of reproduction is ended by the CPU 111 or the like (step S34). Here, unless the reproduction is ended, the data reproduction from the recording layer 13 is kept (the step S34: No).

Here, if the reproduction is ended (the step S34: Yes), the series of reproduction processing for the new optical disc 11 (the step S17 in FIG. 25) is completed.

As explained in detail with reference to FIG. 22 to FIG. 27, the pattern area is disposed, with the plurality of tracks as one group GR. Thus, free or arbitrary arrangement is possible in the integrated (grouped) tracks, and the degree of freedom can be ensured in the arrangement of specific parameter detection points, such as tilt error detection points, which can be detected by the recording/reproducing apparatus 101. One pattern area 23 and another adjacent pattern area 23 are independent of each other. Thus, it is possible to dispose the specific parameter detection patterns, such as the tilt detection patterns, independently of each other, and arrangement with the degree of freedom is possible throughout the entire surface of the optical pickup 11 as a whole.

As the guide layer 12, the arrangement in this format can realize easy-reading and extremely advantageous arrangement for the recording/reproducing apparatus 101 which simultaneously reads the plurality of tracks TR which are densified, because the pattern area 23 is disposed with the simultaneously read plurality of tracks TR as one group GR.

Moreover, the servo area 22 is formed by wobbling the grooves in the guide layer 12. Thus, the recording/reproducing apparatus 101 can recognize the accurate position of the pattern area 23 (refer to FIG. 23 and FIG. 24) by using the wobble signal detected in the servo area 22, and the recording/reproducing apparatus 101 can easily generate the sample timing of the detected error signal. Particularly at this time, the cycle of the wobbles of the servo area 22 and the section of the pattern area 23 are set to have a predetermined integral ratio (refer to FIG. 8), and it is thus possible to easily generate the sample timing.

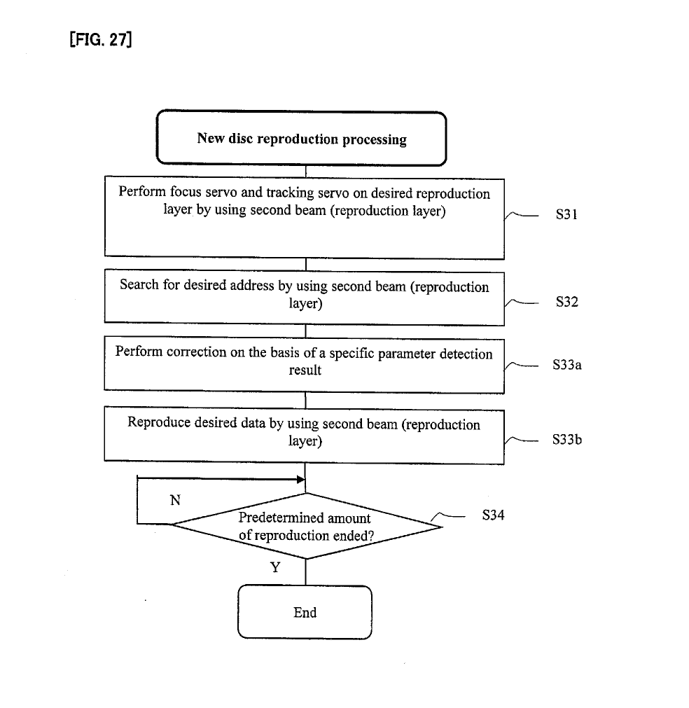

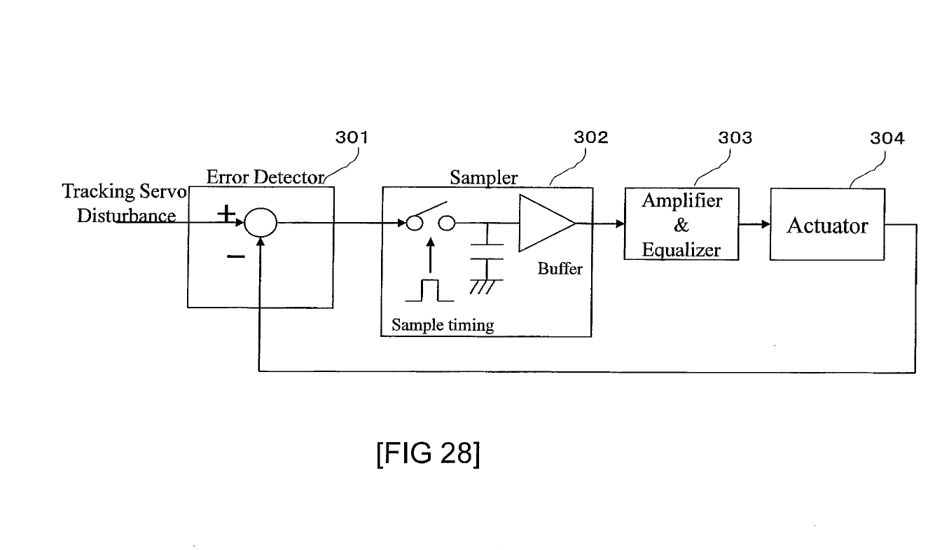

Next, with reference to FIG. 28 to FIG. 31, an explanation will be given to a method of determining the arrangement interval or the longest arrangement interval (i.e. one example of the “predetermined distance” of the present invention) of the servo areas 22 discretely arranged in the track direction by which the tracking servo can operate in the predetermined frequency band, together with a tracking servo system.

As shown in FIG. 28, the tracking servo system includes: an error detector 301 including a subtractor; a sampler 302 including a sampling switch, a capacitor, and a buffer; an amplifier and equalizer 303; and an actuator 304.

In the error detector 301, a disturbance for the tracking servo is inputted, and a feedback signal from the actuator 304 is subtracted (minus added), and a subtracted signal is outputted. The subtracted signal from the error detector 301 is inputted to the sampler 302.

The sampler 302 is configured as a so-called “zero-order hold circuit” for holding a sample value. Specifically, there are provided: the sampling switch which is configured to close at sampling timing; the capacitor for holing it; and the buffer. In the sampler 302, the subtracted signal is sampled by the sampling switch at sampling timing according to a frequency band for operating the tracking serve, is further held by the capacitor, and is buffered by the buffer. The sampling timing is generated by a mark signal, such as, for example, the wobble signal and the pre-pit signal, detected by the light receiving element for receiving the first beam LB1. Incidentally, a method of generating the sampling timing is not limited to this, and the sampling timing may be generated in accordance with a medium configuration in a modified example or the like described later. Moreover, the configuration of the sampler 302 is also not limited to this and may be a “first-order hold circuit” or the like.

The buffer output from the sampler 302 as sampled above is amplified and equalized by the amplifier and equalizer 303 and is further inputted to the actuator 304.

In accordance with the inputted amplified signal, the irradiation position of the first beam LB1 on the guide layer 12 (therefore, the irradiation position of the second beam LB2 on one recording layer 13) provided in the optical pickup 102 is moved in the radial direction by the actuator 304. From the actuator 304, the feedback signal according to the variation thereof is fed back to the error detector 301.

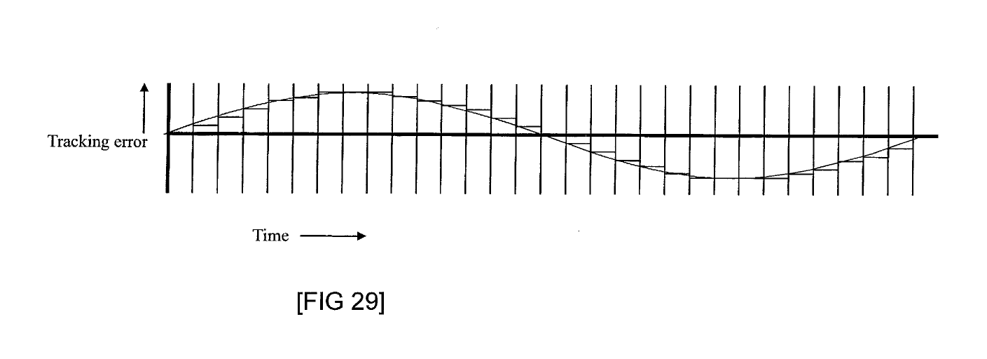

Now, in particular, with reference to FIG. 29 to FIG. 31, consideration is given to the sampling timing of the sampler 302.

FIG. 29 schematically illustrated the operation output of the sampler 302 in cases where the eccentric component changes, which is the maximum disturbance element inputted to the error detector 301. From FIG. 29, it is seen that the tracking error waves from a plus side to a minus side at a substantially constant frequency with respect to time.

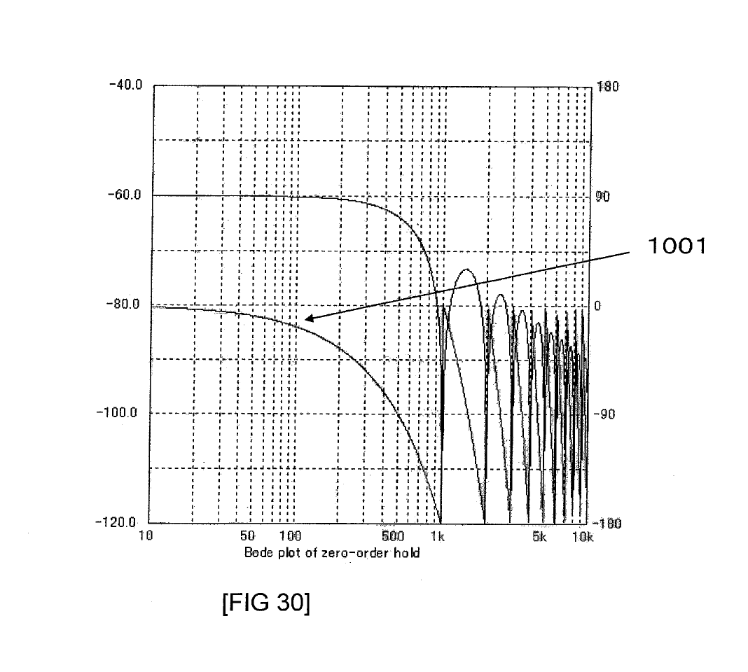

FIG. 30 illustrates a Bode line map of transfer function in cases where “zero-order hold” is performed by the sampler 302, i.e. illustrates Bode Plot of zero-order hold. In other words, here, frequency characteristics of the zero-order hold are illustrated, and in particular, a gain characteristic (a characteristic curve on the upper side) and phase (a characteristic curve on the lower side) are illustrated together in the Bode plot. In this example, the case of sampling at 1 ms; however, in reality, the sampling is performed at much shorted intervals.

From FIG. 30, regarding the phase characteristic, it is seen that in the case of 1 KHz sampling, the phase rotates by several degrees, as illustrated in a characteristic curve portion 1001 in the phase, in the signal at 100 Hz. On the other hand, it can be also said that if a band in which the phase rotation can be ignored is 100 Hz, a sample interval of about 10 times (1 KHz) or more is required (i.e. the sampling at a higher frequency than 1 KHz is required).

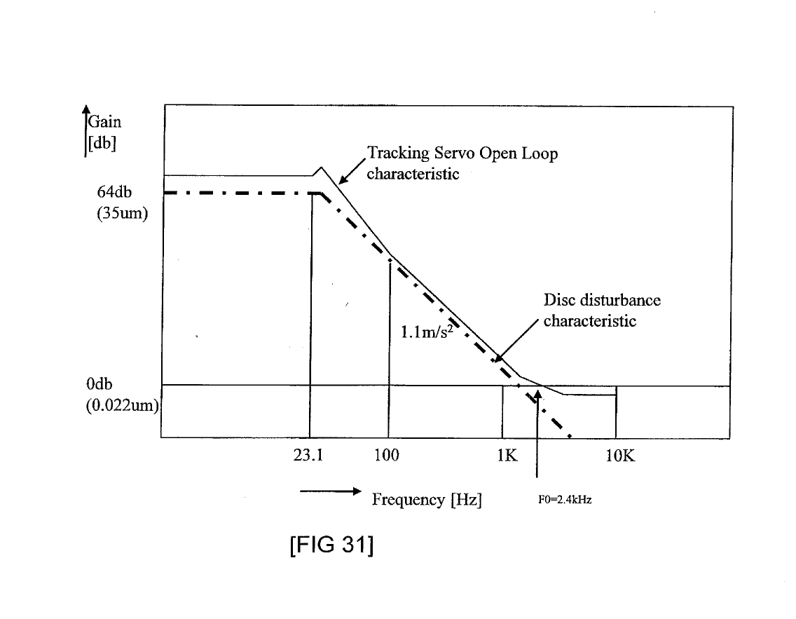

FIG. 31 illustrates an example of a disc disturbance characteristic and a tracking servo open loop characteristic, regarding the tracking servo. In this example, the “disc (i.e. optical disc 11) disturbance characteristic” has an eccentric component of 35 μm on one side until a frequency of 23.1 Hz and is 1.1 m/S² in an acceleration region. In other words, the disc disturbance is almost flat at 64 db corresponding to 35 μm in the characteristic diagram until the frequency of 23.1 Hz and decreases with a slope of 1.1 m/S² to 0 dB corresponding to 0.022 μm on a higher frequency side than the frequency of 23.1 Hz. The tracking servo open loop characteristic is illustrated as a characteristic example capable of suppressing the disc disturbance as described above. In other words, in the characteristic diagram, it is set such that the open loop characteristic is on a higher gain side at any frequency, which makes it possible to suppress the disturbance in any frequency band. Incidentally, this example is illustrates with f0 (cutoff band)=2.4 KHz.

In the case of this example explained with reference to FIG. 29 to FIG. 31, the “predetermined distance” is determined as follows.

That is, if a tracking servo band is set to, for example, 2.4 KHz, a time interval T is obtained as T=1/(24×10³)=46.7 [psec] corresponding to 24 kHz which is about 10 times in order to ignore an influence by the sampler 302 realized as the hold circuit described above. From a relation between the time interval T and a rotational linear velocity by the spindle motor 104, the longest distance required as the arrangement interval or the arrangement pitch (refer to FIG. 9) of the two servo areas 22 discretely arranged in tandem in the track direction, i.e. one example of the “predetermined distance” of the present invention, is determined.

For example, if a linear velocity v is set to 4.917 m/sec, a predetermined distance L is obtained as L=v×T=230 [μsec]. In other words, if one servo area 22 is put in five slots along the track TR, a slot configuration is determined such that the length of the five slots is shorter than 230 [μm], or how many slots are used to put one servo area 22 is determined.

Incidentally, the method of determining the arrangement interval (i.e. arrangement pitch) of the servo areas 22 is not limited to this example, and the arrangement interval may be determined in view of the servo band required as shown in FIG. 30 and FIG. 31, the linear velocity in the zone CAV method of the optical disc 11, or the like.

### Various Modified Examples

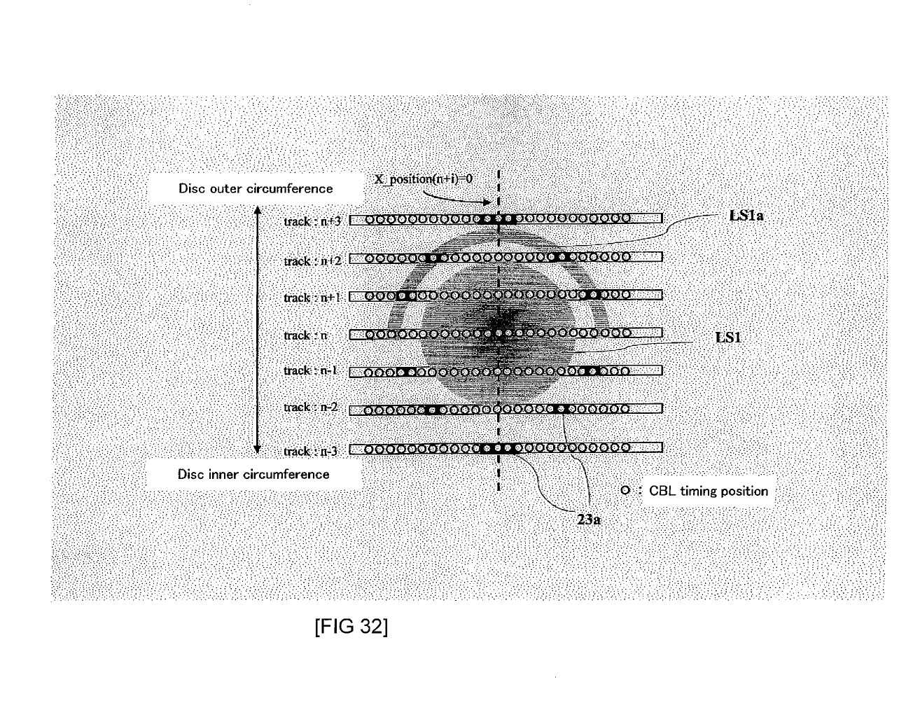

Hereinafter, various modified examples of the example will be explained with reference to FIG. 32 to FIG. 38.

A modified example illustrated in FIG. 32 is related to a specific example of the pattern area 23.

In FIG. 32, the tilt detection pattern is configured throughout the plurality of tracks TR, and the tilt detection pattern is disposed in a vicinity including intersection points of the plurality of tracks TR and a first bright ring position of the first beam LB1 (except intersection points of a tilt position detection target track and the first bright ring position).

More specifically, the tilt detection pattern is disposed, including a position vicinity satisfying the following equation: X position (n+i)={(0.82×λ/NA)²−(i×Tₚ)²}^{1/2}/CBL, i=±1, ±2, . . . , wherein λ: wavelength of the first beam LB1, NA: aperture of the first beam (numerical aperture), Tp track pitch, CBL: channel bit length, n: tilt detection target track, and X_position (n+i): intersection points of the first bright ring position on an (n+i) track normalized by the CBL. Moreover, “0.82” is a proportionality constant associated with the intersections points of the first bright ring position unique to the plurality of tracks TR of the optical disc 11 and the first beam LB1.

As described above, by disposing the pattern covering the plurality of (i.e. seven in this example) tracks TR in the pattern area 23, the disc tilt detection can be performed, certainly.

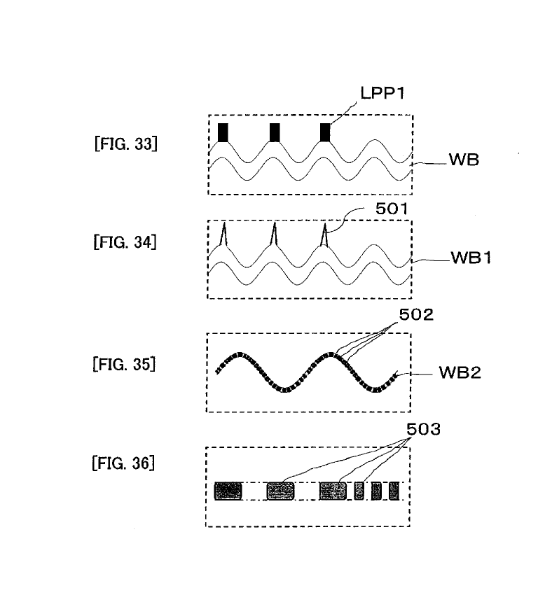

Next, FIG. 33 shows a physical track configuration formed in the servo area 22 in the example describe above, and each of FIG. 34 to FIG. 37 illustrates a modified example thereof.

In the example in FIG. 33, the wobbles WB and the land pre-pits LPP1 constitute the track TR in the servo area 22. Here, the cycles of the wobbles WB and the land pre-pits LPP1 have an integral multiple relation, and moreover, each of the land pre-pits LPP1 is formed at respective one of peaks of the wobbles WB. This facilitates the detection of the pre-pit signal and the wobble signal.

In the modified example in FIG. 34, each of sharp curve portions 501 in which a wobble amplitude (a deflection amount) is locally increased is provided at respective one of peaks of wobbles WB1 of the groove track. In other words, without the pre-pits, the track TR of the servo area 22 is formed from the special wobbles WB1. Even in this case, the wobble signal can be easily detected.

In the modified example in FIG. 35, wobbles WB2 are formed by wobbling continuous arrangement along the track TR of a plurality of grooves 502 grooved in a shortly divided manner. For example, if the wobbles WB2 are formed by pre-embossing, a track TRw having such a structure can be established in each servo area 22.

In the modified example in FIG. 36, the width in the radial direction is constant, and the length in the track direction is modulated, as occasion demands. Continuous arrangement along the track TR of a plurality of grooves 503 grooved in a shortly divided manner (in other words, a “mark pattern”) is set as the track TR. In the modified example, the track TR is not wobbled. For example, if the mark pattern is formed by the pre-embossing, the track TRw having such a structure can be established in each servo area 22.

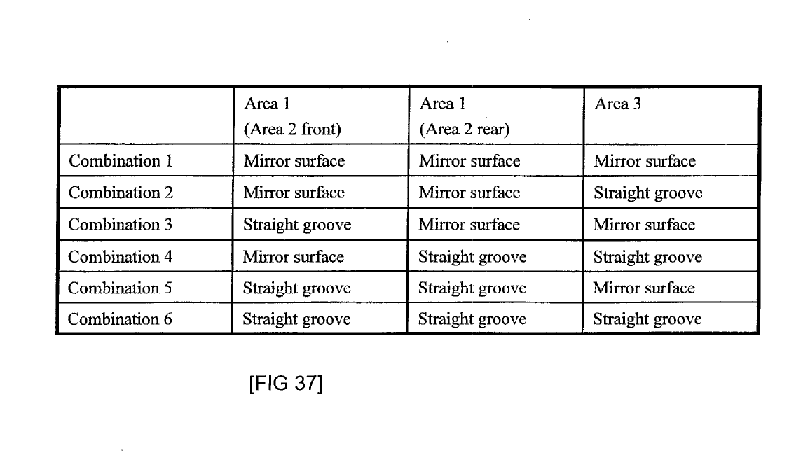

Next, FIG. 37 shows various modified examples of the physical track configuration formed in the mirror-surface area 21 and the pattern area 23 in the example described above, as various combinations of the mirror surface and the straight groove. In FIG. 37, an “area 1” is an area corresponding to the mirror-surface area 21 illustrated in FIG. 9 or the like, and an “area 3” is an area corresponding to the pattern area 23 illustrated in FIG. 9 or the like.

An “(area 2 front)” means being adjacently disposed on the front side in the track direction of the servo area 22 shown in FIG. 9 or the like, and an “(area 2 rear)” means being adjacently disposed on the rear side in the track direction of the servo area 22 illustrated in FIG. 9 or the like.

In the example described above, as illustrated in FIG. 9, the mirror-surface area 21 is configured as the mirror surface or straight grove area, and the pattern surface area 23 is formed as the mirror surface. In the various modified examples in FIG. 37, the physical configuration of the servo area 22 is the same as in the example described above (refer to FIG. 33) or the modified examples (refer to FIG. 34 to FIG. 36).

In FIG. 37, in the modified example of “combination 1”, the area other than the servo area 22 is the mirror surface, and thus, a sum signal (hereinafter simply referred to as a “SUM signal”) of the light receiving element for the first beam LB1 in the optical pickup 102 (i.e. a photo-detector for red color) becomes locally small only in the servo area 22. Therefore, by using the SUM signal, an unnecessary area for the tracking servo can be masked.

In the modified example of “combination 2”, the mirror-surface area 21 in front of the servo area 22 (“area 2 front”) and the mirror-surface area 21 behind the servo area 22 (“area 2 rear”) are set as the mirror surface, and thus, only in the areas, the SUM signal becomes locally large. Therefore, the outside of the section can be masked as the unnecessary area for the tracking servo.

In the modified example of “combination 3”, only the mirror-surface area 21 in front of the servo area 22 (“area 2 front”) has the straight groove, and thus, the SUM signal becomes locally small only in this area. Therefore, the area is judged to be a tracking servo entry period, and the tracking servo can be stabilized more quickly.

In the modified example of “combination 4”, only the mirror-surface area 21 in front of the servo area 22 (“area 2 front”) has the mirror surface, and thus, the SUM signal becomes large only in this area. Therefore, the area is judged to be the tracking servo entry period, and the tracking servo can be stabilized more quickly.

In the modified example of “combination 5”, the mirror-surface area 21 in front of the servo area 22 (“area 2 front”) and the mirror-surface area 21 behind the servo area 22 (“area 2 rear”) have the straight groove, and thus, the SUM signal becomes small in the areas. Therefore, the outside of the section can be masked as the unnecessary area for the tracking servo.

In the modified example of “combination 6”, the entire area has the straight groove, and thus, the tracking error signal does not cause offset every three areas. Therefore, a circuit configuration associated with the tracking servo can be simplified.

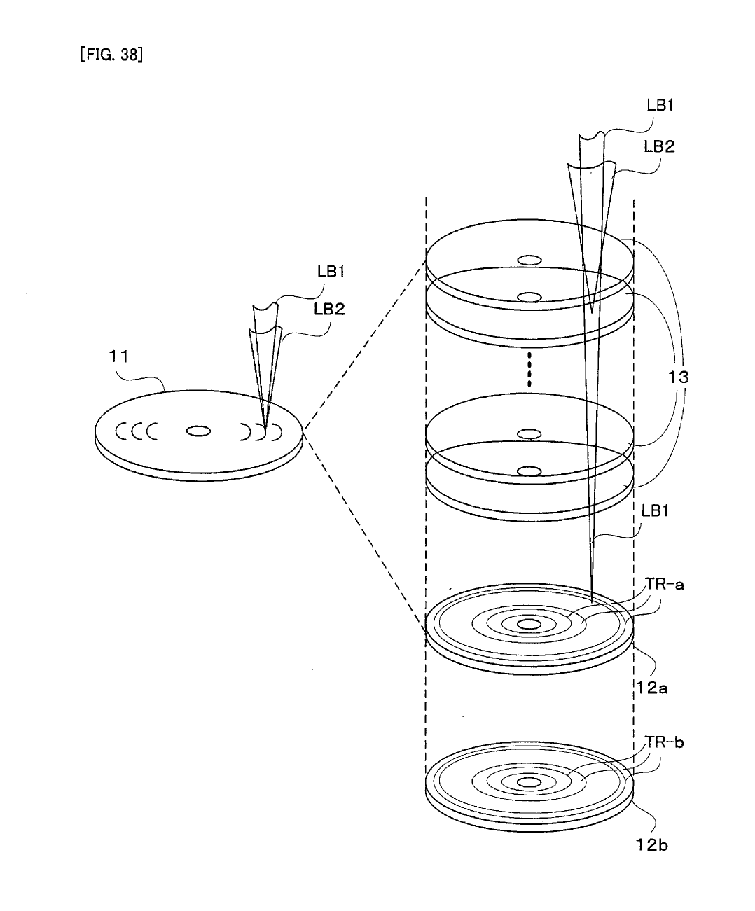

Next, FIG. 38 illustrated a modified example of the basic layer configuration of the optical disc in the example described above (refer to FIG. 1 and FIG. 2). FIG. 38 is a schematic perspective view having the same concept as in FIG. 1 illustrating the optical disc in the modified example.

In FIG. 38, in the modified example of the optical disc 11, two guide layers 12a and 12b are provided. For example, a track TR-a of the guide layer 12a is configured to carry first address information for indicating an address position directed from the inner circumference to the outer circumference. A track TR-b of the guide layer 12b is configured to carry second address information for indicating an address position directed from the outer circumference to the inner circumference. In this case, moreover, even the recording layers 13 are properly used as a first recording layer recorded in accordance with the first address information and a second recording layer recorded in accordance with the second address information, and guidance for the first recording layer is performed by using the guide layer 12a and guidance for the second recording layer is performed by using the guide layer 12b. By virtue of such a configuration, it is possible to make efficient or easy operation of recording information from the inner circumference to the outer circumference in one or a plurality of first recording layers and of recording information from the outer circumference to the inner circumference in one or a plurality of second recording layers. Moreover, reliability and stability of the recording operation can be significantly increased by properly using the two types of address information. Thus, it is possible to realize the optical disc 11 which allows the recording continuously bi-directionally, or arbitrarily or independently bi-directionally.

For example, if it is set to perform the recording and reproduction from the inner circumference to the outer circumference in the first layer of the recording layers and to perform the recording and reproduction from the outer circumference to the inner circumference in the second layer of the recording layers, then, a time to change the recording and reproduction between the two layers is almost a time to perform a layer jump. Thus, it is extremely useful in the recording and reproduction which are continuously performed by straddling the plurality of recording layers. In other words, it is possible to obtain the same effect as that of so-called “opposite recording” or “opposite reproduction” in a dual-layer disc. That is, if the data that is continuous in real time such as video data is recorded as the data to be recorded, by using the optical disc 11 in the modified example, then, it takes the time for the layer jump, to reach from the end of the first recording layer to the start of the second recording layer, in the reproduction. This is extremely useful in view of the layer jump and a time for returning the position of the optical pickup 102 from the outer circumference to the inner circumference, which is further added in the case of the example illustrated in FIG. 1. In the case of the example illustrated in FIG. 1, in order to seamlessly reproduce the data, the recording/reproducing apparatus 101 may be provided with a large amount of memory.

As described above, by using the modified example in FIG. 38 at the same time, continuous reproduction becomes possible on the reproducing apparatus, inexpensively and easily.

As explained above in detail, according to the example and the modified examples, the arrangement interval (arrangement pitch) of the servo areas 22 along the tracks TR is set to be less than or equal to the predetermined distance, and moreover, the servo areas 22 are (discretely) arranged on the entire surface of the optical disc 11. Thus, the continuous tracking signal can be obtained by the sampling at any position from the inner circumference to the outer circumference of the optical disc 11 in the guide layer 12.

Moreover, in particular, one cycle of wobble WB and the constituent unit of the data format in one recording layer 13 have an integral multiple relation, and the slots are configured as an integral multiple of the one cycle of wobble WB, and the servo area 22 corresponds to this section. This facilitates the appropriate arrangement not to overlap the servo areas 22 on the adjacent tracks TR (i.e. not to cause the crosstalk in the wobble signal and the pre-pit signal). The wobble signal obtained in this manner can be used as the generation of a timing reference signal excellent in robust, or the generation of a timing signal at the start of the recording, via a phase locked loop (PLL) circuit.

Moreover, the present invention is not limited to the aforementioned embodiment, but various changes may be made, if desired, without departing from the essence or spirit of the invention which can be read from the claims and the entire specification. An information recording medium, an information recording apparatus and method, and an information reproducing apparatus and method, which involve such changes, are also intended to be within the technical scope of the present invention.

### DESCRIPTION OF REFERENCE CODES

11 optical disc
12 guide layer
13 recording layer
21 mirror-surface area
22 servo area (mark area)
23 pattern area
TR track
WB wobble
LLP1 land pre-pit
LB1 first beam
LB2 second beam
102 optical pickup
102L objective lens
101 recording/reproducing apparatus
201 host computer

1. An information recording medium adopting a zone CAV method, comprising:
a guide layer in which tracks are formed in advance and on which a first light beam is focused; and
a plurality of recording layers laminated on said guide layer, and on each of which a second light beam having a smaller diameter than that of the first light beam is focused, wherein
on the tracks, including a portion which overlaps an area of the recording layer in which information is recorded by the second light beam, (i) a plurality of guide areas, each of which has a physical structure for carrying guide information for guidance, are arranged discretely at arrangement intervals of predetermined distance or less which is set in advance in a track direction along the tracks and are shifted between a plurality of tracks throughout the plurality of tracks which are adjacent to each other in a radial direction crossing the tracks such that a guide operation in a predetermined band can be performed at each radial position in the radial direction on the premise of the zone CAV method, and (ii) a plurality of signal detection areas, each of which has an integrated predetermined pattern covering a plurality of track portions, are further arranged in the tracks such that a particular type of pattern signal can be detected in a center track portion, at least located near a central portion in the radial direction, out of the plurality of track portions which are adjacent to each other in the radial direction crossing the tracks, and
(i) the plurality of guide areas are disposed in partial slots which are not adjacent to each other in the track direction and which are not adjacent to each other throughout the plurality of tracks in the radial direction, out of a plurality of slots obtained by dividing the tracks in the track direction and (ii) each of the plurality of guide areas is disposed in one slot included in each first group and not disposed in another slot included in each first group, for each group, wherein the first group is provided with a plurality of slots arranged in the track direction out of the plurality of slots,
the plurality of signal detection areas are disposed in the slot included in each second group, wherein the second group is provided with one or more slots obtained by dividing the tracks in the track direction,
the plurality of slots are sections into each of which information is recorded in the slots which are continuous in both the track direction and the radial direction in the recording layer,
a length in the track direction of two first group and the second group, which are arranged in the track direction, corresponds to the arrangement interval of the predetermined distance or less.

2. The information recording medium according to claim 1, wherein the second group is disposed continuously to at least one of a plurality of the first groups in the track direction, or is disposed between the plurality of slots in the first group.

3. The information recording medium according to claim 2, wherein the length in the track direction of the two first groups and the second group and a length in the track direction of a smallest constituent unit of data which is recorded into each of the plurality of recording layers have a predetermined integral ratio.

4. The information recording medium according to claim 1, wherein
the plurality of slots in the first group are configured as slots having mutually equal lengths in the track direction, and
the one or more slots in the second group are configured as slots having mutually equal lengths in the track direction.

5. The information recording medium according to claim 1, wherein
guide information associated with at least one guide area disposed in front of the center track portion in the track direction out of the plurality of guide areas is configured to also function as mark information indicating that corresponding one signal detection area of the plurality of signal detection areas is located thereafter,
the tracks are formed, spirally or concentrically, from an inner circumference to an outer circumference or from the outer circumference to the inner circumference of said information recording medium, and
the mark information indicates that the corresponding one signal detection area is located thereafter by indicating (i) timing to sample the corresponding one signal detection area located thereafter or (ii) an address position of the corresponding one signal detection area located thereafter.

6. The information recording medium according to claim 1, wherein
the physical structure carries the guide information such that a length in the track direction of the slot and a length in the track direction of a constituent unit in a format of data which is recorded into each of the plurality of recording layers have a predetermined integral ratio.

7. The information recording medium according to claim 4, wherein
the plurality of guide areas are configured as the slots having mutually equal lengths in the track direction,
the guide information is disposed in each of the slots so as not to be adjacent to each other between the plurality of tracks in the radial direction,
the plurality of signal detection areas are configured as other slots having lengths equal to those of the slots, and
the predetermined pattern is disposed in each of the slots so as not to be adjacent to each other between the plurality of tracks in the radial direction and so as not to overlap the plurality of guide areas.

8. The information recording medium according to claim 1, wherein the plurality of guide areas and the plurality of signal detection areas are disposed mixedly on the basis of arrangement rules thereof which are different from each other.

9. The information recording medium according to claim 1, wherein the plurality of guide areas and the plurality of signal detection areas are separated in a form of having a buffer area therebetween so as not to be adjacent to each other in the radial direction, the buffer area having a length having an integral-ratio relation with a length of the slot in the first group in the track direction.

10. The information recording medium according to claim 2, wherein the predetermined pattern is configured, in the slot in the second group, such that a tilt detection signal for tilt detection can be detected as the pattern signal.

11. The information recording medium according to claim 1, wherein the physical structure includes, in the slot in the first group, at least one of a wobble and pre-pit structure and a wobble and partial notch structure.

12. The information recording medium according to claim 1, wherein the plurality of slots in which the guide areas are disposed are selected as a plurality of slots which are not included in a light spot simultaneously on the basis of (i) a diameter of the light spot formed on the tracks by the first light beam irradiated and focused on the tracks at least in information recording for the recording layer, (ii) a pitch in the radial direction of the tracks, (iii) a displacement amount by which a relative position between two slots which are adjacent in the radial direction is shifted in the track direction in every cycle according to the zone CAV method, in comparison with the case of assuming that it complies with the CAV method; and (iv) a length in the track direction of the slot.

13. The information recording medium according to claim 1, wherein
the tracks are guide tracks for tracking servo,
the physical structure allows generation of a signal for the tracking servo which constitutes at least one portion of the guide information,
each of the plurality of guide areas is a servo area for generating the signal for the tracking servo,
the predetermined distance is set in advance to a distance in which the tracking servo can operate in a predetermined band, and
the plurality of servo areas are arranged such that the plurality of servo areas are shifted between the plurality of tracks so as not to be irradiated with the first light beam simultaneously, on the basis of a diameter of the first light beam for the tracking servo.

14. An information recording apparatus for recording data onto an information recording medium adopting a zone CAV method, comprising: a guide layer in which tracks are formed in advance and on which a first light beam is focused; and a plurality of recording layers laminated on the guide layer, and on each of which a second light beam having a smaller diameter than that of the first light beam is focused, wherein on the tracks, including a portion which overlaps an area of the recording layer in which information is recorded by the second light beam, (i) a plurality of guide areas each of which has a physical structure for carrying guide information for guidance are arranged discretely at arrangement intervals of predetermined distance or less which is set in advance in a track direction along the tracks and are shifted between a plurality of tracks throughout the plurality of tracks which are adjacent to each other in a radial direction crossing the tracks such that a guide operation in a predetermined band can be performed at each radial position in the radial direction on the premise of the zone CAV method, and (ii) a plurality of signal detection areas, each of which has an integrated predetermined pattern covering a plurality of track portions, are further arranged in the tracks such that a particular type of pattern signal can be detected in a center track portion, at least located near a central portion in the radial direction, out of the plurality of track portions which are adjacent to each other in the radial direction crossing the tracks, and (i) the plurality of guide areas are disposed in partial slots which are not adjacent to each other in the track direction and which are not adjacent to each other throughout the plurality of tracks in the radial direction, out of a plurality of slots obtained by dividing the tracks in the track direction and (ii) each of the plurality of guide areas is disposed in one slot included in each first group and not disposed in another slot included in each first group, for each group, wherein the first group is provided with a plurality of slots arranged in the track direction out of the plurality of slots, the plurality of signal detection areas are disposed in the slot included in each second group, wherein the second group is provided with one or more slots obtained by dividing the tracks in the track direction, the plurality of slots are sections into each of which information is recorded in the slots which are continuous in both the track direction and the radial direction in the recording layer, a length in the track direction of two first group and the second group, which are arranged in the track direction, corresponds to the arrangement interval of the predetermined distance or less,
said information recording apparatus comprising:
a light irradiating device capable of irradiating and focusing the first light beam for tracking on the guide layer and capable of irradiating and focusing the second light beam for data recording on one recording layer out of the plurality of recording layers;
an information obtaining device for receiving first light based on the irradiated and focused first light beam from the guide layer and obtaining the carried guide information on the basis of the received first light;
a tracking servo device for controlling said light irradiating device to perform tracking servo in a predetermined band on the tracks on the basis of the obtained guide information; and
a data recording control device for controlling said light irradiating device to record the data by irradiating and focusing the second light beam on the one recording layer when the tracking servo is performed.

15. An information recording method of recording data onto an information recording medium adopting a zone CAV method, comprising: a guide layer in which tracks are formed in advance and on which a first light beam is focused; and a plurality of recording layers laminated on the guide layer, and on each of which a second light beam having a smaller diameter than that of the first light beam is focused, wherein on the tracks, including a portion which overlaps an area of the recording layer in which information is recorded by the second light beam, (i) a plurality of guide areas each of which has a physical structure for carrying guide information for guidance are arranged discretely at arrangement intervals of predetermined distance or less which is set in advance in a track direction along the tracks and are shifted between a plurality of tracks throughout the plurality of tracks which are adjacent to each other in a radial direction crossing the tracks such that a guide operation in a predetermined band can be performed at each radial position in the radial direction on the premise of the zone CAV method, and (ii) a plurality of signal detection areas, each of which has an integrated predetermined pattern covering a plurality of track portions, are further arranged in the tracks such that a particular type of pattern signal can be detected in a center track portion, at least located near a central portion in the radial direction, out of the plurality of track portions which are adjacent to each other in the radial direction crossing the tracks, and (i) the plurality of guide areas are disposed in partial slots which are not adjacent to each other in the track direction and which are not adjacent to each other throughout the plurality of tracks in the radial direction, out of a plurality of slots obtained by dividing the tracks in the track direction and (ii) each of the plurality of guide areas is disposed in one slot included in each first group and not disposed in another slot included in each first group, for each group, wherein the first group is provided with a plurality of slots arranged in the track direction out of the plurality of slots, the plurality of signal detection areas are disposed in the slot included in each second group, wherein the second group is provided with one or more slots obtained by dividing the tracks in the track direction, the plurality of slots are sections into each of which information is recorded in the slots which are continuous in both the track direction and the radial direction in the recording layer, a length in the track direction of two first group and the second group, which are arranged in the track direction, corresponds to the arrangement interval of the predetermined distance or less, by using a light irradiating device capable of irradiating and focusing the first light beam for tracking on the guide layer and capable of irradiating and focusing the second light beam for data recording on one recording layer out of the plurality of recording layers,
said information recording method comprising:
an information obtaining process of receiving first light based on the irradiated and focused first light beam from the guide layer and obtaining the carried guide information on the basis of the received first light;
a tracking servo process of controlling said light irradiating device to perform tracking servo in a predetermined band on the tracks on the basis of the obtained guide information; and
a data recording control process of controlling said light irradiating device to record the data by irradiating and focusing the second light beam on the one recording layer when the tracking servo is performed.

16. An information reproducing apparatus for reproducing data from an information recording medium adopting a zone CAV method, comprising: a guide layer in which tracks are formed in advance and on which a first light beam is focused; and a plurality of recording layers laminated on the guide layer, and on each of which a second light beam having a smaller diameter than that of the first light beam is focused, wherein on the tracks, including a portion which overlaps an area of the recording layer in which information is recorded by the second light beam, (i) a plurality of guide areas each of which has a physical structure for carrying guide information for guidance are arranged discretely at arrangement intervals of predetermined distance or less which is set in advance in a track direction along the tracks and are shifted between a plurality of tracks throughout the plurality of tracks which are adjacent to each other in a radial direction crossing the tracks such that a guide operation in a predetermined band can be performed at each radial position in the radial direction on the premise of the zone CAV method, and (ii) a plurality of signal detection areas, each of which has an integrated predetermined pattern covering a plurality of track portions, are further arranged in the tracks such that a particular type of pattern signal can be detected in a center track portion, at least located near a central portion in the radial direction, out of the plurality of track portions which are adjacent to each other in the radial direction crossing the tracks, and (i) the plurality of guide areas are disposed in partial slots which are not adjacent to each other in the track direction and which are not adjacent to each other throughout the plurality of tracks in the radial direction, out of a plurality of slots obtained by dividing the tracks in the track direction and (ii) each of the plurality of guide areas is disposed in one slot included in each first group and not disposed in another slot included in each first group, for each group, wherein the first group is provided with a plurality of slots arranged in the track direction out of the plurality of slots, the plurality of signal detection areas are disposed in the slot included in each second group, wherein the second group is provided with one or more slots obtained by dividing the tracks in the track direction, the plurality of slots are sections into each of which information is recorded in the slots which are continuous in both the track direction and the radial direction in the recording layer, a length in the track direction of two first group and the second group, which are arranged in the track direction, corresponds to the arrangement interval of the predetermined distance or less,
said information reproducing apparatus comprising:
a light irradiating device capable of irradiating and focusing the first light beam for tracking on the guide layer and capable of irradiating and focusing the second light beam for data reproduction on one recording layer out of the plurality of recording layers;
an information obtaining device for receiving first light based on the irradiated and focused first light beam from the guide layer and obtaining the carried guide information on the basis of the received first light;
a tracking servo device for controlling said light irradiating device to perform tracking servo in a predetermined band on the tracks on the basis of the obtained guide information; and
a data obtaining device for receiving second light based on the irradiated and focused second light beam from the one recording layer and obtaining the data on the basis of the received second light when the tracking servo is performed.

17. An information reproducing method of reproducing data from an information recording medium adopting a zone CAV method, comprising: a guide layer in which tracks are formed in advance and on which a first light beam is focused; and a plurality of recording layers laminated on the guide layer, and on each of which a second light beam having a smaller diameter than that of the first light beam is focused, wherein on the tracks, including a portion which overlaps an area of the recording layer in which information is recorded by the second light beam, (i) a plurality of guide areas each of which has a physical structure for carrying guide information for guidance are arranged discretely at arrangement intervals of predetermined distance or less which is set in advance in a track direction along the tracks and are shifted between a plurality of tracks throughout the plurality of tracks which are adjacent to each other in a radial direction crossing the tracks such that a guide operation in a predetermined band can be performed at each radial position in the radial direction on the premise of the zone CAV method, and (ii) a plurality of signal detection areas, each of which has an integrated predetermined pattern covering a plurality of track portions, are further arranged in the tracks such that a particular type of pattern signal can be detected in a center track portion, at least located near a central portion in the radial direction, out of the plurality of track portions which are adjacent to each other in the radial direction crossing the tracks, and (i) the plurality of guide areas are disposed in partial slots which are not adjacent to each other in the track direction and which are not adjacent to each other throughout the plurality of tracks in the radial direction, out of a plurality of slots obtained by dividing the tracks in the track direction and (ii) each of the plurality of guide areas is disposed in one slot included in each first group and not disposed in another slot included in each first group, for each group, wherein the first group is provided with a plurality of slots arranged in the track direction out of the plurality of slots, the plurality of signal detection areas are disposed in the slot included in each second group, wherein the second group is provided with one or more slots obtained by dividing the tracks in the track direction, the plurality of slots are sections into each of which information is recorded in the slots which are continuous in both the track direction and the radial direction in the recording layer, a length in the track direction of two first group and the second group, which are arranged in the track direction, corresponds to the arrangement interval of the predetermined distance or less, by using a light irradiating device capable of irradiating and focusing the first light beam for tracking on the guide layer and capable of irradiating and focusing the second light beam for data reproduction on one recording layer out of the plurality of recording layers,
said information reproducing method comprising:
an information obtaining process of receiving first light based on the irradiated and focused first light beam from the guide layer and obtaining the carried guide information on the basis of the received first light;
a tracking servo process of controlling said light irradiating device to perform tracking servo in a predetermined band on the tracks on the basis of the obtained guide information; and
a data obtaining process of receiving second light based on the irradiated and focused second light beam from the one recording layer and obtaining the data on the basis of the received second light when the tracking servo is performed.
